(19) United States
(12) Patent Application Publication
(10) Pub. No.: US 2024/0381116 A1
(43) Pub. Date: Nov. 14, 2024

(54) SIDELINK BEAM MANAGEMENT RESPONSES

(71) Applicant: QUALCOMM Incorporated, San Diego, CA (US)

(72) Inventors: Qing LI, Princeton Junction, NJ (US); Junyi LI, Greentown, PA (US)

(21) Appl. No.: 18/659,626

(22) Filed: May 9, 2024

Related U.S. Application Data
(60) Provisional application No. 63/501,646, filed on May 11, 2023.

(51) Int. Cl. H04W 16/28; H04W 52/52; H04W 72/25; H04W 92/18

(52) U.S. Cl. CPC H04W 16/28; H04W 52/52; H04W 72/25; H04W 92/18

(57) ABSTRACT

Various aspects of the present disclosure generally relate to wireless communication, including sidelink beam management responses. In some aspects, a first user equipment (UE) may receive, in one or more mini-slots, one or more sidelink signals of a plurality of sidelink signals (e.g., sidelink reference signal blocks (S-RSBs), sidelink beams, sidelink reference signals, etc.) for sidelink beam management associated with a second UE; and transmit, to the second UE, at least one response associated with at least one sidelink signal of the one or more sidelink signals received. In some aspects, a first UE may transmit, in a plurality of mini-slots, a plurality of sidelink signals; and receive, from one or more other UEs during one or more response occasions associated with the plurality of sidelink signals, one or more responses associated with at least one of the plurality of sidelink signals. Numerous other aspects are also described.

### CROSS-REFERENCE TO RELATED APPLICATIONS

The present application claims priority to and the benefit of U.S. Provisional Patent Application No. 63/501,646, filed May 11, 2023 and titled “SIDELINK BEAM MANAGEMENT RESPONSES,” which is hereby incorporated by reference in its entirety as if fully set forth below and for all applicable purposes.

### INTRODUCTION

Aspects of the present disclosure generally relate to wireless communication and to techniques and apparatuses for sidelink beam management responses.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP)(CP-OFDM) on the downlink, using CP-OFDM and/or single-carrier frequency division multiplexing (SC-FDM)(also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects described herein relate to a method of wireless communication performed at a first user equipment (UE), the method comprising: receiving, in one or more mini-slots of one or more slots, one or more sidelink reference signal blocks (S-RSBs) of a plurality of S-RSBs associated with a second UE; and transmitting, to the second UE, at least one response associated with at least one S-RSB of the one or more S-RSBs received.

Some aspects described herein relate to a method of wireless communication performed at a first user equipment (UE), the method comprising: transmitting, in a plurality of mini-slots of one or more slots, a plurality of sidelink reference signal block (S-RSBs); and receiving, from one or more other UEs during one or more response occasions associated with the plurality of S-RSBs, one or more responses associated with at least one of the plurality of S-RSBs.

Some aspects described herein relate to an apparatus for wireless communications at a user equipment (UE), comprising: receive, in one or more mini-slots of one or more slots, one or more sidelink reference signal blocks (S-RSBs) of a plurality of S-RSBs associated with a second UE; and transmit, to the second UE, at least one response associated with at least one S-RSB of the one or more S-RSBs received.

Some aspects described herein relate to an apparatus for wireless communications at a user equipment (UE), comprising: at least one memory; and at least one processor coupled to the at least one memory, wherein the apparatus is configured to: transmit, in a plurality of mini-slots of one or more slots, a plurality of sidelink reference signal block (S-RSBs); and receive, from one or more other UEs during one or more response occasions associated with the plurality of S-RSBs, one or more responses associated with at least one of the plurality of S-RSBs.

Some aspects described herein relate to a user equipment (UE), comprising: at least one memory; at least one transceiver; and at least one processor coupled to the at least one memory and the at least one transceiver, wherein the UE is configured to: receive, in one or more mini-slots of one or more slots, one or more sidelink reference signal blocks (S-RSBs) of a plurality of S-RSBs associated with a second UE; and transmit, to the second UE, at least one response associated with at least one S-RSB of the one or more S-RSBs received

Some aspects described herein relate to a user equipment (UE), comprising: at least one memory; at least one transceiver; and at least one processor coupled to the at least one memory and the at least one transceiver, wherein the UE is configured to: transmit, in a plurality of mini-slots of one or more slots, a plurality of sidelink reference signal block (S-RSBs); and receive, from one or more other UEs during one or more response occasions associated with the plurality of S-RSBs, one or more responses associated with at least one of the plurality of S-RSBs.

Some aspects described herein relate to a user equipment (UE), comprising: means for receiving, in one or more mini-slots of one or more slots, one or more sidelink reference signal blocks (S-RSBs) of a plurality of S-RSBs associated with a second UE; and means for transmitting, to the second UE, at least one response associated with at least one S-RSB of the one or more S-RSBs received.

Some aspects described herein relate to a user equipment (UE), comprising: means for transmitting, in a plurality of mini-slots of one or more slots, a plurality of sidelink reference signal block (S-RSBs); and means for receiving, from one or more other UEs during one or more response occasions associated with the plurality of S-RSBs, one or more responses associated with at least one of the plurality of S-RSBs.

Some aspects described herein relate to a non-transitory computer-readable medium storing one or more instructions for wireless communication, the one or more instructions comprising one or more instructions that, when executed by one or more processors of a user equipment (UE), cause the UE to: receive, in one or more mini-slots of one or more slots, one or more sidelink reference signal blocks (S-RSBs) of a plurality of S-RSBs associated with a second UE; and transmit, to the second UE, at least one response associated with at least one S-RSB of the one or more S-RSBs received.

Some aspects described herein relate to a non-transitory computer-readable medium storing one or more instructions for wireless communication, the one or more instructions comprising one or more instructions that, when executed by one or more processors of a user equipment (UE), cause the UE to: transmit, in a plurality of mini-slots of one or more slots, a plurality of sidelink reference signal block (S-RSBs); and receive, from one or more other UEs during one or more response occasions associated with the plurality of S-RSBs, one or more responses associated with at least one of the plurality of S-RSBs.

Aspects generally include a method, apparatus, system, computer program product, non-transitory computer-readable medium, UE, base station, network entity, network node, wireless communication device, and/or processing system as substantially described herein with reference to and as illustrated by the drawings, specification, and appendix.

The foregoing has outlined rather broadly the features and some technical advantages of examples according to the disclosure in order that the detailed description that follows may be better understood. Additional features and advantages will be described hereinafter. The concepts and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIGS. 5a-5c are diagrams illustrating examples of channel state information reference signal beam management procedures, in accordance with the present disclosure.

FIGS. 6a-6c are diagrams illustrating examples of sidelink messaging, in accordance with the present disclosure.

FIGS. 7a-7c are diagrams illustrating examples of sidelink reference signal blocks (S-RSBs), in accordance with the present disclosure.

FIG. 8 is a diagram illustrating an example associated with sensing and transmitting S-RSBs, beam responses, and sidelink communications, in accordance with the present disclosure.

FIG. 9 is a diagram illustrating an example of S-RSB bursts, in accordance with the present disclosure.

FIG. 10 is a diagram illustrating an example of beam sweeping patterns in the context of S-RSB bursts, in accordance with the present disclosure.

FIG. 11 is a diagram illustrating an example of beam sweeping patterns in the context of S-RSB bursts, in accordance with the present disclosure.

FIG. 12 is a diagram illustrating an example of beam sweeping patterns in the context of S-RSB bursts, in accordance with the present disclosure.

FIG. 13 is a diagram illustrating an example of beam sweeping patterns in the context of S-RSB bursts, in accordance with the present disclosure.

FIG. 14 is a diagram illustrating an example of resources associated with beams, in accordance with the present disclosure.

FIGS. 15a-15e are diagrams illustrating examples of S-RSB burst structures for use with 4-symbol mini-slots, in accordance with the present disclosure.

FIGS. 16a-16e are diagrams illustrating examples of S-RSB burst structures for use with 2-symbol mini-slots, in accordance with the present disclosure.

FIG. 17 is a diagram illustrating an example associated with sensing and transmitting sidelink reference signal blocks (S-RSBs), beam responses, and associated communications, in accordance with the present disclosure.

FIG. 18 a diagram illustrating an example of an S-RSB burst structure including associated beam responses, in accordance with the present disclosure.

FIG. 19 a diagram illustrating an example of S-RSB burst(s) and associated beam responses, in accordance with the present disclosure.

FIGS. 20a-20c are diagrams illustrating examples of beam response structures, in accordance with the present disclosure.

FIG. 21 is a diagram illustrating an example of sidelink signal burst(s) and associated beam responses, in accordance with the present disclosure.

FIG. 22 is a diagram illustrating an example of sidelink signal burst(s) and associated beam responses, in accordance with the present disclosure.

FIG. 23 is a diagram illustrating an example of techniques associated with sensing and transmitting sidelink signals and associated beam responses, in accordance with the present disclosure.

FIG. 24 is a diagram illustrating an example associated with sensing and transmitting sidelink signals and associated beam responses, in accordance with the present disclosure.

FIG. 25 is a diagram of an example apparatus for wireless communication, in accordance with the present disclosure.

FIG. 26 is a diagram illustrating an example process performed, for example, by a UE or an apparatus of a UE, in accordance with the present disclosure.

FIG. 27 is a diagram illustrating an example process performed, for example, by a UE or an apparatus of a UE, in accordance with the present disclosure.

FIG. 28 is a diagram illustrating an example disaggregated base station architecture according to some aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

Sidelink communications may involve synchronizing timing between UEs. A sidelink synchronization procedure may define a hierarchy of priorities associated with different synchronization references and may require UEs to continuously search the hierarchy to get to the highest-quality synchronization reference that can be found. For Uu downlink, a base station (e.g., gNB) may sweep synchronization signal blocks (SSBs) or channel state information reference signals (CSI-RSs) with different transmitting beams for beam forming and fine tuning, beam monitoring with measurements, and candidate beam detection for beam recovery, etc. For sidelink beam management (e.g., beam pairing or beam firming, beam fine tuning (such as transmit beam or receive beam fine tuning), beam maintenance (such as beam monitoring or beam measurement and report, beam switching, etc.), beam failure recovery (such as beam failure detection, candidate beam selection, etc.), a UE participating in a beam management procedure may transmit a sidelink signal for one or more beam measurements and another UE participating in the beam management procedure may respond based on the one or more beam measurements. However, for sidelink communications in some networks and/or systems, certain UEs (e.g., synchronization reference (SyncRef) UEs) may provide synchronization assistance (e.g., transmitting sidelink SSBs) when there is no sidelink SSB to use in a proximity (e.g., the measurement of sidelink SSB is below a threshold). Other UEs may not be allowed to transmit a sidelink SSB due to an effort to control sidelink synchronization reference quality. In this regard, a non-SyncRef UE, or a sidelink UE that does not otherwise provide synchronization assistance to other UEs, may cause interference to the synchronization reference signals of the SyncRef UEs if attempting to sweep sidelink SSBs on different beams for beam management.

Further, for sidelink unicast communications, in some existing network standards, a transmitting UE may only transmit a sidelink reference signal (e.g., sidelink CSI-RS, etc.) together with a data transmission on the physical sidelink shared channel (PSSCH). Therefore, the transmitting UE may need to sweep the sidelink reference signals with different beams at the granularity of a slot. Because the sidelink reference signal is sent together with data on PSSCH over a minimum interval of one slot, sweeping across multiple beam directions can require multiple slots (i.e., at least one slot for each beam direction) and associated resources using existing approaches. Because of the slot granularity, sidelink sweeping sidelink reference signals in some networks may consume 3-4 times the resources as compared to beam sweeping for Uu.

These issues may be exacerbated in sidelink resource allocation mode 2, where there is no coordination by a network unit (e.g., a base station). Also, the transmission of relatively large SSBs in a beam sweeping pattern by multiple UEs can create interference (e.g., collisions between SSBs from different UEs). With more dynamic channels in FR2 frequencies, beamforming or beam switching may occur more frequently, further increasing potential latency, resource usage, and interference issues.

Mini-slot based sensing for sidelink beam management in accordance with the present disclosure improves many of these issues. In this regard, in accordance with the present disclosure a UE may perform sensing (e.g., based at least in part on a sidelink beam management configuration) to monitor for communications, such as sidelink-reference signal blocks (S-RSBs), from other UEs on a mini-slot basis. The UE may decode the received communications to determine resources used and/or reserved by the other UEs (e.g., based on SCI included in the communications). The UE may further determine which resources to use (or not use) based on the resources being used and/or reserved by the other UEs.

In some aspects, resources (e.g., one or more resource blocks over one or more symbols) may be allocated for a beam response for each S-RSB of an S-RSB burst. In this regard, an S-RSB burst may include a plurality of S-RSBs transmitted over time using one or more transmit beams. A receiving UE may monitor for and/or receive one or more S-RSBs of an S-RBS burst using one or more receive beams. A receiving UE may determine one or more best transmit beams (e.g., of the beam(s) used by the transmitting UE to transmit the S-RSBs of the S-RSB burst), one or more best receive beams (e.g., of the beam(s) used by the receiving UE to receive the S-RSBs of the S-RSB burst), one or more beam measurements (e.g., measurements of one or more of the beams used to transmit the S-RSBs of the S-RSB burst), and/or one or more candidate beams (e.g., one or more of the beams used to transmit the S-RSBs of the S-RSB burst) based on the received one or more S-RSBs of the S-RSB burst.

The receiving UE may respond to the UE that transmitted the S-RSB burst (i.e., the transmitting UE) with a beam response using the allocated resources. The beam response may be a communication from the receiving UE that provides an indication of one or more beam management parameters (e.g., selected transmit beam(s), selected receive beam(s), beam measurement(s), candidate beams and associated measurements, etc.) to the UE that transmitted the S-RSB burst. For example, the receiving UE may include in one or more beam responses an indication (implicit or explicit) of the one or more best transmit beams, the one or more best receive beams, the one or more beam measurements, and/or one or more candidate beams, respectively associated with the one or more S-RSBs of the S-RSB burst. In some instances, the receiving UE may transmit a single beam response that includes one or more indications associated with the one or more S-RSBs of the S-RSB burst. In this regard, the mini-slot based sensing for sidelink beam management, including the associated beam response resources and formats, in accordance with the present disclosure can improve latency associated with sidelink beamforming, beam measurement, and beam recovery, improve resource consumption, reduce interference, facilitate timely beamforming and switching on dynamic channels (including FR2). For example, by sweeping S-RSBs of an S-RSB burst using mini-slot based timing, monitoring for the S-RSBs of the S-RSB burst using the mini-slot based timing, and allocating resources for beam responses to the S-RSBs of the S-RSB burst using mini-slot based timing in accordance with aspects of the present disclosure, sidelink beam sweeping for beam management (e.g., beamforming, beam measurement, beam recovery, etc.) can be performed in a single slot or over a few slots depending on the number of beam directions desired for the sidelink beam sweeping. Additional aspects of the present disclosure will be apparent from the following description and accompanying drawings.

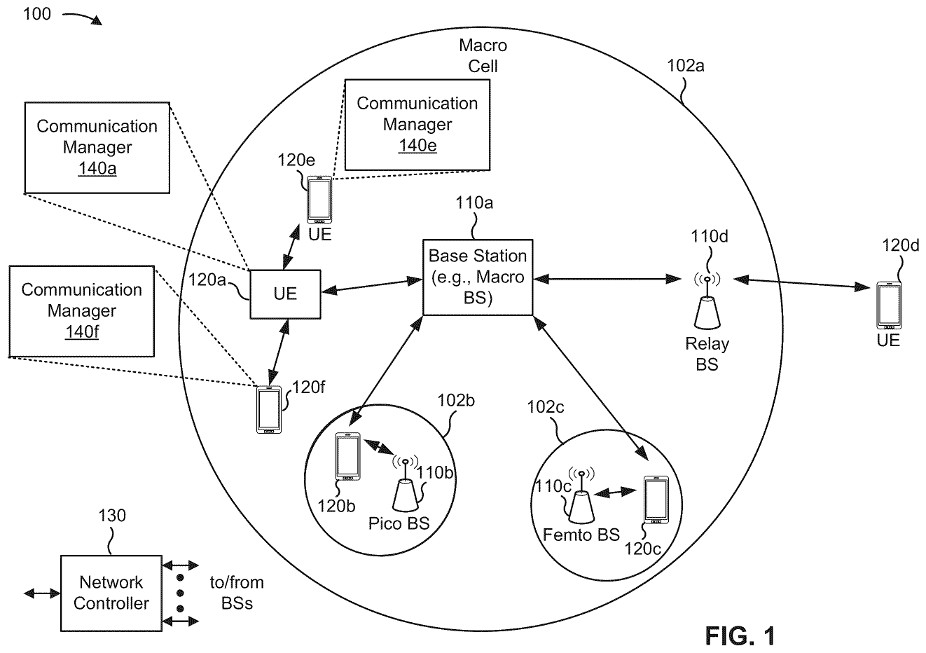

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmit receive point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHZ-7.125 GHZ) and FR2 (24.25 GHz-52.6 GHZ). It should be understood that although a portion of FR1 is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHz-71 GHZ), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140a. As described in more detail elsewhere herein, the communication manager 140a may perform sensing in a sidelink resource pool. The communication manager 140a may select, based at least in part on the sensing, one or more sidelink resources for one or more sidelink reference signal blocks (S-RSBs), where each S-RSB includes at least one reference signal (RS) and sidelink control information (SCI). The communication manager 140a may transmit the one or more S-RSBs in an S-RSB burst using the one or more sidelink resources. The communication manager 140a may monitor, at one or more sidelink resources for one or more beam responses, where each beam response (e.g., a response for beam management such as beam pairing, transmit or receive beam fine tuning, beam measurement, candidate beam list, etc.) is associated with one or more S-RSBs of an S-RSB burst. The communication manager 140a may receive the one or more beam responses from another UE (e.g., UE 120c, UE 120f). Additionally, or alternatively, the communication manager 140a may perform one or more other operations described herein.

In some aspects, a second UE (e.g., UE 120c) may include a communication manager 140c. As described in more detail elsewhere herein, the communication manager 140c may monitor for one or more S-RSBs in an S-RSB burst in a sidelink resource pool. The communication manager may receive the one or more S-RSBs in the S-RSB burst, where each S-RSB in the S-RSB burst includes at least one RS and SCI. The communication manager 140e may select a beam based at least in part on the one or more S-RSBs in the S-RSB burst. The communication manager 140e may determine, based at least in part on the one or more S-RSBs in the S-RSB burst, resources for transmitting one or more beam responses, where each beam response is associated with one or more S-RSBs of an S-RSB burst. The communication manager 140e may transmit the one or more beam responses to another UE (e.g., UE 120a). Additionally, or alternatively, the communication manager 140c may perform one or more other operations described herein.

In some aspects, a third UE (e.g., UE 120f) may include a communication manager 140f. The communication manager 140e may perform the same or similar functions as communication manager 140a and/or communication manager 140e described above. Additionally, or alternatively, the communication manager 140e may perform one or more other operations described herein.

As indicated above, FIG. 1 is provided as an example. Other examples may differ from what is described with regard to FIG. 1.

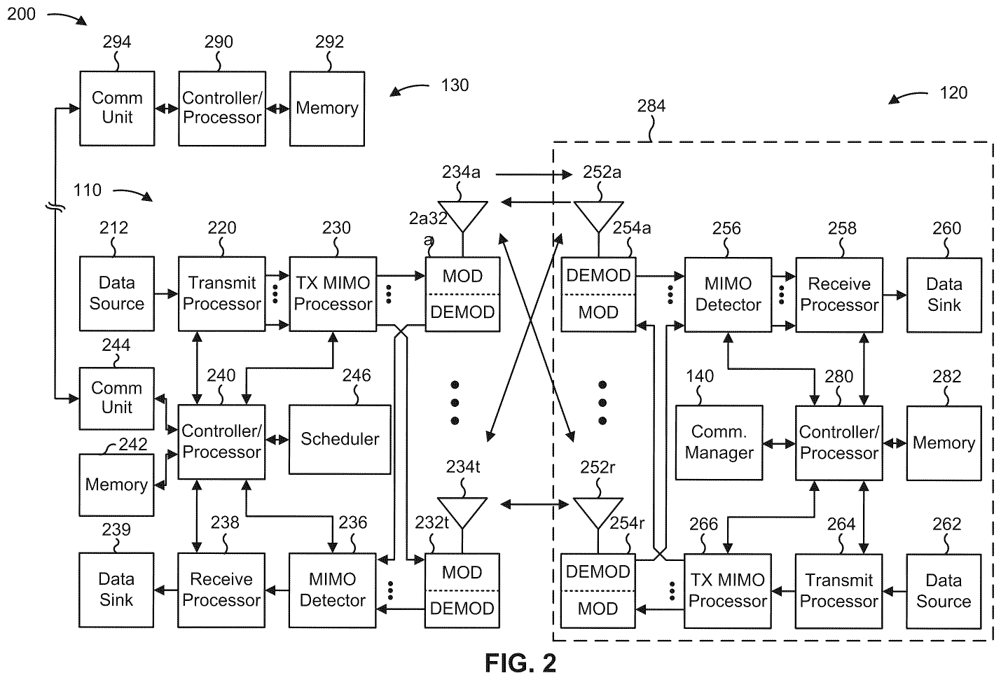

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, a signal to interference noise ratio (SINR) and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

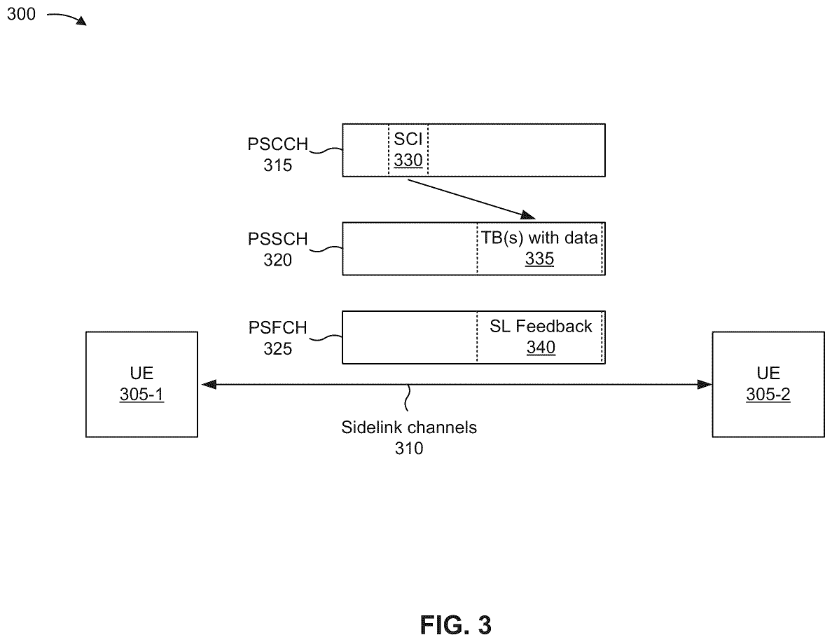

On the uplink, at the UE 120, a transmit processor 264 may receive and process data from a data source 262 and control information (e.g., for reports that include RSRP, RSSI, RSRQ, SINR and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-18).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-18).

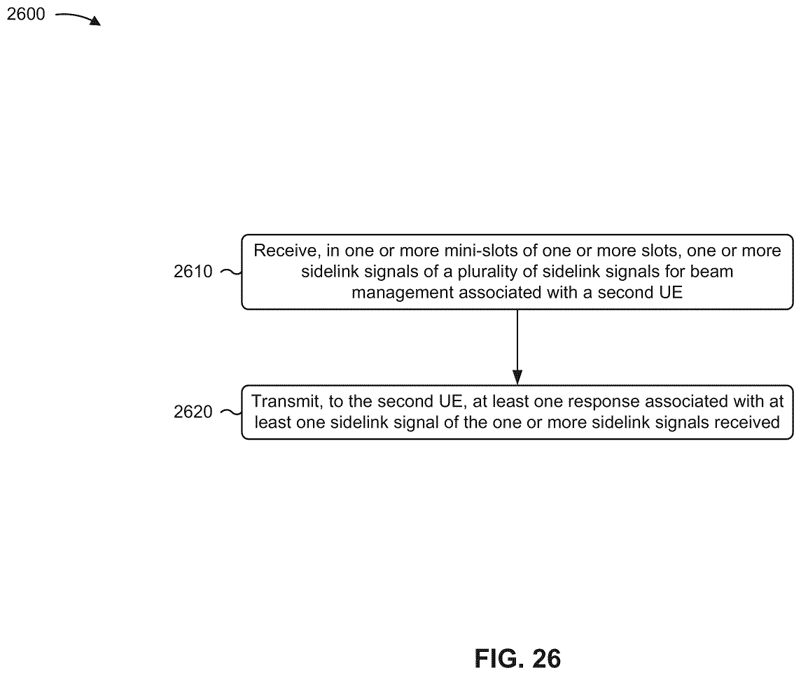

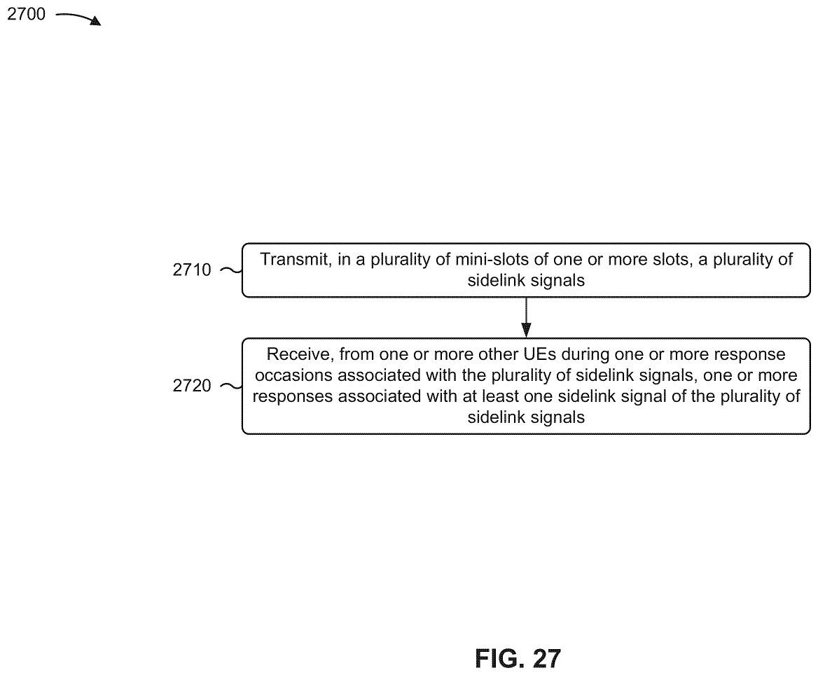

The controller/processor 240 of the network node 110, the controller/processor 280 of the UE 120, and/or any other component(s) of FIG. 2 may perform one or more techniques associated with beam sweeping S-RSBs and/or transmitting beam responses as described in more detail elsewhere herein. For example, the controller/processor 240 of the network node 110, the controller/processor 280 of the UE 120, and/or any other component(s) of FIG. 2 may perform or direct operations of, for example, process 2600 of FIG. 26, process 2700 of FIG. 27, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 2600 of FIG. 26, process 2700 of FIG. 27, and/or other processes as described herein. In some examples, executing instructions may include running the instructions, converting the instructions, compiling the instructions, and/or interpreting the instructions, among other examples.

In some aspects, the UE 120 includes means for receiving, in one or more mini-slots of one or more slots, one or more sidelink reference signal blocks (S-RSBs) of a plurality of S-RSBs associated with a second UE; and means for transmitting, to the second UE, at least one response associated with at least one S-RSB of the one or more S-RSBs received. In some aspects, the UE 120 includes means for transmitting, in a plurality of mini-slots of one or more slots, a plurality of sidelink reference signal block (S-RSBs); and means for receiving, from one or more other UEs during one or more response occasions associated with the plurality of S-RSBs, one or more responses associated with at least one of the plurality of S-RSBs. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications), mesh networking, and/or UE-to-network or UE-to-UE relay. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs)(e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry SCI 330, which may indicate various control information used for sidelink communications, such as one or more resources (e.g., time resources, and/or frequency resources) where a transport block (TB) 335 may be carried on the PSSCH 320. The TB 335 may include data and/or medium access control control element(s)(MAC CE(s)). The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, and/or frequency resources) for the transmission of the PSSCH 320, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink resource allocation mode (e.g., Mode 1) where resource selection and/or scheduling is performed by a network node 110 (e.g., a base station, a CU, or a DU). For example, the UE 305 may receive a grant (e.g., dynamically indicated in downlink control information (DCI), such as dynamic grant, or activated by DCI, such as configured grant type 2, or in a radio resource control (RRC) message, such as for configured grant type 1) from the network node 110 (e.g., directly or via one or more network nodes) for sidelink channel access and/or scheduling. In some aspects, a UE 305 may operate using a resource allocation mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSCCH-RSRP or PSSCH-RSRP parameter) associated with various sidelink channels, and/or may measure an RSRQ parameter (e.g., a PSCCH-RSRQ or PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the resource allocation mode where resource selection and/or scheduling is performed by a UE 305 (e.g., Mode 2), the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

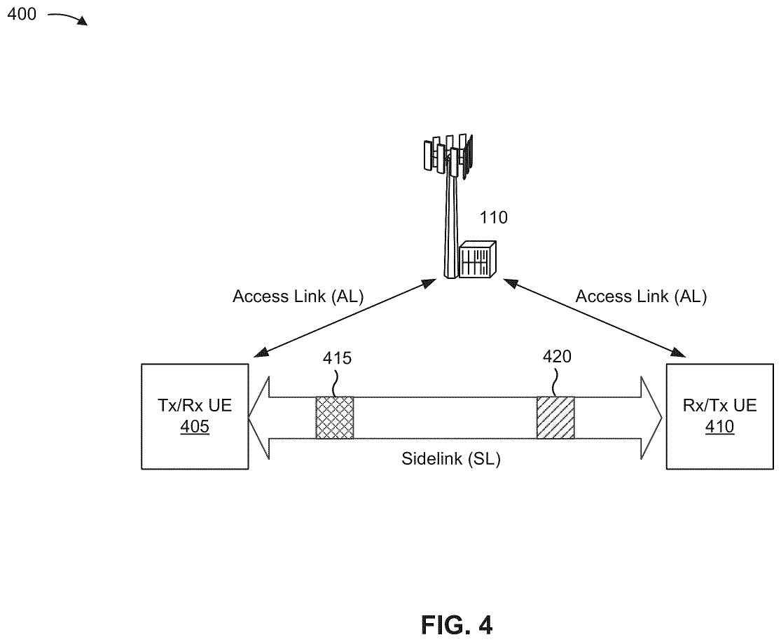

FIG. 4 is a diagram illustrating an example 400 of sidelink communications and access link communications, in accordance with the present disclosure.

As shown in FIG. 4, a Tx/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink resource allocation modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

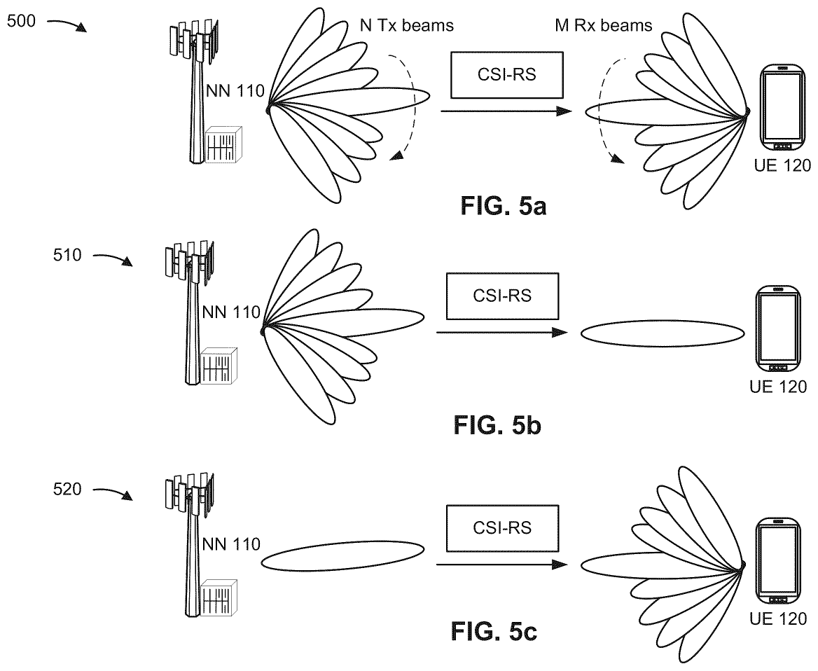

FIGS. 5a-5c are diagrams illustrating examples 500, 510, and 520 of CSI-RS beam management procedures, respectively, in accordance with the present disclosure. As shown in FIGS. 5a-5c, examples 500, 510, and 520 include a UE 120 in communication with a network node 110 in a wireless network (e.g., wireless network 100). However, the devices shown in FIGS. 5a-5c are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

The network node 110 may transmit a synchronization signal block (SSB) to UEs. The SSB may carry information used by a UE for initial network acquisition and synchronization, such as a PSS, an SSS, a physical broadcast channel (PBCH), and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

As shown in FIG. 5a, example 500 may include a network node 110 (e.g., one or more network node devices such as an RU, a DU, and/or a CU, among other examples) and a UE 120 communicating to perform beam management using CSI-RSs. Example 500 depicts a first beam management procedure (e.g., P1 beam management). The first beam management procedure may be referred to as a beam selection procedure, an initial beam acquisition procedure, a beam sweeping procedure, a cell search procedure, and/or a beam search procedure. As shown in FIG. 5a and example 500, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple Tx beams. The network node 110 may transmit a CSI-RS using each transmit beam for beam management. To enable the UE 120 to perform Rx beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 500 has been described in connection with CSI-RSs, the first beam management process may also use SSBs for beam management in a similar manner as described above.

As shown in FIG. 5b, example 510 may include a network node 110 and a UE 120 communicating to perform beam management using CSI-RSs. Example 510 depicts a second beam management procedure (e.g., P2 beam management). The second beam management procedure may be referred to as a beam refinement procedure, a network node beam refinement procedure, a TRP beam refinement procedure, and/or a transmit beam refinement procedure. As shown in FIG. 5b and example 510, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 5c, example 520 depicts a third beam management procedure (e.g., P3 beam management). The third beam management procedure may be referred to as a beam refinement procedure, a UE beam refinement procedure, and/or a receive beam refinement procedure. As shown in FIG. 5c and example 520, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Similar beam management procedures may be used for sidelink beam management operations between UEs in accordance with the present disclosure. Sidelink beam management operations may include initial beam-pairing or beamforming, beam fine tuning, beam maintenance, and beam failure recovery. Beam fine tuning may involve selection of a beam direction and limited beam sweeping around the beam direction. The limited beam sweeping may use narrower beams and/or use more granularity in beam directions.

As indicated above, FIGS. 5a-5c are provided as examples of beam management procedures. Other examples of beam management procedures may differ from what is described with respect to FIGS. 5a-5c. For example, the UE 120 and the network node 110 (or UEs in sidelink communication) may perform the third beam management procedure before performing the second beam management procedure, and/or the UE 120 and the network node 110 (or UEs in sidelink communication) may perform a similar beam management procedure to select a UE transmit beam and/or UE receive beam.

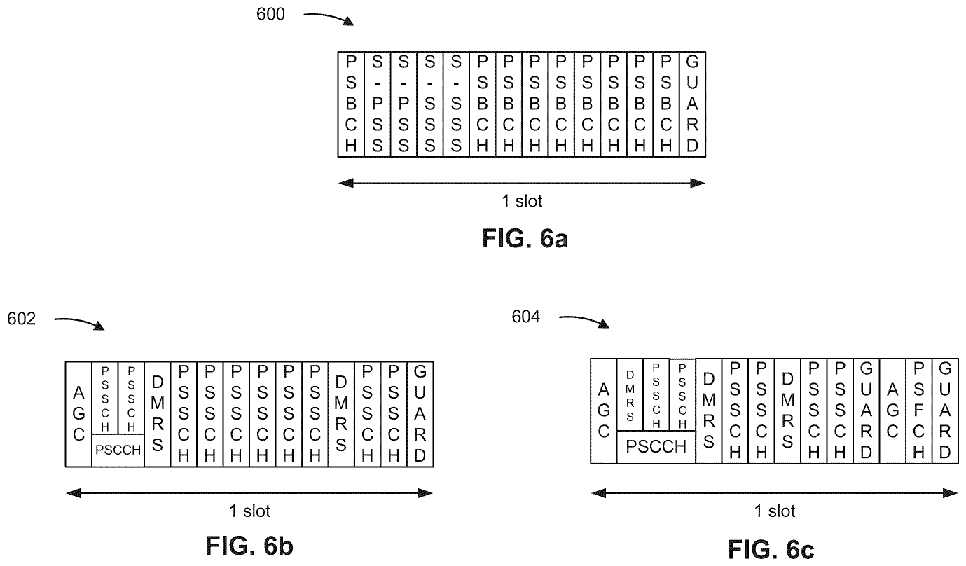

FIGS. 6a-6c are diagrams illustrating examples 600, 602, and 604 of sidelink messaging, respectively, in accordance with the present disclosure. FIGS. 6a-6c are provided as examples. Other examples of sidelink messaging may differ from what is described with regards to FIGS. 6a-6c, including some of the sidelink messaging in accordance with the present disclosure.

Sidelink beam management may involve synchronizing timing between UEs. A sidelink synchronization procedure may define a hierarchy of priorities associated with different synchronization references and require all UEs to continuously search the hierarchy to get to the highest-quality synchronization reference that can be found. When a UE is unable to find any other synchronization reference (such as a global navigation satellite system (GNSS) or a base station) directly or indirectly (relayed), a UE may use its own internal clock to transmit an NR sidelink synchronization signal block (S-SSB). Example 600 of FIG. 6a shows that an S-SSB may include a physical sidelink broadcast channel (PSBCH), a sidelink primary synchronization signal (S-PSS), and a sidelink secondary synchronization signal (S-SSS) on almost all 14 symbols of a slot. In some instances, the UE may transmit one or more S-SSBs with a period of 160 milliseconds (ms) based on a numerology used for communications on the sidelink channel.

UEs may also transmit NR SCI. Example 602 of FIG. 6b shows a first-stage SCI on a PSCCH (2 symbols) transmitted with a PSSCH. The SCI may indicate the time-frequency resources reserved for future transmissions with the PSSCH. The SCI transmissions may be used by sensing UEs to maintain a record of which resources have been reserved by other UEs in the recent past. For semi-persistent scheduling (SPS) on sidelink, a Resource Reservation Period field may indicate a time interval for periodic transmissions in future. Example 604 of FIG. 6c shows a 3-symbol PSCCH.

UEs may transmit an NR sidelink CSI report. For sidelink link adaptation and rank adaptation in unicast transmissions, a transmitting UE may transmit a sidelink CSI reference signal (CSI-RS) multiplexed with a PSSCH transmission. The CSI Request field (e.g., in SCI part 2) may indicate aperiodic sidelink CSI reporting from a receiving UE (via a medium access control control element (MAC CE)). The transmitting UE may wait to trigger the next CSI report from a given receiving UE until the preceding report has been received or a latency bound has expired.

For Uu downlink, a base station (e.g., gNB or network node) may sweep SSBs or CSI-RSs with different transmitting beams for beam forming and fine tuning, beam monitoring with measurements, and candidate beam detection for beam recovery (e.g., as discussed above with respect to FIGS. 5a-5c). However, for sidelink communication, only synchronization reference (SyncRef) UEs may be allowed to transmit a sidelink SSB due to the control of sidelink synchronization reference quality. A non-SyncRef UE, or a sidelink UE that does not provide synchronization assistance, may cause interference to the synchronization references while sweeping sidelink SSBs on different beams for beam management, similar to a base station sweeping SSBs periodically for beam management on a Uu interface.

For sidelink unicast, in some instances a transmitting UE may only transmit a sidelink reference signal (e.g., sidelink CSI-RS, etc.) together with a data transmission on the PSSCH. Therefore, the transmitting UE may need to sweep the sidelink reference signals with different beams at the granularity of a slot. That is, a full slot may be required for each beam. As a result, sweeping across multiple beam directions may require multiple slots (i.e., at least one slot for each beam direction), which can create significant latency issues for sidelink beamforming, beam measurement, and/or beam recovery. Similarly, as shown by example 600, almost all 14 symbols are used for each SSB. If such an SSB is transmitted in each beam direction of a beam sweep, significant signaling resources are consumed. This resource consumption may have an even greater adverse effect in sidelink resource allocation mode 2, where there is no coordination by a network unit (e.g., a base station). In this regard, sweeping sidelink reference signals may consume 3-4 times the resources as compared to beam sweeping for Uu. Further, the transmission of large SSBs in a beam sweeping pattern by multiple UEs can create an unwanted amount of interference. Further still, with more dynamic channels in FR2 frequencies, beamforming or beam switching may occur more frequently, further increasing potential latency, resource usage, and interference issues.

Mini-slot based sensing for sidelink beam management in accordance with the present disclosure eliminates or reduces many of these issues. In some aspects, resources are allocated for a beam response for each sidelink reference signal block (S-RSB) of an S-RSB burst. A receiving UE may determine one or more best transmit beams, one or more best receive beams, one or more beam measurements, and/or one or more candidate beams based on the received one or more S-RSBs of the S-RSB burst. The receiving UE may include in one or more beam responses an indication (implicit or explicit) of the one or more best transmit beams, the one or more best receive beams, and/or the one or more beam measurements, and/or one or more candidate beams, respectively associated with the one or more S-RSBs of the S-RSB burst. In some instances, the receiving UE may transmit a single beam response that includes indications associated with the one or more S-RSBs of the S-RSB burst. In this regard, the mini-slot based sensing for sidelink beam management, including the associated beam response resources and formats, in accordance with the present disclosure can reduce the latency associated with sidelink beamforming, beam measurement, and beam recovery, reduce resource consumption, reduce interference, facilitate timely beamforming and switching on dynamic channels (including FR2), in addition to providing other benefits as will be apparent.

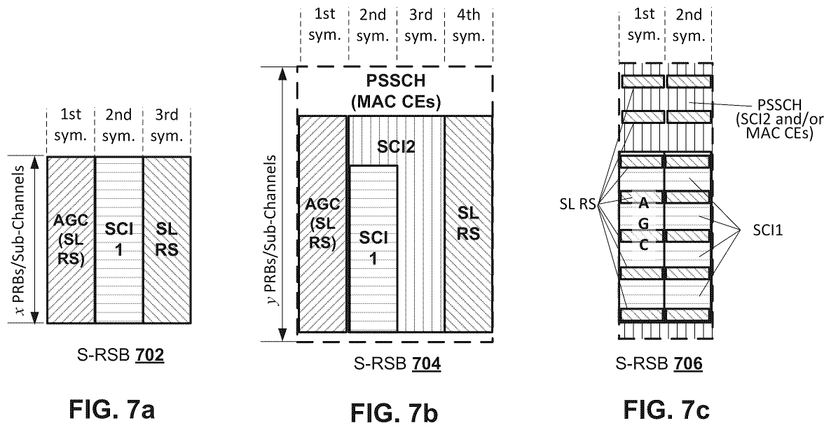

FIG. 7a-7c are diagrams illustrating examples 702, 704, and 706 of S-RSBs, respectively, in accordance with the present disclosure. According to various aspects described herein, a sidelink UE may transmit S-RSBs (e.g., S-RSB 702, S-RSB 704, S-RSB 706) that are shorter in time duration than the sidelink SSBs of examples 600, or sidelink CSI-RS of examples 602 and/or 604, as shown in FIGS. 6a-6c. In this way, sidelink UEs may conserve power and signaling resources while reducing interference and latency when performing beamforming, beam switching, and/or beam recovery procedures.

Each S-RSB (e.g., S-RSB 702, S-RSB 704, S-RSB 706) may include at least one RS and SCI (e.g., SCI-1 and/or SCI-2) that other UEs may use for beam management (e.g., using the RS) and resource sensing for beam sweeping and/or sidelink communication (e.g., based at least in part on the resource reservation(s) indicated in the SCI-1, where the SCI-1 may be directionally broadcast on a transmit beam without scrambling with any RNTI). The S-RSB 702 of FIG. 7a spans 3 symbols. As shown, the S-RSB 702 includes a first RS in the first symbol that may be used for automatic gain control (AGC), a one-symbol SCI in the second symbol, and a second RS in the third symbol that may be used for other beam management operations. In some instances, the second RS may be used for beamforming, beam fine tuning, and/or beam measurement (e.g., a reference signal received power (RSRP) parameter, a received signal strength indicator (RSSI) parameter, a reference signal received quality (RSRQ) parameter, a signal to interference noise ratio (SINR), and/or a CQI parameter). The second RS may be the same as the first RS or different than the first RS.

In some aspects, the first RS and/or the second RS may be a frequency domain Zadoff-Chu (ZC) sequence (e.g., aₙ ∈ {α₀, α₁, . . . , α_{N}}) mapped to each resource element or subcarrier (e.g., sₙ ∈ {s₀, s₁, . . . . s_{N}}) of x resource blocks (RBs) or physical resource blocks (PRBs) or sub-channels in frequency within a resource pool, wherein the Zadoff-Chu root sequence index may be derived from the SCI on PSCCH (e.g., based on the SCI's CRC parity bits, for example, mapped with a subset of LSBs or MSBs of the parity bits or mapped with the whole set of the parity bits) or may be mapped based on a parameter RS_root (e.g., {0, 1, 2, . . . }) that may be (pre-) configured or specified. A value of the RS_root may be randomly selected if RS_root contains multiple values.

In some aspects, the first RS and/or the second RS may be a frequency domain m-sequence (e.g., αₙ ∈ {α₀, α₁, . . . , α_{N}}), mapped to each resource element or sub-carrier (e.g., sₙ ∈ {s₀, s₁, . . . . s_{N}}) of x resource blocks (RBs) or physical resource blocks (PRBs) or sub-channels in frequency within a resource pool. For example, αₙ=1-2 p (m), wherein p (m) is a polynomial function with m derived from the SCI on PSCCH (e.g., based on the SCI's CRC parity bits, for example, mapped with a subset of LSBs or MSBs of the parity bits or mapped with the whole set of the parity bits) or mapped to a parameter RS_m (e.g., {0, 1, 2, . . . }) that may be (pre-) configured or specified. A value of the RS_m may be randomly selected if RS_m contains multiple values.

In some aspects, the first RS and/or the second RS may be a Gold sequence (e.g., αₙ ∈ {α₀, α₁, . . . , α_{N}}), mapped to each resource element or sub-carrier (e.g., sₙ ∈ {s₀, s₁, . . . . s_{N}}) of x resource blocks (RBs) or physical resource blocks (PRBs) or sub-channels within a resource pool. For example, αₙ=(1-2 p₀(m₀))(1−2p₁(m₁))(e.g., combined with two m-sequences), wherein p₀(m₀) and p₁(m₁) are two polynomial functions with m₀ and m₁ derived respectively from the SCI on PSCCH (e.g., based on the CRC parity bits, pᵢ ∈ {p₀, p₁, . . . p_{L}}, for example, mapped differently with the whole set of the CRC parity bits, m₀=Σᵢ₌₀^{L-1}pᵢ·2^{L-1-i} and m₁=Σᵢ₌₀^{L-1}pᵢ·2ⁱ; mapped with different subsets of the CRC parity bits, m₀ is mapped with a first subset of the CRC parity bits and m₁ is mapped with a second subset of the CRC parity bits); or mapped respectively to parameters RS_m0 (e.g., with a value of {0, 1, 2, . . . , M0}) and RS_m1 (e.g., with a value of {0, 1, 2, . . . , M1}) that may be (pre-) configured or specified. A value of the RS_m0 and a value of the RS_m1 may be randomly selected respectively if RS_m0 and RS_m1 each contains multiple values.

In some aspects, the RS may be a pseudo-random sequence (e.g., αₙ ∈ {α₀, α₁, . . . , α_{N}}), mapped continuously (e.g., 1 resource element or sub-carrier in every RB with density as 1 or 3 resource elements or sub-carriers in each RB with density as 3) or discontinuously over y RBs or PRBs or sub-channels (e.g., even or odd RBs with density as 0.5,)(e.g., with a comb structure as shown in S-RSB 706). For example,

$${a}_{n} = \frac{1}{\sqrt{2}} ( 1 - 2 c ( 2 n ) ) + j \frac{1}{\sqrt{2}} ( 1 - 2 c ( 2 n + 1 ) ) ,$$

with pseudo-random sequence c(n) generated with a length-G Gold sequence. The pseudo-random sequence c(n) may be initiated with cᵢₙₜ (e.g., cᵢₙₜ=(2^{z}(N_{symb}^{slot}n_{s,f}^{μ}+l+1)(2m+1)+m)mod 2^{G}, where z is the bit number of m, N_{symb}^{slot}, is the symbol number per slot, n_{s,f}^{μ} is the slot number within a frame for numerology μ, l is the OFDM symbol within the slot, and m may be derived from the SCI on PSCCH (e.g., based on the SCI's CRC parity bits, for example, mapped with a subset of LSBs or MSBs of the parity bits or mapped with the whole set of the parity bits as exemplified previously) or mapped to a parameter RS_m (e.g., {0, 1, 2, . . . , M}) that may be (pre-) configured or specified. A value of the RS_m may be randomly selected if RS_m contains multiple values. In the case that the pseudo-random sequence based RS doesn't map to each of the resource elements or subcarriers over y RBs or PRBs or sub-channels (e.g., a comb structure is distributed evenly among the y RBs), the RS may be interleaved with SCI on PSCCH (e.g., SCI-1 is punctured or rate matched with the RS on the SL RS symbol(s) as shown in S-RSB 702 of FIG. 7a or the SCI-1 is punctured or rate matched with the RS in the shared symbol(s) as shown in S-RSB 706 of FIG. 7c), the RS may be interleaved with SCI-2 multiplexed on PSSCH (e.g., SCI-2 is punctured or rate matched with the RS on the SL RS symbol(s) as shown in S-RSB 704 of FIG. 7b), the RS may be interleaved with MAC CE(s) carried on PSSCH (e.g., PSSCH with MAC CE(s) is punctured or rate matched with the RS on the SL RS symbol(s) as shown in S-RSB 704 of FIG. 7b), and/or any combination alike.

The SCI may comprise SCI-1 (see, e.g., S-RSB 702, S-RSB 704, S-RSB 706) and/or SCI-2 (see, e.g., S-RSB 704). In some aspects, the SCI may indicate a sidelink beam burst structure and one or more resources associated with the S-RSB. The sidelink beam burst structure may include one or multiple beam sweeping transmissions for beam pairing and/or one or multiple associated beam response (e.g., a response with pairing, fine tuning, beam measurement, or candidate beam selection, etc.) occasions. In this regard, the SCI may indicate the time and frequency resources, beam direction(s), and/or other parameters for each transmission (e.g., each S-RSB) of the sidelink beam burst. The SCI may also indicate the resources for each response occasion (e.g., a response message carried on PSSCH, such as discovery message or direct communication request message responding to the beast beam; a response indication in MAC CE or SCI with responding UE ID, beam pairing information, and/or beam measurement information; and/or a response signal carried on PSFCH, etc.) of the sidelink beam burst associated with the corresponding beam pairing transmission.

The SCI may indicate time and frequency resources reserved for one or more S-RSB transmissions and/or beam response occasions. In some instances, the SCI may indicate time and frequency resources (e.g., semi-persistent scheduling (SPS)) used for future S-RSBs transmissions, such that other UEs are aware of the transmission pattern of the S-RSBs. The other UEs may use the indicated resources to monitor for the S-RSBs and/or to schedule transmissions and/or receptions around the S-RSBs to avoid transmission collisions (e.g., collisions between S-RSB bursts from different UEs or collisions between S-RSB bursts and other sidelink communications such as beam report from different UEs). In some instances, the SCI may indicate time and frequency resources to be used for a beam response occasion associated with each S-RSB. Receiving UE(s) may transmit one or more beam responses to the transmitting UE of the S-RSB using the indicated time and frequency resources. In some aspects, the receiving UE(s) transmit a beam response during a response occasion associated with the best beam(s)(e.g., for initial beam pairing) and/or candidate beam(s)(e.g., beam maintenance or beam failure recovery).

The SCI may include beam information (e.g., transmission configuration indicator (TCI) state with quasi-co-location (QCL) types such as type A or type D or spatial filter for a receive beam parameter or for beam association or correspondence, a beam identifier or beam index of a beam used to transmit the S-RSB for beam association or resource mapping, beam type (e.g., shape of the beam, such as wide or narrow), a number of total beams within a S-RSB burst, for example, associated with a beam type, and S-RSB information (e.g., S-RSB index of an S-RSB within an S-RSB burst for beam association or resource mapping, S-RSB structure or configuration for a UE to identify the proper S-RSB burst associated with resources in time and frequency and space). The S-RSB burst structure or configuration information may include an S-RSB configuration index or resource indication (e.g., a codepoint of S-RSB configuration or resource allocation associated with burst duration and/or S-RSB burst period in subframes or slots or mini-slots, based at least in part on a numerology configured for a sidelink BWP) or total number of S-RSBs within a S-RSB burst or a bitmap indicating the subframes and/or slots and/or mini-slots and/or symbols occupied with the current S-RSB burst or to be occupied by the future S-RSB burst(s). Based on a combination of one or more of the beam index and the number of total beams, the S-RSB index and the total number of S-RSBs or the S-RSB structure or configuration, the S-RSB bitmap, and/or any combination alike, a UE may gain the overall resource allocation of S-RSB burst(s) transmitted or to be transmitted from other UE(s) even with the detection of a single S-RSB transmission of an S-RSB burst using a directional receiving beam.

In some aspects, the SCI may include a source identifier (ID) or a destination ID, such as a Layer 1 (L1) source ID for identifying the transmitter of the one or more S-RSBs of a burst. For example, an Rx UE may determine whether to pair a receive beam with the Tx UE's transmit beam and/or whether to report the beam measurement to the Tx UE based at least in part on the Tx UE's ID. The SCI may include a destination ID, such as an L1 destination ID for identifying an Rx UE with which the Tx UE may conduct beam sweeping to the Rx UE for transmitting beam fine tuning or receiving beam fine tuning or for beam maintenance or beam monitoring with beam measurement and report or for beam recovery with candidate beam selection.

In some aspects, the SCI may include a destination ID or link ID for identifying a sidelink communication (e.g., a L1 destination ID for identifying a groupcast or broadcast or a link ID for identifying a unicast) associated with the one or more S-RSBs of a burst. For example, an Rx UE may determine whether to pair a receive beam and/or fine tune a transmitting or receiving beam and/or whether to report the beam measurement or candidate beams for a sidelink communication based at least in part on the destination ID or link ID.

In some aspects, the SCI may include an application ID or a service ID (e.g., service type or service code for identify a service) associated with the one or more S-RSBs of a burst. For example, an Rx UE may determine whether to pair a receive beam and/or fine tune a transmitting or receiving beam and/or whether to report the beam measurement or candidate beams for an application or service based at least in part on the application ID or service ID.

In some aspects, the SCI may include a pair ID (e.g., identify a physical connection or association between two devices or UEs, which may include one or more unicast connections) associated with the one or more S-RSBs of a burst. For example, an Rx UE may determine whether to fine tune a transmitting or receiving beam and/or report the beam measurement or candidate beams for the physical connection or association in part on the pair ID.

The SCI may indicate a type of beam management operation, whether initial beamforming, beam fine tuning of transmit (Tx) beams, beam fine tuning of receive (Rx) beams, beam measurements, or beam recovery (e.g., an Rx UE may detect the proper S-RSB burst(s) for beamforming, beam fine tuning, beam maintenance, and/or candidate beams for beam recovery). In some aspects, the SCI may be multiplexed or interleaved with the SL RS on the SL RB symbol (e.g., the SL RS with a comb structure (e.g., as shown in S-RSB 706).

In another example, the S-RSB 704 spans 4 symbols and includes 2 symbols of SCI as shown. The SCI may include SCI part 1 (may also be referred to as SCI1 or SCI-1) and SCI part 2 (may also be referred to as SCI2 or SCI-2). The SCI part 2 may indicate preferred resources or non-preferred resources (e.g., for beam responses or discovery messages or direct communication messages or sidelink communications such as establishing a PC5 connection following the beam sweeping) associated with the S-RSB of an S-RSB burst (e.g., associated to a beam or space direction). Alternatively, the SCI part 2 may include the source ID, the destination ID, the link ID, the application ID or service ID, the pair ID, and/or other identifiers or information for a beam management operation. Alternatively, the SCI part 2 may include a type of beam management operation as described previously. Alternatively, the SCI part 2 may include some of the beam information or S-RSB information not used for sensing purpose. If the S-RSB is 4 symbols, the SCI part 2 may be included in the third symbol or in the third symbol and part of the second symbol (as shown in S-RSB 704 of FIG. 7b). The second RS may be included in the fourth symbol of the S-RSB 704. In some aspects, the SCI part 2 may be multiplexed or interleaved with the SL RS (e.g., the SL RS with a comb structure (e.g., as shown in S-RSB 706 of FIG. 7c).

In some aspects, one or more MAC CEs may be multiplexed with the S-RSB symbols, e.g., over symbols 1˜ 4 for a 4-symbol S-RSB (see, e.g., S-RSB 704). The MAC CE(s) may contain some of the information described above for SCI part 2 (e.g., preferred or non-preferred resources, IDs such as application or service ID or service type, type of beam management operation, etc.), additional information with beam or S-RSB burst (e.g., transmitting power or transmitting power scale, etc.), or other information. In some aspects, the MAC CE(s) may be multiplexed or interleaved with the SL RS on the SL RB symbol (e.g., the SL RS with a comb structure (e.g., as shown in S-RSB 706)

In another example, the S-RSB 706 spans 2 symbols. The S-RSB 706 may be particularly suitable for use with 2-symbol mini-slots but may be used with mini-slots having a larger number of symbols. The S-RSB 706 includes a first symbol associated with automatic gain control (AGC) and a second symbol associated with beam pairing. As shown, the first symbol and the second symbol of the S-RSB 706 include the same information. In particular, both symbols of the S-RSB 706 include SCI interleaved with an SL RS (e.g., sidelink CSI-RS with a comb structure configured or preconfigured). In this regard, the SCI may be punctured by the SL RS or be rate matched around a comb-structured SL RS. Additionally, or alternatively, the PSSCH carrying SCI-2 or MAC CE(s) may also be punctured by the SL RS or be rate matched around a comb-structured SL RS.

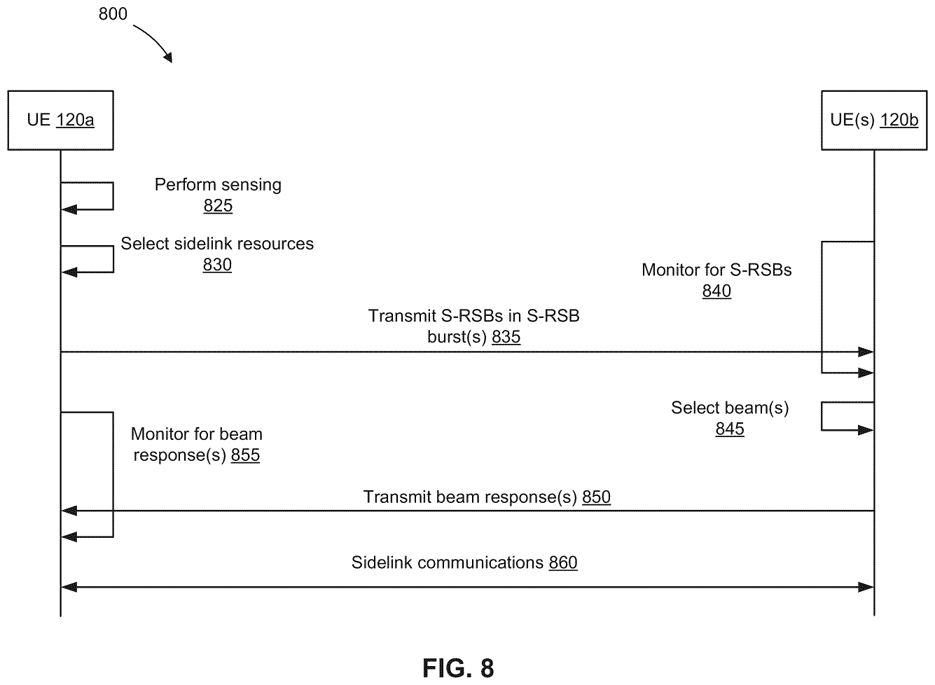

FIG. 8 is a diagram illustrating an example 800 associated with sensing and transmitting sidelink reference signal blocks (S-RSBs) and sidelink communications, in accordance with the present disclosure. Example 800 shows sensing-based beam sweeping with the transmission of S-RSBs and associated sidelink communications. As shown by reference number 825, UE 120a may perform sensing (e.g., based at least in part on a sidelink beam management configuration, for example, the configuration for initial beam pairing, beam fine tuning, beam maintenance or monitoring, or beam failure recovery, etc., decoding SCI of each S-RSB to determine used or reserved resources, and/or a sidelink measurements associated with each received S-RSB such as RSSI, CBR, RSRQ, RSRP, and/or SINR measurements) to sense or detect the resources or resource patterns of S-RSB bursts transmitted or to be transmitted by other UEs in a resource pool pre-configured or configured for beam management and/or sidelink communications. UE 120a may then determine the resources or resource patterns that can be used for transmitting one or more S-RSB bursts without colliding with other UE's S-RSB bursts based on the sensing. In some aspects, the sensing may include sensing using receive beams sweeping in multiple directions (e.g., for S-RSB burst for initial beam pairing), such as covering an angular range of UE 120a for detecting multiple S-RSBs within one or more S-RSB bursts, and the UE 120a may exclude resources (from candidate resources) reserved by the SCI (e.g., decoded) or measured (e.g., above a threshold pre-configured or configured) with the detected one or more S-RSBs within the angular range. In some aspects, the sensing may include sensing using one receive beam in a direction (e.g., for S-RSB burst for beam fine tuning), and the UE 120a may exclude resources (from candidate resources) reserved by the SCI or measured with the detected one or more S-RSBs of one or more S-RSB bursts and/or other reserved resources that may be derived based on the beam index or S-RSB index and the number of total beams or the number of total S-RSBs within an S-RSB burst or the indication of an S-RSB structure or configuration or S-RSB resource indication. As shown by reference number 830, the UE 120a may select sidelink resources (e.g., time and frequency resources) for transmitting S-RSBs based at least in part on the candidate resources that are still available (e.g., within at least the angular range of UE 120a) for transmitting one or more S-RSB bursts based on the sensing. In this regard, the UE 120a may select the sidelink resources so as to avoid colliding with other UE's S-RSB bursts or other sidelink communications over the same resources with a certain beam direction.

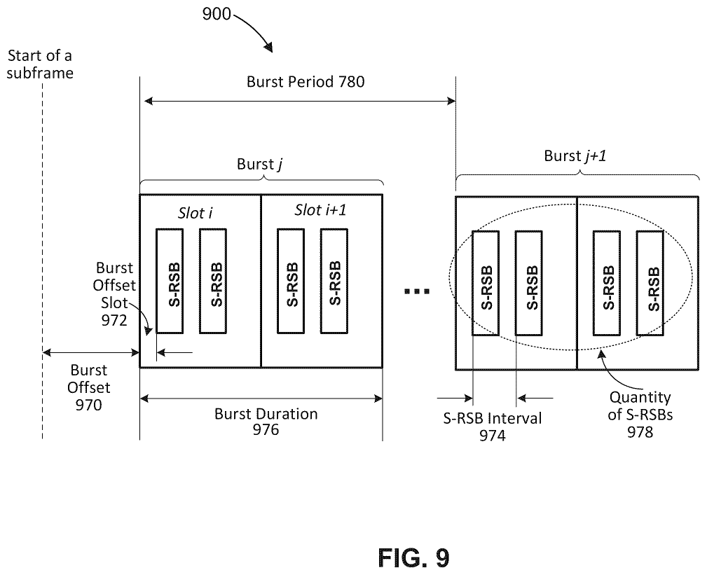

As shown by reference number 835, the UE 120a may transmit one or more S-RSBs in one or more S-RSB bursts in a beam sweeping pattern. UE 120a may transmit the one or more S-RSB bursts using a sidelink resource pool. The sidelink resource pool may be for sidelink beam management pre-configured or configured (e.g., via SIB 12 or dedicated RRC configuration message from network node 110a) and/or otherwise indicated to the UE 120a (e.g., by network node 110a via RRC reconfiguration or MAC CE or DCI activation or peer UE 120b via PC5 RRC or PC5 MAC CE). The sidelink resource pool may be dedicated for S-RSB bursts. The sidelink resource pool for S-RSB bursts may be frequency division multiplexed (FDMed) and/or time division multiplexed (TDMed) with other transmission and/or reception resource pools. The UE 120a may transmit the S-RSBs using the sidelink resources selected from the sidelink resource pool based on the sensing and/or the sidelink beam management configuration. Each S-RSB transmitted within an S-RSB burst may include an S-RSB burst index or identifier (e.g., for beam association or resource mapping). As shown in FIGS. 9-16 and 18-22, an S-RSB burst, including associated beam responses, may be structured or configured in various ways. In this regard, there may be different S-RSB burst structures or configurations, including different beam response structures or configurations, for different functions (e.g., beamforming, beam fine tuning, beam maintenance, beam recovery, etc.) and/or for different numerologies with different BWPs or sidelink carriers.

Referring to FIG. 9, shown therein is a diagram illustrating an example 900 of S-RSB bursts, in accordance with the present disclosure. As shown, an S-RSB burst structure may include a burst offset 970 (e.g., a starting point within a subframe or a frame, for example, a slot index within a subframe or frame), a burst offset slot 972 (e.g., a starting point within a slot, for example, a mini-slot or symbol index within a slot), an S-RSB interval 974 between adjacent S-RSBs (e.g., in symbols or mini-slots), a burst duration 976 of the S-RSB burst (e.g., in symbols, mini-slots, slots, or subframes, in frames, in absolute time, etc.), a quantity of S-RSBs 978 within the S-RSB burst, and/or a burst period 980 (e.g., time period in mini-slots, slots, subframes, frames or absolute time) between S-RSB bursts. An S-RSB within the S-RSB burst may indicate the burst structure or configuration information (e.g., S-RSB configuration index). Additionally, or alternatively, an S-RSB burst structure or configuration may be specified, pre-configured, or configured based on a slot or mini-slot configuration and/or a numerology associated with a sidelink BWP.

As shown by reference number 840, the UE 120b may monitor for S-RSBs in the sidelink resource pool. In some instances, the UE 120b may monitor for the S-RSBs based in part on a sidelink beam management configuration, which may be preconfigured, configured, and/or otherwise indicated to the UE 120b (e.g., by network node 110a via RRC reconfiguration or MAC CE or DCI activation or peer UE 120b via PC5 RRC or PC5 MAC CE). In some aspects, the UE 120b may receive one or more S-RSBs from the S-RSB bursts transmitted by the UE 120a using a receive beam (e.g., using a common receive beam for one or more S-RSBs of an S-RSB burst transmitted with a set of transmit beams) or a receive beam sweep pattern (e.g., using a first receive beam for a first number of S-RSBs (e.g., 1, 2, 3, etc.) of an S-RSB burst, using a second receive beam for a second number of S-RSBs (e.g., 1, 2, 3, etc.) of the S-RSB burst, and so forth; or using a first receive beam for a first S-RSB burst, using a second receive beam for a second S-RSB burst, and so forth). A receive beam sweep pattern may also be used for receive beam fine tuning (e.g., sweeping receive beams for an S-RSB burst with a fixed transmit beam). In some aspects, one receive beam may also be used for transmit beam fine tuning (e.g., select a best transmit beam with transmit beam sweeping in an S-RSB burst). In some aspects, one or more receive beams may be used for beam maintenance or monitoring or for candidate beam selection.

As shown by reference number 845, the UE 120b may select one or more Tx and/or Rx beam(s) based at least in part on the received S-RSB(s). The UE 120b may select the Tx and/or Rx beam(s) based at least in part on measurements of S-RSBs in the one or more S-RSB bursts (e.g., the highest SL-RSRP, SL-RSRQ, SL-SINR measurement). In some aspects, the UE 120b may select an S-RSB or a Tx beam associated with an S-RSB of the one or more S-RSB bursts using a receiving beam that is paired to the selected Tx beam as part of a beam-pair link. In some aspects, the UE 120b may select an S-RSB or a Tx beam associated with an S-RSB of the one or more S-RSB bursts for fine tuning transmit beam. In some aspects, the UE 120b may select a receive beam associated the best measurement with an S-RSB of the one or more S-RSB bursts for fine tuning receive beam. In some aspects, the UE 120b may select one or more S-RSBs or one or more Tx beams associated with one or more S-RSBs of the one or more S-RSB bursts for candidate beam selection.

As shown by reference number 850, the UE 120b transmits a beam response (e.g., beam pairing response, beam fine tuning response, beam measurement response, candidate beam selection response, and/or any alike beam response) to the UE 120a using a transmitting beam corresponding to its Rx beam that is paired with the selected Tx beam(s) associated to the S-RSB(s) with the beast measurement(s). In this regard, the UE 120b may transmit the beam response using resources for the beam response occasion(s) associated with the S-RSB(s) of the selected Tx beam(s). In some aspects, the UE 120b transmits a separate beam response for each selected Tx beams using the associated beam response occasion. In some aspects, the UE 120b transmits a single beam response for multiple selected Tx beams using a single beam response occasion. For example, the UE 120b may transmit a single beam response with indications and/or measurements for multiple selected Tx beams (e.g., candidate beams) using a beam response occasion associated with a selected Tx beam (e.g., a best Tx beam). In some instances, the beam response occasions(s) may be pre-configured or configured or activated (e.g., by a network node or the Tx UE) associated to one or more S-RSB burst configurations. In some instances, the beam response occasions(s) may be dynamically indicated (e.g., by the Tx UE) in SCI of each S-RSB of the S-RSB burst.

As shown by reference number 855, the UE 120a monitors for a beam response (e.g., beam pairing response, beam fine tuning response, beam measurement response, candidate beam selection response, and/or any alike beam response) associated with one of the S-RSBs of the S-RSB burst from other UEs (UEs 120b) using a receiving beam corresponding to a Tx beam associated with one of the S-RSBs of the S-RSB burst. The UE 120a may monitor for the beam response(s) using resources for communicating a beam response associated with one of the S-RSBs, wherein the response resources may be pre-configured or configured or activated (e.g., by a network node or the Tx UE) associated to one or more S-RSB burst configurations or dynamically indicated in the SCI of the S-RSB. In some instances, the UE 120a receives a beam response from the UE(s) 120b based on the monitoring.

As shown by reference number 860, the UE 120a may communicate with the UE(s) 120b based on the beam response(s) received. For example, the UE 120a may transmit a communication to the UE 120b and/or receive a communication from the UE 120b based on the beam response(s) received (e.g., initial beam pairing confirmation, discovery messages or direct connection establishment messages, beam switching indication based on the Tx beam fine tuning or beam measurements, beam selection from candidate beams for beam recovery, or any sidelink messages). In some aspects, the UE 120a and/or the UE 120b may use the beam direction or paired Tx and Rx beams associated with a beam response for sidelink communications between the UE 120a and the UE 120b.

In some instances, the UE 120b may communicate using the selected Tx and/or Rx beam(s). For example, in some aspects, UE 120b may perform sensing for the sidelink communication and select resources (e.g., time and frequency) for the sidelink communication based at least in part on the Rx beam paired with the selected Tx beam. UE 120b may sense and select the resources from a resource set based at least in part on a configured time duration after the S-RSB of the one or more S-RSBs in the one or more S-RSB bursts, a mapping of the resource set with the S-RSB of the one or more S-RSBs in the one or more S-RSB bursts, and/or preferred or non-preferred resources indicated in SCI part 2 or MAC CE(s) included in the S-RSB of the one or more S-RSBs in the one or more S-RSB bursts. The S-RSB may be associated with the selected Tx beam. The UE 120b may map the resource set to an S-RSB of the S-RSB burst based at least in part on a received Tx beam ID, a Tx beam index, and/or an S-RSB index indicated by SCI in an S-RSB associated with the selected beam.

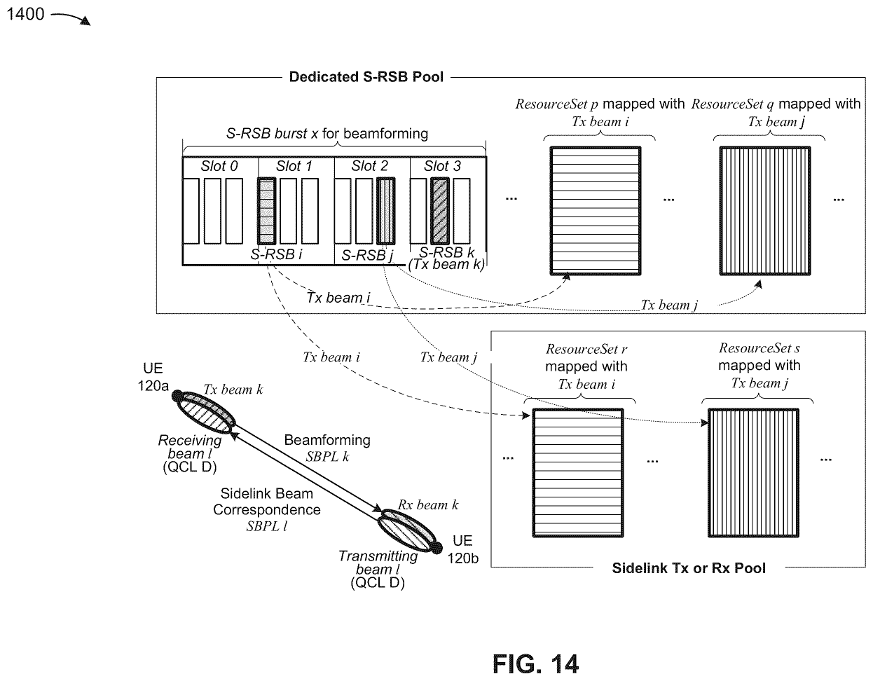

In some instances, the UE 120b may transmit a sidelink communication using the beam and the resources associated with the selected Tx beam. The sidelink communication may be a discovery message (e.g., peer discovery or relay UE discovery after the initial beamforming), a direct communication request (DCR)(e.g., to establish a PC5 RRC connection after the initial beamforming), or a beam report (e.g., report the selected (fine) transmit (Tx) or (fine) receive (Rx) beam(s) and/or the associated sidelink beam pair(s) or sidelink beam pair links after the initial beamforming), or a beam measurement, or a candidate beam list (e.g., with associated measurements). The UE 120b may transmit the sidelink communication using a transmitting beam that corresponds to a receive beam of UE 120b paired with the selected transmit beam from UE 120a (see, e.g., further discussion regarding this in the context of FIG. 14). The UE 120b may determine the transmitting beam based at least in part on a selected Tx beam ID, a selected Tx beam index, an S-RSB index associated with a selected Tx beam, a TCI state (e.g., QCL type for the RS) indicated by SCI in an S-RSB associated with the selected Tx beam, and/or a spatial filter (e.g., beamforming parameters) indicated by the SCI.

In some instances, the UE 120a may monitor for a sidelink communication from the UE(s) 120b based at least in part on each S-RSB of the one or more S-RSBs of the one or more S-RSB bursts. The UE 120a may monitor for the sidelink communication in one or more resource sets (in a sidelink resource pool) based at least in part on a configured time duration after each S-RSB of the one or more S-RSBs in the one or more S-RSB bursts, a mapping of each resource set of the one or more resource sets with a respective S-RSB of the one or more S-RSBs in the one or more S-RSB bursts, and/or preferred or non-preferred resources indicated in SCI part 2 included in each S-RSB of the one or more S-RSBs in the one or more S-RSB bursts. The UE 120a may monitor for a sidelink communication using one or more receiving beams that are based at least in part on one or more respective transmitting beams (e.g., based on beam correspondence at UE 120a) that are associated with each S-RSB of the one or more S-RSBs in the one or more S-RSB bursts. The UE 120a may receive the sidelink communication based on the monitoring.

As a result of the use of mini-slot, sensing-based S-RSB bursts and associated beam responses in accordance with the present disclosure, the sidelink communications between UE 120a and UE(s) 120b and with other sidelink UEs can be improved as a result of less interference and improved beam management. With the S-RSBs being of a smaller size than sidelink SSBs, less signaling resources are used, latency is reduced, and power is conserved, which improves the overall sidelink system resource utilization and performance.

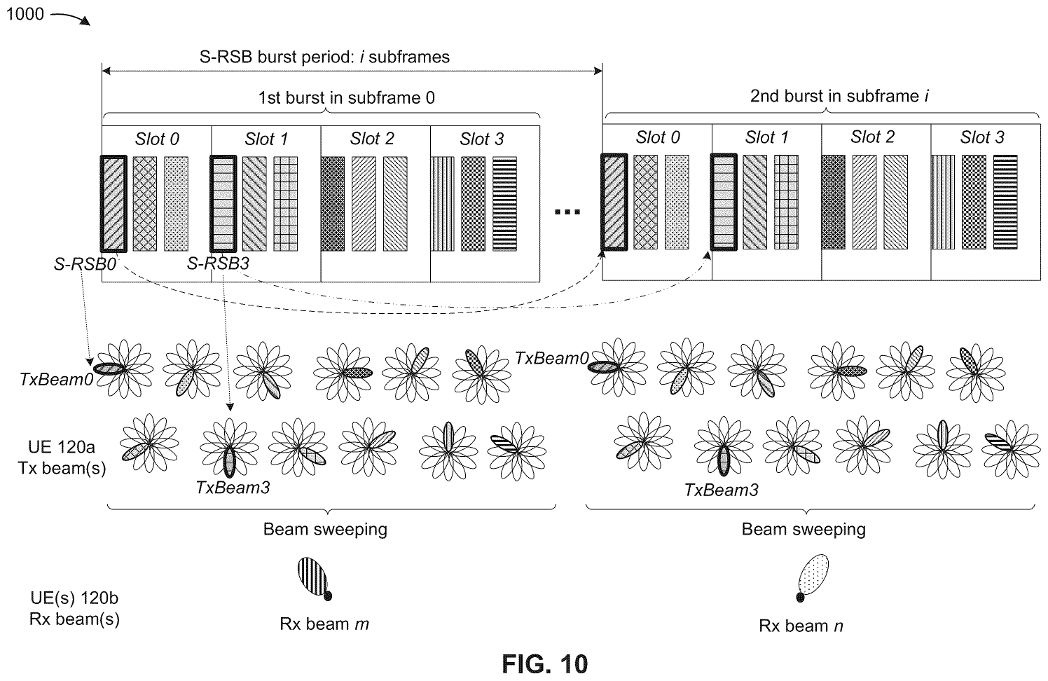

FIG. 10 is a diagram illustrating an example 1000 of a beam sweeping pattern for beamforming, in accordance with the present disclosure. A UE may transmit a long S-RSB burst with multiple S-RSB transmissions on multiple respective Tx beams of the beam sweeping pattern. The beam sweeping pattern may include a wide range of beam directions.

The S-RSB burst for beamforming may be specified, preconfigured, or configured (e.g., via system information such as SIB12 or SIB x or common or broadcast RRC message) so that all UEs supporting FR2 for sidelink communications may acquire such information for initial beamforming or pairing on sidelink. The information may include, for example, burst structure(s), a burst offset, a burst offset in slot, a burst duration, a burst period, a quantity of repeated S-RSBs per burst, and/or an S-RSB interval. Further, the information may be on a BWP basis with a numerology.

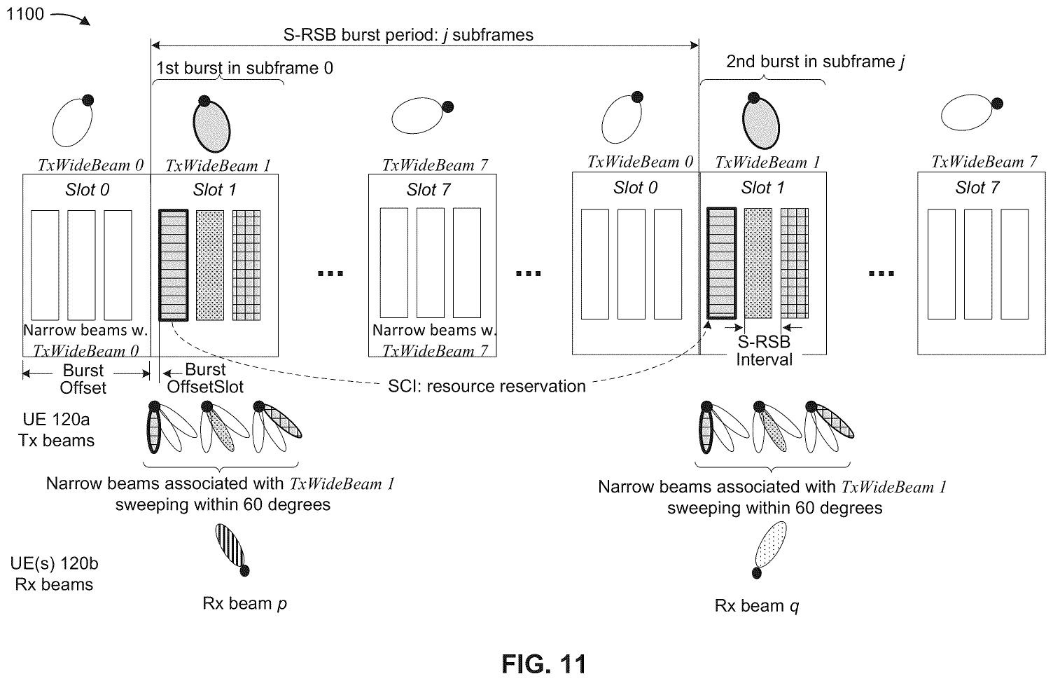

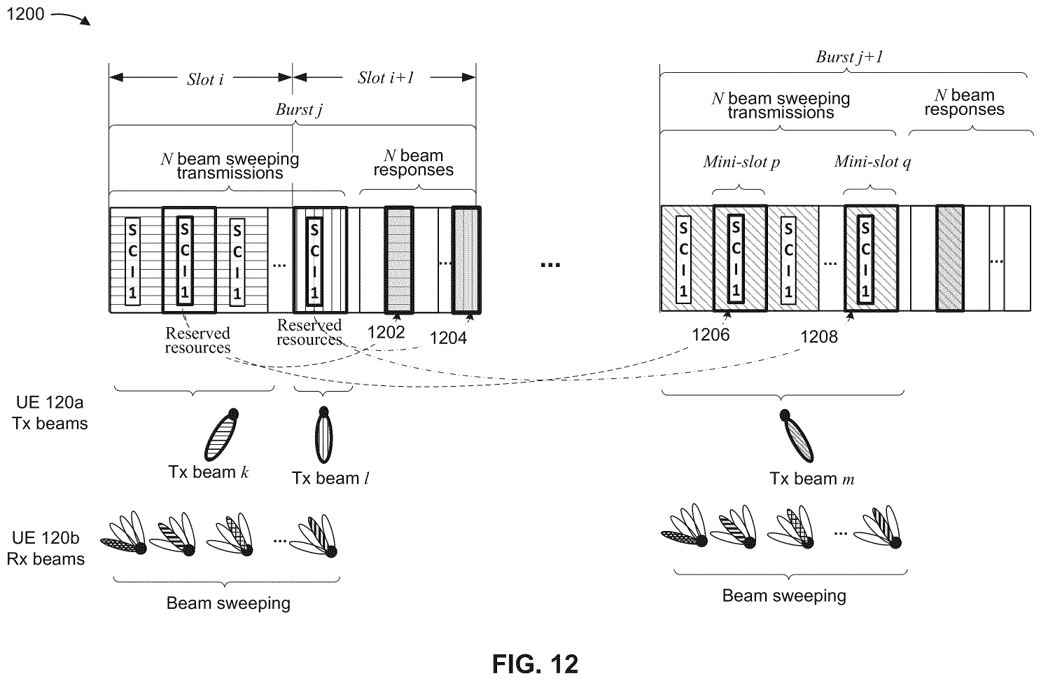

Example 1000 shows beamforming with the burst offset of 0 slots (e.g., starting from the first slot of a subframe) and a burst offset in the slot of 0 symbols (e.g., starting from the first symbol of a slot), the burst duration of 4 slots, the burst period of i subframes or i ms in time, 12 S-RSBs per bursts, and the S-RSB interval of 4 symbols (using 3-symbol S-RSB). Other variations of the burst structure may be utilized in accordance with the present disclosure, including having resources allocated for response occasions associated with each S-RSB of the burst (see, e.g., FIGS. 12, 15, and 16). However, the beam sweeping concepts shown in FIG. 10 (as well as FIGS. 11-13) can be applied to the various burst structures.

In some instances, the burst duration may be longer with a wider Tx beam sweeping angular range for beamforming or beam pairing. For example, the burst duration of an S-RSB burst for beamforming may include 6, 8, 9, 10, 12, 15, 16, or other suitable number of S-RSBs across two or more slots. For example, example 1000 shows 12 S-RSBs transmitted over four slots such that 3 S-RSBs are transmitted in each slot. In a sidelink BWP with an FR2 numerology of 60 kHz subcarrier spacing (SCS), there may be 4 slots per subframe. Each S-RSB of the S-RSB burst may be transmitted in an associated Tx beam and thus the beam sweeping pattern in example 1000 includes 12 beams in a 360 degree pattern. For example, S-RSB0 is transmitted in one beam direction (TxBeam0) and S-RSB3 is transmitted in another beam direction (TxBeam3) that is the 4th beam in the beam sweeping pattern. The S-RSB burst duration in example 800 is 4 slots, 1 subframe, or 1 ms with 12 three-symbol S-RSBs.

The S-RSB burst period may be a quantity of i subframes or a time duration of i ms, which may be used for SPS based resource reservation as indicated in the SCI. As shown in example 1000, the SCI of S-RSB0 in the first burst may indicate the S-RSB0 transmission in the second burst (and/or later burst(s)) at the resource indicated with the reserved resource and/or with a Resource Reservation Period field based on the S-RSB burst period. Similarly, the SCI of S-RSB3 in the first burst may indicate the S-RSB3 transmission in the second burst (and/or later burst(s)) at the resource indicated with the reserved resource (e.g., for one transmission) and/or with a Resource Reservation Period field for semi-periodic transmissions based on the S-RSB burst period).

Example 1000 also shows receiving beams (e.g., sweeping receive beams) that a receiving UE 120b is using (e.g., Rx beam m for the first S-RSB burst and Rx beam n for the second S-RSB burst). In some aspects, the receiving UE 120b may select a first Tx beam (e.g., TxBeam1) associated with the S-RSB of the first S-RSB burst with the first best (preferred) beam measurement (e.g., RSRP1, RSRQ1, or SINR1) using a first Rx beam (e.g., RxBeam1) and a second Tx beam (e.g., TxBeam2) associated to the S-RSB of the second S-RSB burst with the second best beam measurement (e.g., RSRP2, RSRQ2, or SINR2) using a second Rx beam (e.g., RxBeam2). The receiving UE 120b may determine a best Tx beam and the associated Rx beam for the beam pair based at least in part on comparing the first and the second best beam measurements.

In some aspects, the receiving UE 120b may report the selected best Tx beam (e.g., from one antenna or panel) and/or the associated respective sidelink beam pair or sidelink beam pair link to the transmitting UE 120a. In some instances, the receiving UE 120b indicates the selected best Tx beam by transmitting a beam response to the UE 120a. In some aspects, the receiving UE 120b transmits a beam response during the response occasion for the S-RSB associated with the selected best Tx beam. In some aspects, the receiving UE 120b may report multiple selected best Tx beams (e.g., from different antennas or panels) and/or the associated respective sidelink beam pairs or sidelink beam pair links to the transmitting UE 120a (e.g., based on the highest RSRP, RSRQ, or SINR measurement, available resources in one of the resource sets, channel congestion level such as RSSI or CBR measurement, etc.). In this regard, the UE 120b may report the multiple selected best Tx beams in a single beam response (e.g., a beam response including multiple fields and/or bits to allow indication of the multiple selected best Tx beams) or multiple beam responses (e.g., one beam response per selected Tx beam). The receiving UE 120b may use multiple transmitting beams corresponding respectively to multiple receiving beams (e.g., beam correspondence with different antennas or panels) paired with the multiple selected best Tx beams at the resource sets associated or mapped respectively with the multiple selected best Tx beams, after the beam pairing or beamforming.

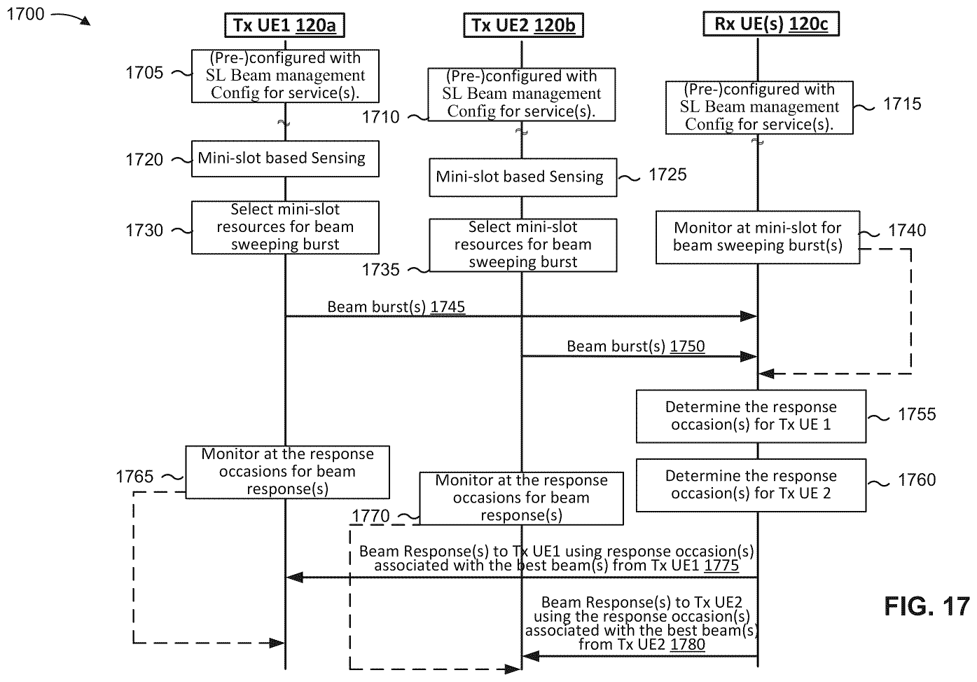

In some aspects, a receiving UE (e.g., UE 120b as shown in FIG. 7 or UE 120c as shown in FIG. 17) may monitor different S-RSB bursts from different Tx UEs (e.g., UE 120a as shown in FIG. 7 or UEs 120a-120b as shown in FIG. 17) identified respectively by the source ID indicated in the SCI (e.g., SCI-1 or SCI-2) of each S-RSB of the different S-RSB bursts. The receiving UE may select multiple Tx beams respectively associated to multiple Tx UEs and report the selected multiple Tx beams respectively to the multiple Tx UEs using multiple transmitting beams corresponding respectively to multiple receiving beams (e.g., based on the beam correspondence) paired with the multiple selected Tx beams at the resource sets associated or mapped respectively with the multiple selected Tx beams, for initial beam pairing or beamforming, beam fine tuning, beam monitoring with measurement, or candidate beam reporting.

In some aspects, multiple receiving UEs may monitor for the same S-RSB burst(s) from one Tx UE identified by the source ID indicated in the SCI (e.g., SCI-1 or Sci-2) of each S-RSB of the S-RSB burst(s). The multiple receiving UEs may select one or multiple Tx beams for use with the Tx UE. Similarly, each receiving UE may report one or multiple selected Tx beams and/or the associated respective sidelink beam pairs or sidelink beam pair links to the transmitting UE using the transmitting beam corresponding to the receiving beam (e.g., based at least in part on the beam correspondence) paired with one of the one or multiple selected Tx beams at the resource set associated or mapped with one of the one or multiple selected best Tx beams (e.g., based on the highest RSRP, RSRQ, or SINR measurement, available resources in one of the resource sets, channel congestion level such as RSSI or CBR measurement). The receiving UE may use multiple transmitting beams (e.g., to report multiple selected Tx beams individually) corresponding respectively to multiple receiving beams (e.g., beam correspondence with different antennas or panels) paired with the multiple selected Tx beams at the resource sets associated or mapped respectively with the multiple selected best Tx beams, for initial beam pairing or beamforming, beam fine tuning, beam monitoring with measurement, or candidate beam reporting. The receiving UE may use best transmitting beam (to report multiple selected Tx beams together) corresponding to best receiving beams (e.g., beam correspondence with different antennas or panels) paired with the selected best Tx beams at the resource sets associated or mapped with the selected best Tx beams, for the beam pairing or beamforming, beam fine tuning, beam monitoring with measurement, or candidate beam reporting. The transmitting UE may monitor for transmissions from multiple receiving UEs at each resource set associated or mapped with each S-RSB of its one or more S-RSB bursts using the receiving beams corresponding to the transmitting beams respectively associated with S-RSBs of the one or more S-RSB bursts.

FIG. 11 is a diagram illustrating an example 1100 of a beam sweeping pattern for beam fine tuning, in accordance with the present disclosure. FIG. 11 is provided as an example. Other examples may differ from what is described with regard to FIG. 11. The beam fine tuning may be for a transmit (Tx) beam. As shown, the Tx beam sweeping with a fixed Rx beam for beam fine tuning of a transmit beam may include fewer S-RSBs associated with fine Tx beams in a narrow angular range of Tx beam directions. The S-RSB burst for Tx beam fine tuning may be preconfigured or configured (e.g., via a common or a broadcast RRC message for UEs in the coverage of the network, via a UE dedicated RRC message for a UE that is identified by the destination ID in the SCI of an S-RSB within a S-RSB burst) or activated (e.g., via a MAC CE from the network or PC5 MAC CE from the UE). The S-RSB burst may start, for example, at a burst offset and a burst offset in slot. The S-RSB burst may have a burst duration, a burst period, a quantity of S-RSBs per burst, and/or S-RSB interval. Example 1100 shows a Tx beam fine tuning S-RSB burst with a burst offset of 1 slot (e.g., starting from the second slot of a subframe), a burst offset in slot of 1 symbol (e.g., starting from the second symbol of a slot), a burst duration of 1 slot, a burst period of j subframes or j ms in time, 3 S-RSBs per burst, and the S-RSB interval of 4 symbols (using 3-symbol S-RSB). In some aspects, each S-RSB of the S-RSB burst will have an associated response occasion that may be pre-configured or configured or activated with the associated S-RSB burst configuration (e.g., via the network or the Tx UE). Additionally, or alternatively, the SCI of each S-RSB may indicate the resources for the associated response occasion (e.g., SCI-1 with reserved resources, or SCI-2 with preferred or non-preferred resources).

The burst duration may be shorter with a narrow, fine Tx beam sweeping angular range for fine tuning a Tx beam in a direction (e.g., associated with a Tx wide beam). In the example 1100, the 3 S-RSBs (using 3-symbol S-RSB) in 3 fine beams in slot 1 of subframe 0 or subframe j may be swept in a certain direction (e.g., associated with a Tx beam TxWideBeam 1). There may be multiple S-RSB transmissions on multiple respective fine beams, but the intra-S-RSB burst Tx beam sweeping may be in a narrow range of directions. The quantity of beams and/or the angular degrees (e.g., within 90 degrees, within 60 degrees, or otherwise) of the beam sweeping pattern for beam fine tuning may be configured via signaling or stored as preconfigured information. In example 1100, the angular range of the beam sweeping pattern is 60 degrees with a sidelink FR2 numerology (e.g., SCS=120 kHz with 8 slots per subframe). Additionally, the SCI of an S-RSB of a first burst (e.g., the first S-RSB of the first burst in slot I of subframe 0) may indicate the resource reserved for the first S-RSB transmission in a second burst (e.g., the first S-RSB of the second burst in slot 1 of subframe j) and/or with a Resource Reservation Period field for semi-periodic S-RSB bursts based on the burst period j subframes or j ms.

FIG. 12 is a diagram illustrating an example 1200 of a beam sweeping pattern for beam fine tuning, in accordance with the present disclosure. FIG. 12 is provided as an example. Other examples may differ from what is described with regard to FIG. 12. The beam fine tuning may be for a receive (Rx) beam. The Rx beam sweeping with a fixed Tx beam for beam fine tuning of a receive beam may include fewer repeated S-RSBs in a short S-RSB burst. The S-RSB burst for Rx beam fine tuning may be preconfigured or configured (e.g., via common or broadcast or dedicated RRC message for UEs in the coverage of the network or via PC5 RRC message for a specific UE such as group lead, cluster head, RSU, transmitting UE or receiving UE) or activated (e.g., via MAC CE from the network or PC5 MAC CE from the UE). The S-RSB burst may be identified by the destination ID (e.g., for UE(s) 120b of unicast(s) or for UEs 120b of a groupcast or broadcast) in the SCI (e.g., SCI-1 or SCI-2) of an S-RSB within a S-RSB burst. The S-RSB burst may use a burst offset, a burst offset in a slot, a burst period, and/or an S-RSB interval. The S-RSB burst may have a burst duration or a quantity of repeated S-RSBs per. Example 1200 shows an Rx beam fine tuning S-RSB burst with the burst offset of 0 slot (e.g., starting from the first slot of a subframe), a burst offset in a slot of 0 symbols (e.g., starting from the first symbol of the slot), the burst duration of 2 slots, 4 S-RSBs per burst, and 4 beam responses (e.g., a beam management response with pairing, fine tuning, measurement, candidate beams, etc.) occasions (each spanning 2 symbols) associated with the 4 S-RSBs. The burst duration may be shorter with a narrow fine Rx beam sweeping angular range for fine tuning Rx beam in a direction (e.g., associated with a Tx beam). For example, the Rx sweeping pattern may be within 90 degrees, 60 degrees, or other angle with a short S-RSB burst of 4 repeated S-RSBs over 2 slots (e.g., slot 0 and slot I of subframe 0 or subframe k). In some aspects, S-RSBs in an Rx beam fine tuning burst may include repetitions of the same S-RSB (e.g., same Tx beam). In some aspects, two or more of the S-RSBs of an S-RSB burst may be transmitted using the same Tx beam. For example, the first three S-RSBs of S-RSB burst j are transmitted using common Tx beam k and all four S-RSBs of S-RSB burst j+1 are transmitted using common Tx beam m. In some aspects, one or more of the S-RSBs of an S-RSB burst may be transmitted using a different Tx beam than other S-RSBs of the S-RSB burst (see, e.g., the last S-RSB of S-RSB burst j that is transmitted with Tx beam l). In example 1200, the S-RSB burst duration is four 4-symbol S-RSBs and four 2-symbol response occasions across two slots, which may be based on a sidelink FR2 numerology (e.g., SCS=120 kHz with 8 slots per subframe).

The SCI (SCI 1 and/or SCI 2) of each S-RSB of an S-RSB burst may include beam information (e.g., transmission configuration indicator (TCI) state with quasi-co-location (QCL) types such as type A or type D or spatial filter for a receive beam parameter or for beam association or correspondence, a beam identifier or beam index of a beam used to transmit the S-RSB for beam association or resource mapping) and S-RSB information (e.g., S-RSB index of an S-RSB within an S-RSB burst for beam association or resource mapping, S-RSB structure or resource configuration for a UE to identify the proper S-RSB burst). The S-RSB burst structure or resource configuration information may include an S-RSB configuration index (e.g., a codepoint of S-RSB burst duration and/or S-RSB burst period, based at least in part on a numerology configured for a sidelink BWP).

Further, the SCI (SCI 1) of a particular S-RSB of an S-RSB burst may dynamically indicate the resources reserved for a corresponding beam response. For example, as shown in example 1200, the SCI associated with the second S-RSB of S-RSB burst j indicates the resources associated with the corresponding beam response as indicated by arrow 1202. Similarly, the SCI associated with the fourth S-RSB of S-RSB burst j indicates the resources associated with the corresponding beam response as indicated by arrow 1204.

Further still, the SCI of a particular S-RSB of an S-RSB burst may indicate the resources reserved for the corresponding S-RSB transmission in a second (or later)S-RSB burst. For example, as shown in example 1200, the SCI associated with the second S-RSB of S-RSB burst j indicates the resources associated with the corresponding second S-RSB or S-RSB burst j+/as indicated by arrow 1206. Similarly, the SCI associated with the fourth S-RSB of S-RSB burst j indicates the resources associated with the corresponding fourth S-RSB or S-RSB burst j+/as indicated by arrow 1208.

In some aspects, there may be a one-to-one mapping between an S-RSB transmission on a Tx beam and a beam response occasion (e.g., one set of N beam responses after one set of N beam sweeping transmissions for fine tuning Tx, or beam monitoring with measurement report, or candidate beam report, etc., as shown in FIG. 12). In some aspects, there may be a multiple-to-one mapping between multiple S-RSB transmissions with one or multiple beam sweeping bursts on a Tx beam and a beam response occasion (e.g., one set of N beam responses after multiple sets of N beam sweeping transmissions for selecting best Tx and/or Rx beams for initial beam pairing or for an averaged measurement over multiple sets of N beam sweeping transmissions). In some instances, multiple beam sweeping bursts may be transmitted using the same set of Tx beams for the plurality of S-RSBs of each beam sweeping burst and a receiving UE may use a different receiving beam for each burst. In such instances, the receiving UE may determine the best pair of Tx beam and Rx beam based on the multiple beam sweeping bursts and transmit an indication of the selected Tx beam and/or Rx beam in a beam response associated with the multiple beam sweeping bursts. In some instances, multiple beam sweeping bursts may be transmitted using the same set of Tx beams for the plurality of S-RSBs of each beam sweeping burst and a receiving UE may average measurements associated with each Tx beam over the multiple beam sweeping bursts. In such instances, the receiving UE may determine the average measurement(s) and transmit an indication of the average measurement(s) in a beam response associated with the multiple beam sweeping bursts.

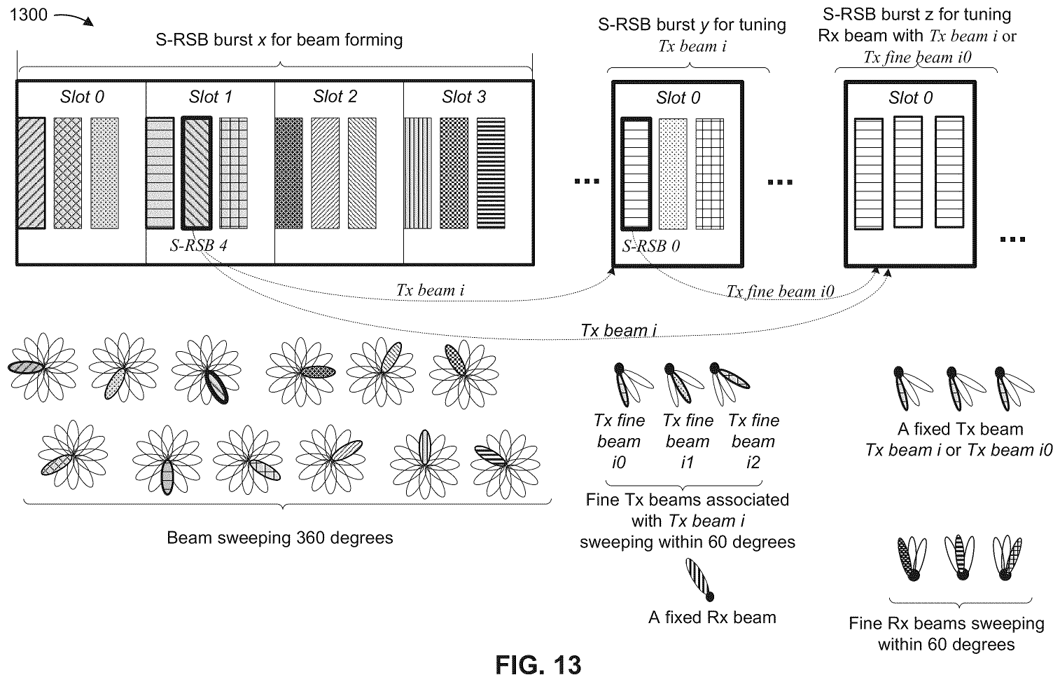

FIG. 13 is a diagram illustrating an example 1300 of the association between S-RSB burst(s) for beam forming or pairing and S-RSB burst(s) for Tx or Rx beam fine tuning with different beam sweeping patterns, in accordance with the present disclosure. FIG. 13 is provided as an example. Other examples may differ from what is described with regard to FIG. 13. Example 1300 shows a first beam sweeping pattern for beam forming (e.g., before or during discovery or direct communication message) and a second beam sweeping pattern for Tx beam fine tuning and a third beam sweeping pattern for Rx beam fine tuning (e.g., during or after the PC5 connection establishment). There may be one or more S-RSB bursts for beam forming, one or more S-RSB bursts for beam fine tuning of Tx beams, and one or more S-RSB bursts for beam fine tuning of Rx beams. The association between different types of S-RSB bursts may be specified, pre-configured or configured, for example, via common or broadcast RRC message for all UEs in the coverage of the network or dedicated RRC message for a specific UE (e.g., identified by the destination ID in the SCI of an S-RSB within an S-RSB burst), with a specified association or a mapping. Additionally, or alternatively, the association between different types of S-RSB bursts may be activated, for example, via MAC CE from the network or PC5 MAC CE from the specific UE.

For a Tx beam associated with a S-RSB of a beamforming S-RSB burst (e.g., Tx beam i of S-RSB burst x), there is an S-RSB burst for beam fine tuning the Tx beam (e.g., S-RSB burst y associated with Tx beam i) by, for example, mapping via a time interval and/or frequency offset (e.g., pre-configured or configured) or via a mapping table with time and frequency resource allocation (e.g., pre-configured or configured) indexed with the Tx beam's ID or index or the index of the S-RSB associated with the Tx beam. For a Tx beam associated with an S-RSB of a beamforming S-RSB burst (e.g., the Tx beam i of S-RSB burst x) or an S-RSB with a Tx beam of a beamforming S-RSB burst (e.g., the S-RSB 4 with Tx beam i of S-RSB burst x), there is an S-RSB burst for beam fine tuning the Tx beam (e.g., S-RSB burst y associated with Tx beam i or S-RSB 4) by mapping, for example, via a time interval and/or frequency offset (e.g., pre-configured or configured) or a mapping table with time and frequency resource allocation (e.g., pre-configured or configured) indexed with the Tx beam's ID or index (e.g., Tx beam i) or the associated S-RSB's index (e.g., the S-RSB 4). For a Tx beam associated with an S-RSB of a beamforming S-RSB burst (e.g., the Tx beam i of S-RSB burst x) or an S-RSB with a Tx beam of a beamforming S-RSB burst (e.g., the S-RSB 4 with Tx beam i of S-RSB burst x), or, for a Tx fine beam associated with an S-RSB of a Tx bean fine tuning S-RSB burst (e.g., the Tx fine beam i0 of S-RSB burst y) or an S-RSB with a Tx beam fine tuning S-RSB burst (e.g., S-RSB0 with Tx fine beam i0 of S-RSB burst y), there is an S-RSB burst for beam fine tuning the Rx beams with the Tx beam or the Tx fine beam (e.g., S-RSB burst z associated with Tx beam i or Tx fine beam i0). The beam fine tuning may involve mapping, for example, via a time interval and/or frequency offset (e.g., pre-configured or configured) or a mapping table with time and frequency resource allocations (e.g., pre-configured or configured) indexed with the Tx beam's ID or index (e.g., the Tx beam i of S-RSB burst x) or the Tx fine beam's ID or index (e.g., the Tx fine beam i0 of S-RSB burst y) or the associated S-RSB's index (e.g., S-RSB4 with Tx beam i of S-RSB burst x or S-RSB0 with Tx fine beam i0 of S-RSB burst y).

FIG. 14 is a diagram illustrating an example 1400 of resources associated with beams, in accordance with the present disclosure. FIG. 14 is provided as an example. Other examples may differ from what is described with regard to FIG. 14. In some aspects, an S-RSB (e.g., associated with a Tx beam) of an S-RSB burst sweeping with different S-RSBs (e.g., different Tx beams) from a first UE (e.g., UE 120a) may be associated with a resource set and Rx beam at a second UE (e.g., UE 120b)(e.g., beam pairing between a Tx beam and a Rx beam). Therefore, sidelink resources may be mapped accordingly for sidelink communication from a second UE (e.g., UE 120b). For example, a Tx beam may be associated with an S-RSB of a beamforming S-RSB burst (e.g., Tx beam i or Tx beam j of S-RSB burst x) transmitted by a first UE (e.g., UE 120a) and selected by a second UE (e.g., UE 120b). There may be a resource set associated with or mapped in the dedicated S-RSB pool (e.g., ResourceSet p mapped with Tx beam i or Resource Set q mapped with Tx beam j) and/or a sidelink transmitting or receiving pool (e.g., Resource Set r mapped with Tx beam i or Resource Set's mapped with Tx beam j) for sidelink communication messages (e.g., discovery, DCR, beam pairing or beam pair link(s) message with the selected Tx and/or Rx beam(s), beam measurements report or candidate beam list message) from the second UE to the first UE during or after the beamforming with a sidelink beam pair link (e.g., SBPL k, which is formed with the selected Tx beam from the first UE and the paired Rx beam at the second UE. The resource set association or mapping may be specified, pre-configured, configured (e.g., common such as SIB 12 or dedicated RRC configuration from network node 110a), activated (e.g., MAC CE or DCI from network node 110a)(e.g., based at least in part on the ID or index of the selected Tx beam or the index of the S-RSB associated with the selected Tx beam), or configured (PC5 RRC) or activated (PC5 MAC CE) from a special UE (e.g., group lead, cluster head, RSU, Tx UE or Rx UE), or indicated dynamically by the SCI part 2 or MAC CE with preferred resources of the S-RSB associated to the selected Tx beam.

In some aspects, sidelink beam correspondence may be enabled based at least in part on a UE's capability. A Tx beam from a first UE (e.g., UE 120a) may be associated with an S-RSB of a beamforming S-RSB burst (e.g., S-RSB k associated with Tx beam k of S-RSB burst x) transmitted by the first UE and selected by a second UE (e.g., UE 120b) with an Rx beam via beamforming with a first sidelink beam pair link (e.g., SBPL k is formed with Tx beam k and Rx beam k). There is a receiving beam (e.g., the receiving beam l) for the first UE to monitor sidelink communication message(s)(e.g., discovery, DCR, or beam report message) from the second UE. In some aspects, the receiving beam (e.g., receiving beam l) corresponding to Tx beam (e.g., Tx beam k) at the first UE, for example, based on QCL Type-D (same special filter) between a first RS of the S-RSB associated to the selected Tx beam (e.g., S-RSB k with Tx beam k) from the first UE and a second RS of the S-RSB from the second UE (not shown) associated with the transmitting beam (e.g., the transmitting beam l) for the second UE to transmit sidelink communication message(s) to the first UE (e.g., the transmitting beam l corresponding to Rx beam k at the second UE, for example, based on QCL Type-D). The transmitting beam and the receiving beam may form a second sidelink beam pair link (e.g., SBPL I is formed with transmitting beam l and receiving beam l) based at least in part on the sidelink beam correspondence.

In some aspects, a dedicated resource pool for S-RSB bursts may be FDMed or TDMed with one or more sidelink communication transmission and/or reception pools. A UE may use a timeline (e.g., configured via signaling or stored preconfigured information) to switch from the dedicated resource pool for beam forming to a transmission or reception pool for transmitting or receiving a sidelink communication such as a discovery message (e.g., beamForm2Discovery), a DCR (e.g., beamForm2DCR), a beam measurement report, or a candidate beam report. A receiving UE may use one or more transmitting beams respectively corresponding to one or more Rx beams associated with one or more selected Tx beams from the transmitting UE in a range of resources (e.g., a resource set) mapped with the one or more selected Tx beams or the S-RSBs respectively associated with the one or more selected Tx beams or indicated in the SCI part 2 or MAC CE transmitted with each S-RSB of the S-RSBs respectively associated with the one or more selected Tx beam. A transmitting UE may use receiving beams respectively associated with its Tx beams or S-RSBs of its S-RSB burst at resources (e.g., resource sets) mapped with its Tx beams S-RSBs of its S-RSB burst or indicated in SCI part 2 transmitted with each S-RSB of the S-RSBs of its S-RSB burst.

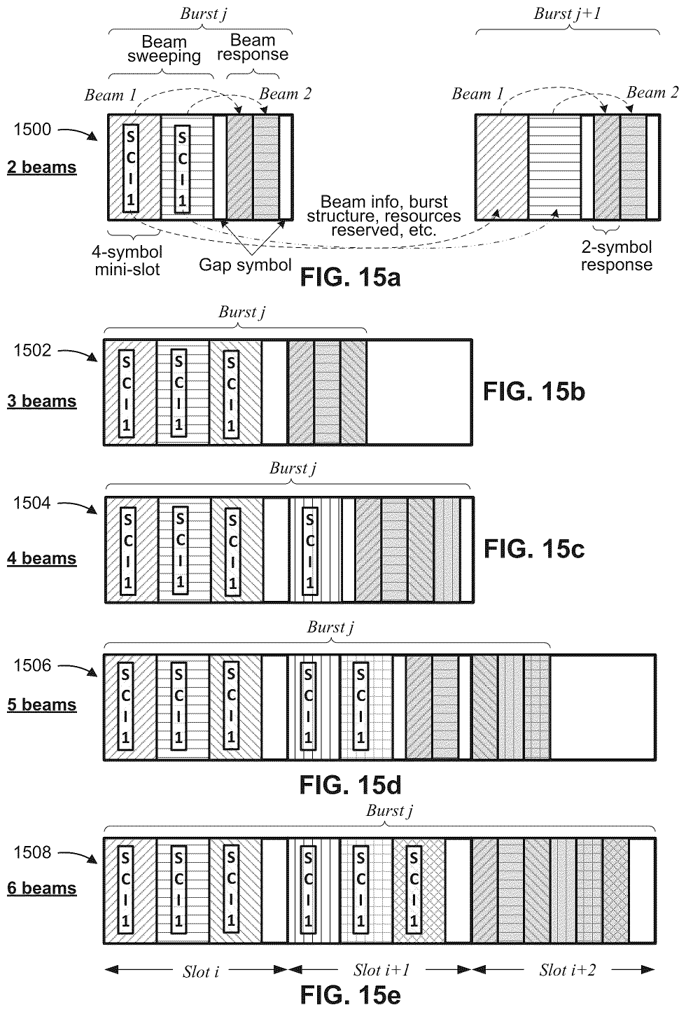

FIGS. 15a-15e are diagrams illustrating examples 1500, 1502, 1504, 1506, and 1508 of S-RSB burst structures for use with 4-symbol mini-slots, respectively, in accordance with the present disclosure. FIGS. 15a-15e are provided as examples. Other examples may differ from what is described with regard to FIGS. 15a-15e. The S-RSB burst structures shown in FIGS. 15a-15e are suitable for use with the techniques and apparatuses described with respect to FIGS. 8-14 and 17-24 as well as other aspects of the present disclosure.

An S-RSB burst structure 1500 is shown in FIG. 15a that includes two S-RSBs and two beam response occasions within one slot. As shown, each of the S-RSBs may occupy a mini-slot having four symbols. In the illustrated example, the S-RSBs of S-RSB structure 1500 occupy all four symbols of the mini-slot (e.g., using S-RSB structures similar to S-RSB 704). In other instances, the S-RSBs may occupy two or three symbols of a mini-slot (e.g., using S-RSB structures similar to S-RSB 706 or S-RSB 702, respectively). In some instances, any remaining symbols of the mini-slot may be used as a gap symbol and/or filled with another S-RSB. The S-RSB burst structure 1500 includes a gap symbol between the second S-RSB (last S-RSB of a burst) and the first beam response occasion. In some instances, the first and second beam response occasions each occupy two symbols of the slot. The S-RSB burst structure 1500 also includes a gap symbol after the second beam response occasion (last beam response occasion). The S-RSB burst structure 1500 may be particularly suitable for sweeping two beam directions (e.g., beam sweeping per panel, wide beam pairing, beam fine tuning or measurement for beam monitoring).

An S-RSB burst structure 1502 is shown in FIG. 15b that includes three S-RSBs and three beam response occasions across portions of two slots. As shown, each of the S-RSBs may occupy a mini-slot having four symbols. In the illustrated example, the S-RSBs of S-RSB structure 1502 occupy all four symbols of the mini-slot (e.g., using S-RSB structures similar to S-RSB 704). In other instances, the S-RSBs may occupy two or three symbols of a mini-slot (e.g., using S-RSB structures similar to S-RSB 706 or S-RSB 702, respectively). In some instances, any remaining symbols of the mini-slot may be used as a gap symbol and/or filled with another S-RSB. The S-RSB burst structure 1502 includes two gap symbols following the third S-RSB and before the second slot and the first beam response occasion. In some instances, each of the three beam response occasions occupies two symbols of the second slot. While shown as adjacent, in some aspects a gap symbol may be placed between each of the beam response occasions. The S-RSB burst structure 1502 may be particularly suitable for sweeping three beam directions.

An S-RSB burst structure 1504 is shown in FIG. 15c that includes four S-RSBs and four beam response occasions across two slots. As shown, each of the S-RSBs may occupy a mini-slot having four symbols. In the illustrated example, the S-RSBs of S-RSB structure 1504 occupy all four symbols of the mini-slot. In other instances, the S-RSBs may occupy two or three symbols of a mini-slot (e.g., using S-RSB structures similar to S-RSB 706 or S-RSB 702, respectively). In some instances, any remaining symbols of the mini-slot may be used as a gap symbol and/or filled with another S-RSB. The S-RSB burst structure 1504 includes two gap symbols between the third S-RSB in the first slot and the fourth S-RSB at the start of the second slot. The S-RSB burst structure 1504 includes a gap symbol between the fourth S-RSB and the first beam response occasion. The four beam response occasions each occupy two symbols of the second slot. The S-RSB burst structure 1504 also includes a gap symbol after the fourth beam response occasion. The S-RSB burst structure 1504 may be particularly suitable for sweeping four beam directions.

An S-RSB burst structure 1506 is shown in FIG. 15d that includes five S-RSBs and five beam response occasions across portions of three slots. As shown, each of the S-RSBs may occupy a mini-slot having four symbols. In the illustrated example, the S-RSBs of S-RSB structure 1506 occupy all four symbols of the mini-slot. In other instances, the S-RSBs may occupy two or three symbols of a mini-slot (e.g., using S-RSB structures similar to S-RSB 706 or S-RSB 702, respectively). In some instances, any remaining symbols of the mini-slot may be used as a gap symbol and/or filled with another S-RSB. The S-RSB burst structure 1506 includes two gap symbols between the third S-RSB in the first slot and the fourth S-RSB at the start of the second slot. The S-RSB burst structure 1506 includes a gap symbol between the fifth S-RSB and the first beam response occasion. The five beam response occasions each occupy two symbols of the second slot. The S-RSB burst structure 1506 includes a gap symbol between the third beam response occasion and the fourth beam response occasion at the start of the third slot. The S-RSB burst structure 1506 may be particularly suitable for sweeping five beam directions.

An S-RSB burst structure 1508 is shown in FIG. 15c that includes six S-RSBs and six beam response occasions across three slots. As shown, each of the S-RSBs may occupy a mini-slot having four symbols. In the illustrated example, the S-RSBs of S-RSB structure 1508 occupy all four symbols of the mini-slot. In other instances, the S-RSBs may occupy two or three symbols of a mini-slot (e.g., using S-RSB structures similar to S-RSB 706 or S-RSB 702, respectively). In some instances, any remaining symbols of the mini-slot may be used as a gap symbol and/or filled with another S-RSB. The S-RSB burst structure 1508 includes two gap symbols between the third S-RSB in the first slot and the fourth S-RSB at the start of the second slot. The S-RSB burst structure 1508 also includes two gap symbols between the sixth S-RSB in the second slot and the first beam response occasion at the start of the third slot. The six beam response occasions each occupy two symbols of the third slot. The S-RSB burst structure 1508 includes two gap symbols following the sixth beam response occasion. The S-RSB burst structure 1506 may be particularly suitable for sweeping six beam directions (e.g., beam sweeping with more than one panel, narrow beam pairing, candidate beam selection for beam recovery).

The arrangements and concepts shown in S-RSB burst structures 1500-1508 may be extended to larger numbers of S-RSBs per burst (e.g., 7, 8, 9, 10, 11, 12, etc.), facilitating sweeping more beam directions.

In some aspects, an S-RSB burst contains all beams of a panel. In this case, one or more S-RSB bursts may be used for sweeping beams of one or more panels. In some aspects, an S-RSB burst contains all beams of all panels. In this case, at least one burst may be used for sweeping all beams of all panels. In some aspects, an S-RSB burst contains a subset of beams of one or more panels. In this case, one or more short S-RSB bursts may be used for beam fine tuning and/or for measurements of candidate beams of the one or more panels.

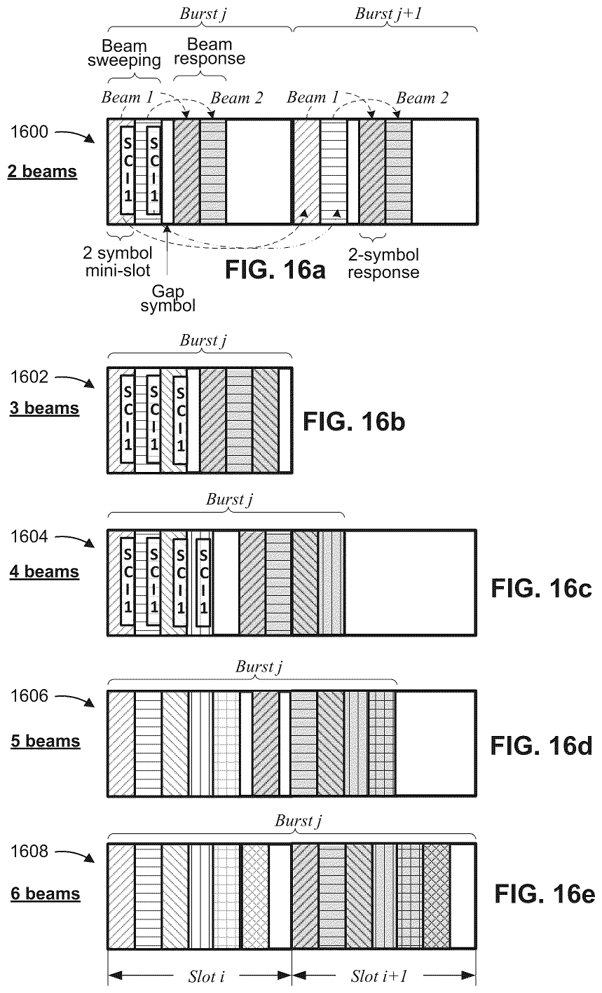

FIGS. 16a-16e are diagrams illustrating examples 1600, 1602, 1604, 1606, and 1608 of S-RSB burst structures for use with 2-symbol mini-slots, respectively, in accordance with the present disclosure. FIGS. 16a-16e are provided as examples. Other examples may differ from what is described with regards to FIGS. 16a-16e. The S-RSB burst structures shown in FIGS. 16a-16e are suitable for use with the techniques and apparatuses described with respect to FIGS. 8-14 and 17-24 as well as other aspects of the present disclosure.

An S-RSB burst structure 1600 is shown in FIG. 16a that includes two S-RSBs and two beam response occasions within one slot. As shown, each of the S-RSBs may occupy a mini-slot having two symbols. The S-RSBs of S-RSB structure 1600 occupy both symbols of the mini-slot. In this regard, the S-RSBs may use an S-RSB structure similar to S-RSB 706 that occupies two symbols. The S-RSB burst structure 1600 includes a gap symbol between the second S-RSB and the first beam response occasion. The first and second beam response occasions each occupy two symbols of the slot. The S-RSB burst structure 1600 also includes five gap symbols after the second beam response occasion. The S-RSB burst structure 1600 may be particularly suitable for sweeping two beam directions.

An S-RSB burst structure 1602 is shown in FIG. 16b that includes three S-RSBs and three beam response occasions within one slot. As shown, each of the S-RSBs may occupy a mini-slot having two symbols. The S-RSBs of S-RSB structure 1602 occupy both symbols of the mini-slot. In this regard, the S-RSBs may use an S-RSB structure similar to S-RSB 706 that occupies two symbols. The S-RSB burst structure 1602 includes a gap symbol between the third S-RSB and the first beam response occasion. The three beam response occasions each occupy two symbols of the slot. The S-RSB burst structure 1602 also includes a gap symbol after the third beam response occasion. The S-RSB burst structure 1602 may be particularly suitable for sweeping three beam directions.

An S-RSB burst structure 1604 is shown in FIG. 16c that includes four S-RSBs and four beam response occasions across portions of two slots. As shown, each of the S-RSBs may occupy a mini-slot having two symbols. The S-RSBs of S-RSB structure 1604 occupy both symbols of the mini-slot. In this regard, the S-RSBs may use an S-RSB structure similar to S-RSB 706 that occupies two symbols. The S-RSB burst structure 1604 includes two gap symbols between the fourth S-RSB and the first beam response occasion. The four beam response occasions each occupy two symbols of the slot. The S-RSB burst structure 1604 also includes gap symbols that fill the second slot following the fourth beam response occasion. In other instances, the remainder of the second slot may be filled with other symbols. The S-RSB burst structure 1604 may be particularly suitable for sweeping four beam directions.

An S-RSB burst structure 1606 is shown in FIG. 16d that includes five S-RSBs and five beam response occasions across portions of two slots. As shown, each of the S-RSBs may occupy a mini-slot having two symbols. The S-RSBs of S-RSB structure 1604 occupy both symbols of the mini-slot. In this regard, the S-RSBs may use an S-RSB structure similar to S-RSB 706 that occupies two symbols. The S-RSB burst structure 1606 includes a gap symbol between the fifth S-RSB and the first beam response occasion. The five beam response occasions each occupy two symbols of the slot. The S-RSB burst structure 1606 includes a gap symbol between the first beam response occasion and the second beam response occasion. The S-RSB burst structure 1606 also includes gap symbols that fill the second slot following the fifth beam response occasion. In other instances, the remainder of the second slot may be filled with other symbols. The S-RSB burst structure 1606 may be particularly suitable for sweeping five beam directions.

An S-RSB burst structure 1608 is shown in FIG. 16e that includes six S-RSBs and six beam response occasions across portions of two slots. As shown, each of the S-RSBs may occupy a mini-slot having two symbols. The S-RSBs of S-RSB structure 1608 occupy both symbols of the mini-slot. In this regard, the S-RSBs may use an S-RSB structure similar to S-RSB 706 that occupies two symbols. The S-RSB burst structure 1608 includes two gap symbols between the sixth S-RSB and the first beam response occasion. The six beam response occasions each occupy two symbols of the slot. The S-RSB burst structure 1608 also includes two gap symbols following the sixth beam response occasion. The S-RSB burst structure 1608 may be particularly suitable for sweeping six beam directions.

In some aspects, a beam sweeping part with one or more Tx beams (e.g., a set of one or more beam sweeping transmissions of a beam sweeping burst) may start at a slot or a mini-slot and a beam response part associated to one or more Tx beams (e.g., a set of one or more beam responses for the one or more Tx beams of the beam sweeping transmissions of the beam sweeping burst) may start at a slot or a mini-slot. In some aspects, one beam sweeping part with one or more Tx beams (e.g., a set of one or more beam sweeping transmissions of a beam sweeping burst) may be associated with one beam response part associated to one or more Tx beams (e.g., a set of one or more beam responses for the one or more Tx beams of the beam sweeping transmissions of the beam sweeping burst) within a burst (e.g., for beam fine tuning or measurement or candidate beam selection, as shown in FIGS. 15 and 16). In some aspects, multiple beam sweeping parts with one or more Tx beams (e.g., multiple sets of one or more beam sweeping transmissions or multiple beam sweeping bursts) may be associated with one beam response part associated to one or more Tx beams (e.g., a set of one or more beam responses for multiple sets of one or more beam sweeping transmissions or multiple beam sweeping bursts). For example, a beam sweeping burst may contain multiple beam sweeping parts followed by one beam response part, or a first beam sweeping burst may contain only beam sweeping part without a beam response part and a second burst may contain both a beam sweeping part and a beam response part (e.g., for beam pairing or beam forming with Tx and Rx beam selection with multiple beam sweeping parts, or for an averaged beam measurements over multiple beam sweeping parts).

FIG. 17 is a diagram illustrates an example 1700 associated with sensing and transmitting sidelink reference signal blocks (S-RSBs) and associated communications, in accordance with the present disclosure. The example 1700 may employ similar mechanisms as described in FIGS. 3-16. As illustrated, the example 1700 includes a number of enumerated blocks associated with actions of a Tx UE1 120a, a Tx UE2 120b, and a Rx UE 120c, but aspects of the example 1700 may include additional blocks before, after, and in between the enumerated blocks. In some aspects, one or more of the enumerated blocks may be omitted or performed in a different order. Additionally, or alternatively, two or more of the blocks of example 1700 may be performed in parallel and/or combined.

At block 1705, the Tx UE1 120a may be pre-configured and/or configured with one or more sidelink beam management configurations (e.g., one or more configurations for mini-slot sensing or measurements, beam pairing parameters, beam fine tuning parameters, beam measurement parameters for beam maintenance or monitoring, candidate beam selection parameters for beam recovery, as described previously in FIGS. 7˜16, etc.) for one or more sidelink services. In some instances, the Tx UE1 120a may be preconfigured with a sidelink beam management configurations (e.g., by the manufacturer, network owner, etc.). In some instances, the Tx UE1 120a may receive the sidelink beam management configuration (e.g., from a base station, network unit, RU, DU, or CU via common or dedicated RRC message or activation indication in MAC CE or DCI, or from a UE via PC5 RRC message (UE Assistance Information or sidelink RRC configuration) or activation indication in PC5 MAC CE or dynamically indicated in SCI, etc.). In this regard, the sidelink beam management configuration may be configured dynamically, semi-persistently, and/or ad hoc. The sidelink beam management configuration may indicate slot or mini-slot configuration, one or more numerologies associated with one or more sidelink bandwidth parts, one or more resources associated with a dedicated beam management (e.g., beam pairing, beam fine tuning, beam measurement for maintenance or monitoring, or candidate beam selection for beam recovery) pool for each of one or more sidelink bandwidth parts, one or more beam management burst parameters, one or more resources for a beam response, and/or other parameters associated with sensing-based sidelink beam management. In some aspects, the sidelink beam management configuration may be associated with one or more services with different QoS requirements (e.g., wide beams for short communication range or narrow beams for long communication range or high reliability, short S-RSB burst for high priority or low latency services for quick beam pairing or recovery, S-RSB transmission dropping or pre-emptions based on the priority when channel is more congested, etc.) utilized by the Tx UE1 120a.

At block 1710, the Tx UE2 120b may be pre-configured and/or configured with one or more sidelink beam management configurations for one or more services (e.g., in a similar manner to TX UE1 120a at block 1705). The sidelink beam management configuration(s) of the Tx UE2 120b may be the same or different than the sidelink beam management configuration(s) of the Tx UE1 120a, for example, based on UE's capability (e.g., number of panels, number of beam per panel, beam types, etc.).

At block 1715, the Rx UE(s) 120c may be pre-configured and/or configured with one or more sidelink beam management configurations for one or more services (e.g., in a similar manner to TX UE1 120a at block 1705 and/or TX UE2 120b at block 1710). The sidelink beam management configuration(s) of the Rx UE(s) 120c may be the same or different than the sidelink beam pairing configuration(s) of the Tx UE1 120a and/or the Tx UE2 120b, for example, based on UE's capability (e.g., number of panels, number of beam per panel, beam types, etc.).

At block 1720, the Tx UE1 120a performs mini-slot based sensing. In some aspects, the Tx UE1 120a performs the mini-slot based sensing (e.g., at each mini-slot, detecting S-RSB and decoding the associated SCI for resources (S-RSB transmission(s) and beam response occasion(s)) related with current and/or future S-RSB burst, and measuring RSRP, RSRQ, RSSI, CBR, etc. over the mini-slots containing S-RSBs respectively) based on a sidelink beam management configuration associated with block 1705. For example, in some instances the Tx UE1 120a monitors for one or more S-RSBs of a S-RSB burst based the sidelink beam management configuration. In this regard, the Tx UE1 120a may monitor a resource pool dedicated to S-RSB bursts for one or more services as indicated in the sidelink beam management configuration. Accordingly, in some instances the Tx UE1 120a may detect S-RSBs transmitted by other sidelink UEs (e.g., Tx UE2 120b) as a result of the min-slot based sensing at block 1720.

At block 1725, the Tx UE2 120b performs mini-slot based sensing (e.g., in a similar manner to the Tx UE1 120a at block 1720). In some aspects, the Tx UE1 120a performs the mini-slot based sensing based on a sidelink beam management configuration associated with block 1705. For example, in some instances the Tx UE1 120a monitors for one or more S-RSBs of a S-RSB burst based the sidelink beam management configuration. In this regard, the Tx UE1 120a may monitor a resource pool dedicated to S-RSB bursts for one or more services as indicated in the sidelink beam management configuration. The Tx UE2 120b may monitor a resource pool dedicated to S-RSB bursts for one or more services as indicated in the sidelink beam management configuration. Accordingly, in some instances the Tx UE2 120b may detect S-RSBs transmitted by other sidelink UEs (e.g., Tx UE1 120a) as a result of the min-slot based sensing at block 1725.

At block 1730, the Tx UE1 120a selects mini-slot resources for one or more beam sweeping bursts. For example, the Tx UE1 120a may select mini-slot resources for its beam sweeping bursts that do not interfere with resources utilized by Tx UE2 120b (or result in interference satisfying a threshold (e.g., below and/or equal to the threshold)). In this regard, the Tx UE1 120a may select the resources for transmitting one or more S-RSB bursts based on one or more received S-RSBs of other UEs (e.g., Tx UE2 120b). In some aspects, the Tx UE1 120a may select the resources by determining, based on the received S-RSBs, S-RSB burst resources associated with the other sidelink UEs and excluding those S-RSB burst resources from the candidate resources for transmitting the plurality of S-RBSs of the S-SRB bursts. In this regard, the Tx UE1 120a may exclude the S-RSB burst resources associated with the other UEs in an effort to minimize interference and/or improve signal quality.

In other instances, the Tx UE1 120a may include some or all resources of the S-RSB burst resources associated with the other UEs in the candidate resources for transmitting the plurality of S-RBSs of the S-SRB bursts so long as a measurement (RSRP, RSRQ, RSSI, etc.) by the Tx UE1 120a satisfies a threshold (e.g., below, below or equal to, above, or above or equal to, etc.) for the one or more of the S-RSB burst resources. In another instances, the Tx UE1 120a may include some or all resources of the S-RSB burst resources associated with the other UEs in the candidate resources for transmitting the plurality of S-RBSs of the S-SRB bursts so long as the priority of the plurality of S-RBSs of the S-SRB bursts by the Tx UE1 120a is higher (e.g., based on the QoS of a service or sidelink communication) than the S-RSB burst associated with the other UEs resources. In some aspects, the Tx UE1 120a may include some or all of the S-RSB burst resources associated with the other sidelink UEs based on mini-slot based channel busy ratio (CBR) and channel occupancy ratio (CR)(e.g., measured and calculated over the mini-slots within a measurement window) which may be associated with a priority. In some instances, the threshold is based on at least one of a sidelink priority level (e.g., associated with the QoS of a sidelink communication and/or a sidelink UE) or a CBR and/or CR. In this regard, different sidelink priority levels and/or different CBR and/or CR levels may have different associated thresholds. For example, in some instances a lower priority level may have a lower threshold, while a higher priority level may have a higher threshold. In some instances, the measurement utilized by the Tx UE1 120a to determine whether the threshold is satisfied is at least one of a sidelink reference signal receive power (SL-RSRP), a sidelink reference signal received quality (SL-RSRQ), and/or sidelink signal to interference and noise ratio (SL-SINR). If the measurement over the associated mini-slots satisfies the threshold (e.g., is below or equal to an interference measurement threshold), then the Tx UE1 120a may include the associated resources in the candidate resources from which Tx UE1 120a selects the resources for transmitting the plurality of S-RBSs.

At block 1735, the Tx UE2 120b selects mini-slot resources for one or more beam sweeping bursts (e.g., in a similar manner to the Tx UE1 120a at block 1730). For example, the Tx UE2 120b may select mini-slot resources for its beam sweeping bursts that do not interfere with resources utilized by Tx UE1 120a (or result in interference satisfying a threshold (e.g., below and/or equal to the threshold)). In this regard, the Tx UE2 120b may select the resources for transmitting one or more S-RSB bursts based on one or more received S-RSBs of other UEs (e.g., Tx UE1 120a). Additional aspects of the selection discussed above with respect to block 1730 apply equally here.

At block 1740, the Rx UE(s) 120c monitors for beam sweeping bursts based on the beam management configurations. The Rx UE(s) 120c may monitor for S-RSBs from the Tx UE1 120a, the Tx UE 120b, and/or other UEs. In this regard, the Rx UE(s) 120c monitors a plurality of mini-slots of a slot for a plurality of sidelink reference signal block (S-RSBs) (see, e.g., FIGS. 9-16). In some aspects, the Rx UE(s) 120c monitors for the plurality of S-RSBs using resources associated with a dedicated beam pairing pool. The Rx UE(s) 120c may monitor for the plurality of S-RSBs using a single receive beam direction (see, e.g., FIGS. 10-11) or using multiple receive beam directions (see, e.g., FIGS. 12-13).

At block 1745, the Tx UE1 120a transmits one or more beam sweeping bursts using the resources selected at block 1730. The Rx UE(s) 120c may receive one or more of the S-RSBs associated with the beam sweeping bursts of the Tx UE1 120a based on the monitoring at block 1740.

At block 1750, the Tx UE2 120b transmits one or more beam sweeping bursts using the resources selected at block 1735. The Rx UE(s) 120c may receive one or more of the S-RSBs associated with the beam sweeping bursts of the Tx UE2 120b based on the monitoring at block 1740.

At block 1755, the Rx UE(s) 120c determines the beam response occasion(s) to transmit a beam response to the Tx UE1 120a. The Rx UE(s) 120c may determine, based on the monitoring at block 1740, at least one beam response occasion associated with at least one of the plurality of S-RSBs transmitted by Tx UE1 120a. In some instances, the Rx UE(s) 120c determines the beam response occasion(s) by identifying one or more beams used to transmit the plurality of S-RSBs satisfying a threshold. For example, the Rx UE(s) 120c may identify one or more beams having at least one of a sidelink reference signal receive power (SL-RSRP), a sidelink reference signal received quality (SL-RSRQ), or sidelink signal to interference and noise ratio (SL-SINR) satisfying a threshold. In this regard, in some aspects the Rx UE(s) 120c may identify multiple selected beams (e.g., transmit beams and/or receive beams) in a single beam response (e.g., a beam response including multiple fields and/or bits to indicate the selected transmit and/or receive beams and/or associated measurements) or multiple beam responses (e.g., one beam response per selected transmit beam and/or receive beam and/or associated measurements).

At block 1760, the Rx UE(s) 120c determines the beam response occasion(s) to transmit a beam response to the Tx UE2 120b. The Rx UE(s) 120c may determine, based on the monitoring at block 1740, at least one beam response occasion associated with at least one of the plurality of S-RSBs transmitted by Tx UE2 120b. Again, the Rx UE(s) 120c may determine the beam response occasion(s) by identifying one or more beams used to transmit the plurality of S-RSBs satisfying a threshold, such as the beams having at least one of a sidelink reference signal receive power (SL-RSRP), a sidelink reference signal received quality (SL-RSRQ), or sidelink signal to interference and noise ratio (SL-SINR) satisfying the threshold. In this regard, in some aspects the Rx UE(s) 120c may identify multiple selected beams (e.g., transmit beams and/or receive beams) in a single beam response (e.g., a beam response including multiple fields and/or bits to indicate the selected transmit and/or receive beams and/or associated measurements) or multiple beam responses (e.g., one beam response per selected transmit beam and/or receive beam and/or associated measurements).

At block 1765, the Tx UE1 120a monitors for beam responses during beam response occasions associated with the beam burst(s) transmitted at block 1745. In this regard, each S-RSB of an S-RSB burst transmitted by Tx UE1 120a may have an associated beam response occasion. Accordingly, the Tx UE1 120a may monitor the resources associated with each beam response occasion to detect one or more beam responses from other UEs (e.g., Rx UE 120c).

At block 1770, the Tx UE2 120b monitors for beam responses from Rx UE(s) 120c during beam response occasions associated with the beam burst(s) transmitted at block 1750. In this regard, each S-RSB of an S-RSB burst transmitted by Tx UE2 120b may have an associated beam response occasion. Accordingly, the Tx UE2 120b may monitor the resources associated with each beam response occasion to detect one or more beam responses from other UEs (e.g., Rx UE(s) 120c).

At block 1775, the Rx UE(s) 120c transmits the beam response(s) to the Tx UE1 120a based on the determination at block 1755. The Tx UE1 120a may receive one or more of the beam responses transmitted by Rx UE(s) 120c based on the monitoring at block 1765. In some aspects, an Rx UE 120c may transmit one or more beam responses at one or more beam response occasions respectively using the corresponding one or more transmitting beams. The Tx UE1 120a may receive one or more of the beam responses at the one or more beam response occasions. In some aspects, an Rx UE 120c may transmit one or more beam responses at one response occasion using the corresponding transmitting beam (e.g., a selected best transmitting beam of Tx UE1 120a). The Tx UE1 120a may receive one or more of the beam responses at the one beam response occasion (e.g., corresponding to its best transmitting beam to the Rx UE 120c). In some aspects, the Tx UE1 120a may identify the Rx UE 120c via an ID (e.g., a L1 source ID or a link ID or a device ID) indicated in the one or more beam response(s).

At block 1780, the Rx UE(s) 120c transmits the beam response(s) to the Tx UE2 120b based on the determination at block 1760. The Tx UE2 120b may receive one or more of the beam responses transmitted by Rx UE(s) 120c based on the monitoring at block 1770.

The Tx UE1 120a and/or the Tx UE2 120b may communicate with the Rx UE(s) 120c based on the beam response(s) received at blocks 1775 and/or 1780. For example, in some instances the Tx UE1 120a may communicate sidelink communications with a first Rx UE 120c using the beam direction(s) or Tx and/or Rx beam(s) associated with the beam response(s) received from the first Rx UE 120c. Similarly, the Tx UE2 120b may communicate sidelink communications with a second Rx UE 120c using the beam direction(s) or Tx and/or Rx beam(s) associated with the beam response(s) received from the second Rx UE 120c.

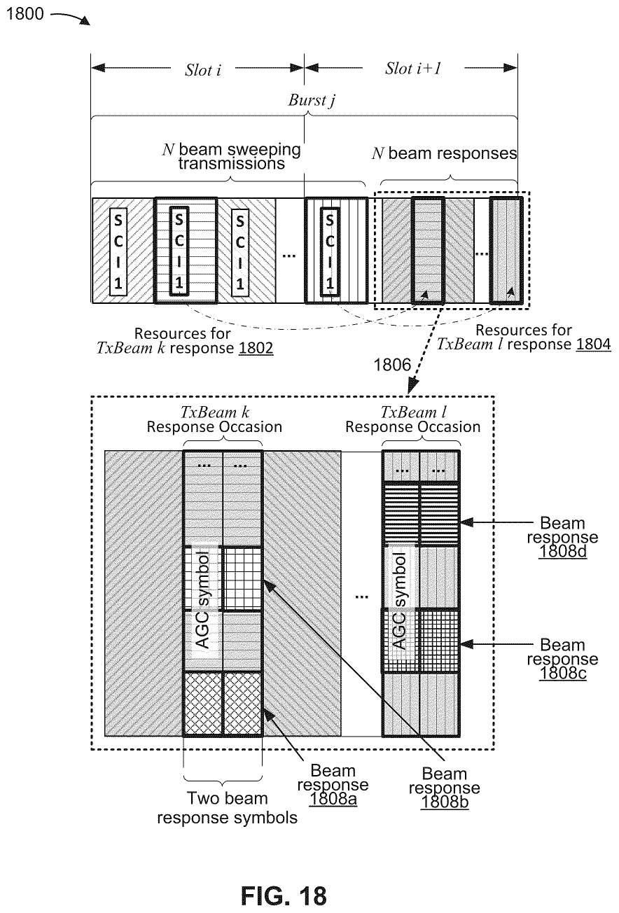

FIG. 18 a diagram illustrating an example 1800 of an S-RSB burst structure including associated beam responses, in accordance with the present disclosure. FIG. 18 is provided as an example. Other examples may differ from what is described with regard to FIG. 18. The example 1800 of FIG. 18 may be similar to the example 1200 of FIG. 12. FIG. 18 includes additional details regarding example beam response structures in accordance with the present disclosure.

As discussed above, a corresponding beam response may be preconfigured or configured (e.g., via RRC message from the network or PC5 RRC message from a Tx UE) or activated (e.g., via MAC CE from the network or PC5 MAC CE from a Tx UE) or indicated by a Tx UE via the SCI (e.g., SCI 1) of one or more sidelink beam signals and/or reference signals (e.g., the beam signal such as an synchronization signal (SS) or a reference signal such as CSI-RS as described previously with respect to an S-RSB) of a sidelink beam signal and/or reference signal burst (e.g., beam sweeping burst using SS, CSI-RS, or other signal as described previously with respect to an S-RSB burst (e.g., Burst j as illustrated). For example, as shown in example 1800, the SCI associated with the second sidelink beam signal or reference signal (e.g., S-RSB associated with TxBeam k as illustrated) of sidelink beam signal or reference signal burst (e.g., S-RSB burst j as illustrated) indicates the resources associated with the corresponding beam response as indicated by arrow 1802. Similarly, the SCI associated with the fourth sidelink beam signal or reference signal (e.g., the S-RSB associated with TxBeam l) of sidelink beam signal or reference signal burst (e.g., S-RSB burst j) indicates the resources associated with the corresponding beam response as indicated by arrow 1804. In some aspects, a set of N beam responses is not needed and/or not included for one or more sets of N beam sweepings. For example, one or more sets of N beam sweepings for Rx beam fine tuning may not be associated with any N beam responses (e.g., internally adjusted and stored at the Rx UE without reporting to the Tx UE), which may be pre-configured or configured or activated or indicated in SCI for Rx beam fine tuning as described previously. For another example, multiple sets of N beam sweepings may be used for selecting both Tx beam and Rx beam (e.g., one example is illustrated in FIG. 10)(as pre-configured or configured or activated or indicated in SCI for initial beam pairing or beamforming as described previously) or for an averaged measurement over multiple sets of N beam sweepings (as pre-configured or configured or activated or indicated in SCI for beam measurement and/or report as described previously), therefore, before a last N beam sweeping of multiple N beam sweepings (e.g., a last set of multiple sets of N beam sweepings), no N beam responses may be utilized. In this regard, one set of N beam responses may be associated with multiple sets of N beam sweepings in one or more bursts, and the N beam response resources may be pre-configured or configured (e.g., via RRC configuration) or activated (e.g., via MAC CE) or reserved or indicated (e.g., SCI-1 or SCI-2) in the SCI transmitted with the first or last set of N beam sweeping of the multiple sets of N beam sweepings (e.g., in the last N beam sweeping transmission part before the N beam responses part starts). In some aspects, a set of N beam responses is indicated with the starting point of the responses and/or the duration of responses, which may be pre-configured or configured or activated or indicated in SCI for Rx beam fine tuning as described previously. For example, a first SCI for one or multiple sets of N beam sweepings may be used for indicating the starting point of the responses and/or the duration of responses.

Aspects of the beam response structures associated with the second sidelink beam signal and/or reference signal (e.g., the S-RSB for TxBeam k Response Occasion) and fourth sidelink beam signal or reference signal (e.g., the S-RSB for TxBeam/Response Occasion) of sidelink beam signal and/or reference signal burst (e.g., S-RSB burst j) are shown in the callout indicated by arrow 1806. As shown, each beam response occasion (e.g., the TxBeam k Response Occasion and the TxBeam/Response Occasion) may include two symbols. In some instances, a beam response occasion may include a single symbol or multiple symbols (e.g., including 2, 3, 4, 5, 6, etc. or other number of symbols). As shown, in some instances a first symbol of the beam response occasion containing more than one symbol may be used for AGC. In the illustrated example, the first symbol used for AGC is the same as the second symbol of the beam response occasion. In some instances, the beam response occasion does not include an AGC symbol (e.g., one or more symbols for beam response(s) only).

As shown in FIG. 18, the TxBeam k Response Occasion may include multiple beam responses (e.g., beam response 1808a and beam response 1808b). In some aspects, the multiple beam responses may be offset in frequency and/or time. In some instances, one beam response (e.g., beam response 1808a) may be associated with a first receive UE and another beam response (e.g., beam response 1808b) may be associated with a second receive UE different than the first receive UE. In this manner, the transmitting UE may receive beam responses from multiple UEs (e.g., the first and second receive UEs) using an Rx beam corresponding to TxBeam k during the TxBeam k Response Occasion.

As also shown in FIG. 18, the TxBeam/Response Occasion may include multiple beam responses (e.g., beam response 1808c and beam response 1808d). In some aspects, the multiple beam responses may be offset in frequency and/or time. In some instances, one beam response (e.g., beam response 1808c) may be associated with a third receive UE and another beam response (e.g., beam response 1808d) may be associated with a fourth receive UE different than the third receive UE. In this manner, the transmitting UE may receive beam responses from multiple UEs (e.g., the third and fourth receive UEs) using an Rx beam corresponding to TxBeam/during the TxBeam/Response Occasion. In some aspects, the transmitting UE may receive beam responses from one or more different UEs during the TxBeam/Response Occasion as compared to the TxBeam k Response Occasion.

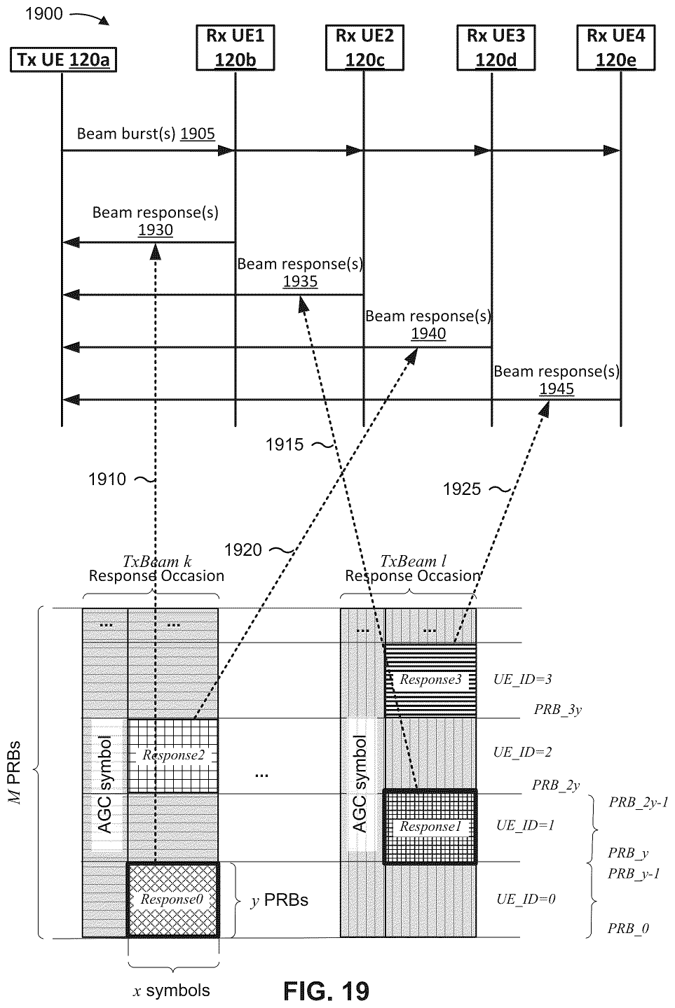

FIG. 19 a diagram illustrating an example 1900 of S-RSB burst(s) and associated beam responses, in accordance with the present disclosure. FIG. 19 is provided as an example. Other examples may differ from what is described with regard to FIG. 19. The example 1900 may employ similar mechanisms as described in FIGS. 3-18. As illustrated, the example 1900 includes a number of enumerated aspects associated with actions of a Tx UE 120a, an Rx UE1 120b, an Rx UE2 120c, an Rx UE3 120d, and an Rx UE4 120c, but aspects of the example 1900 may include additional aspects before, after, and in between the enumerated aspects. In some instances, one or more of the enumerated aspects may be omitted or performed in a different order. Additionally, or alternatively, two or more of the aspects of example 1900 may be performed in parallel and/or combined.

At action 1905, the Tx UE 120a transmits one or more beam sweeping bursts. For example, the Tx UE 120a may transmit, in a plurality of mini-slots of one or more slots, a plurality of sidelink beam signals and/or reference signals (e.g., S-RSBs as illustrated). In some aspects, the Tx UE 120a may transmit the plurality of sidelink beam signals and/or reference signals (e.g., S-RSBs) in one or more bursts based on a sidelink beam management configuration (e.g., initial beamforming or beam pairing, beam fine tuning, beam monitoring with measurement report for beam maintenance, candidate beam report for beam recovery, or any alike). Each of the Rx UEs 120b, 120c, 120d, and 120c may receive one or more sidelink beam signals and/or reference signals, such as the S-RSBs transmitted by the Tx UE 120a. In some aspects, the Tx UE 120a and/or the Rx UEs 120b, 120c, 120d, and 120c may transmit and/or receive (including monitoring for) the plurality of S-RSBs based on a sidelink beam management configuration. In this regard the Tx UE 120a and/or the Rx UEs 120b, 120c, 120d, and 120e may receive the sidelink beam management configuration (e.g., from a base station, network unit, RU, DU, CU, UE, etc.) and/or be preconfigured with the sidelink beam management configuration (e.g., by the manufacturer, network owner, etc.).

Each receiving UE (e.g., Rx UEs 120b, 120c, 120d, and 120c) may transmit one or more beam responses to the Tx UE 120a. The receiving UE may transmit the response(s) using resources for at least one beam response occasion associated with one or more S-RSBs of the plurality of S-RSBs received. In the example 1900 of FIG. 19, each beam response occasion may include M physical resource blocks (PRBs). The M PRBs (pre-) configured or activated for beam responses may be divided into a plurality of groups of PRBs for a plurality of beam responses in frequency domain. As shown, each group of PRBs may include y PRBs. Accordingly, a first PRB group may include PRB_0 to PRB_y-1, a second PRB group may include PRB_y to PRB_2y-1, a third PRB group may include PRB_2y to PRB_3y-1, a fourth PRB group may include PRB_3y to PRB_4y-1, etc. In some instances, each receiving UE (e.g., Rx UEs 120b, 120c, 120d, and 120c) may be allocated one or more PRB groups for transmitting its response(s). For example, in the example of FIG. 19, Rx UE1 120b (e.g., with UE_ID as “0”) is allocated the PRB group including PRB_0 to PRB_y-1 (as indicated by arrow 1910), Rx UE2 120c (e.g., with UE_ID as “1”) is allocated the PRB group including PRB_y to PRB_2y-1 (as indicated by arrow 1915), Rx UE3 120d (e.g., with UE_ID as “2”) is allocated the PRB group including PRB_2y to PRB_3y-1 (as indicated by arrow 1920), and Rx UE4 120c (e.g., with UE_ID as “3”) is allocated the PRB group including PRB_3y to PRB_4y-1 (as indicated by arrow 1925). Accordingly, the receiving UE transmits its beam response(s) using the allocated PRB group. For example, as shown in the example of FIG. 19, the Rx UE1 120b transmits, at action 1930, a beam response (i.e., Response0) associated with the S-RSB for TxBeam k to the Tx UE 120a using x symbols and y PRBs (i.e., PRB_0 to PRB_y-1), the Rx UE2 120c transmits, at action 1935, a beam response (i.e., Response1) associated with the S-RSB for TxBeam l to the Tx UE 120a using x symbols and y PRBs (i.e., PRB_y to PRB_2y-1), the Rx UE3 120d transmits, at action 1940, a beam response (i.e., Response2) associated with the S-RSB for TxBeam k to the Tx UE 120a using x symbols and y PRBs (i.e., PRB_2y to PRB_3y-1), and the Rx UE4 120c transmits, at action 1945, a beam response (i.e., Response3) associated with the S-RSB for TxBeam l to the Tx UE 120a using x symbols and y PRBs (i.e., PRB_3y to PRB_4y-1).

In some instances, each receiving UE (e.g., Rx UEs 120b, 120c, 120d, and 120c) determines the PRBs and/or PRB group allocated to it based on an identifier associated with the UE. In some aspects, the receiving UE may determine a PRB starting index used for transmitting the response(s). In this regard, the first UE may transmit its response(s) over the y PRBs based on the determined PRB starting index. In some aspects, the first UE determines the PRB starting index based at least in part on a UE identifier (e.g., a UE_ID or other local and/or network identifier associated with the first UE). For example, in the example 1900 of FIG. 19 the PRB starting index may be determined based on the following:

$$PRB - Starting - Index = ( UE\_ID mod ⌊ \frac{M}{y} ⌋ ) \times y ,$$

where M is the total number of PRBs available for beam responses and y is the number of PRBs in a group of PRBs allocated to each set of response resources. As another example, in some instances the number of PRBs in each group of PRBs is equal to 1, in which case the PRB starting index may be determined based on the following: PRB-Index=(UE ID) mod M), where M is the total number of PRBs available for beam responses.

In some instances, each beam response occasion (e.g., TxBeam k Response Occasion and TxBeam/Response Occasion) includes an AGC symbol (e.g., the leading symbol of the beam response occasion). In some instances, the receiving UE (e.g., Rx UEs 120b, 120c, 120d, and 120c) may transmit an AGC symbol along with the beam response (i.e., Response0). In some instances, the beam response occasion does not include an AGC symbol and the receiving UE does not transmit an AGC symbol along with the beam response.

The response(s) transmitted by a receiving UE may include an indication of one or more transmit beams, one or more receive beams, one or more beam measurements, and/or one or more candidate beams (e.g., candidate beams with or without the associated measurements). The indication may be an implicit indication (e.g., implicitly indicating selected TX beam(s) based on the resource(s) used to transmit the response (e.g., corresponding to a response occasion associated with a particular sidelink beam signal and/or reference signal, such as the S-RSB or Tx beam) or other correlation) or an explicit indication (e.g., an affirmative indication in a field, information element, or other aspect of the response). In some aspects, the response(s) may include an indication of one or more transmit beams (e.g., a transmit beam ID, a transmit beam index, a sidelink beam pairing or tuning or monitoring signal ID such as S-RSB ID, a sidelink beam pairing or tuning or monitoring signal index or resource index such as S-RSB index, a beam spatial filter or spatial indication such as TCI state, etc.), an indication of one or more receive beams (e.g., a receive beam ID, a receive beam index, a TCI state, spatial filter, etc. associated with a sidelink beam pairing or tuning or monitoring signal ID such as S-RSB ID, a sidelink beam pairing or tuning or monitoring signal index or resource index such as S-RSB index, or S-RSB resource indication), an indication of one or more measurements (e.g., RSSI, RSRP, RSRQ, SINR, CBR, etc.), an indication of one or more candidate beams based on the measurements, and/or a combination thereof. In some aspects, the response(s) may be transmitted using a format with one or more fields. For example, the response(s) may be a multi-bit PSFCH (e.g., mapped to a multi-bit symbol modulated, for example, using QPSK modulation), SCI (e.g., SCI-2 with PSSCH), and/or MAC-CE (e.g., carried on PSSCH) having one or more fields as discussed below. In some aspects, the indication of the one or more transmit beams and/or the one or more receive beams included in the response may be in a list and/or bitmap format.

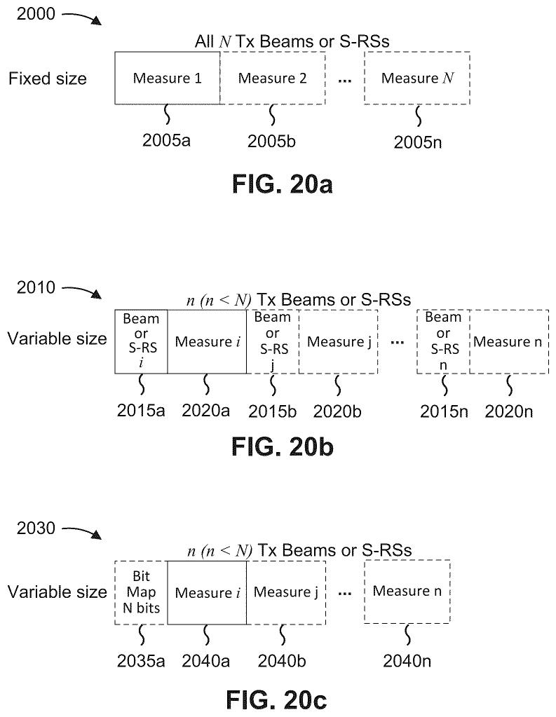

FIGS. 20a-20c are diagrams illustrating examples 2000, 2010, and 2030 of beam response structures, respectively, in accordance with the present disclosure. Example 2000 of FIG. 20a shows a beam response structure having a separate field (e.g., field 2005a, 2005b, . . . , 2005n) associated with each transmit beam and/or sidelink beam signal and/or reference signal such as the S-RSB of one or more sidelink beam signal and/or reference signal bursts such as S-RSB bursts (e.g., beam response after an S-RSB burst for beam fine tuning or beam monitoring measurement or candidate beam selection, or beam response after multiple S-RSB bursts for TX and Rx beam selection for beam pairing). In this regard, the example 2000 may have a fixed size based on the number, N, of transmit beams and/or sidelink beam signals and/or reference signals (e.g., the S-RSBs) of one or more sidelink beam signal and/or reference signal bursts (e.g., the S-RSB bursts). In some aspects, the beam response structure may include a single field (e.g., as shown in solid line in the examples 2000, 2010, and 2030 of FIGS. 20a-20c) for a transmit beam and/or sidelink beam signal and/or reference signal (e.g., the S-RSB) of the one or more sidelink beam signal and/or reference signal bursts (e.g., S-RSB bursts) transmitted at the associated beam response occasion. In some aspects, the beam response structure may include multiple fields (e.g., as shown in solid and dotted line in the examples 2000, 2010, and 2030 of FIGS. 20a-20c) for multiple transmit beams and/or sidelink beam signals and/or reference signals (e.g., the S-RSBs) of the one or more sidelink beam signal and/or reference signal bursts (e.g., S-RSB bursts) at one of the multiple associated beam response occasions (e.g., using the Tx beam corresponding to the Rx beam paired with the best Tx beam at the beam response occasion associated to the best Tx beam selected). The field(s) for transmit beam(s) and/or sidelink beam signals and/or reference signals may be used to provide indications. For example, the field(s) may include an indication of a measurement value (e.g., Measure i (1≤ i≤ N) with an actual measurement value, an averaged measurement value in a time duration (pre-) configured or activated, a measurement value index, an indication of whether a measurement value threshold is satisfied, or otherwise), an indication of a transmit beam (e.g., a transmit beam ID, a transmit beam index, a sidelink beam signal ID, a sidelink beam signal and/or reference signal index, a sidelink beam signal and/or reference signal resource indication, a TCI state (e.g., associated with the sidelink beam signal and/or reference signal), a spatial filter, etc.), and/or an indication of a receive beam (e.g., a receive beam ID, a receive beam index, a TCI state or spatial filter associated with a sidelink beam signal and/or reference signal ID or a sidelink beam signal and/or reference signal index or a sidelink beam signal and/or reference signal resource indication, etc.), and/or combinations thereof.

Example 2010 of FIG. 20b shows a beam response structure that may have a variable size. In some aspects, the example 2010 includes two fields (e.g., field 2015a, 2015b) for each transmit beam and/or sidelink beam signal and/or reference signal of one or more sidelink beam signal and/or reference signal bursts satisfying a threshold (pre-) configured or activated or indicated in SCI (e.g., SCI-2) or MAC CE transmitted with the sidelink beam signal and/or reference signal. In this regard, in contrast to example 2000, the example 2010 may not include a field for each transmit beam and/or sidelink beam signal and/or reference signal (e.g., Beam or S-RS i as illustrated) of one or more sidelink beam signal and/or reference signal bursts. Instead, the size of the example 2010 may vary based on the number, n (less than or equal to N), of transmit beams and/or sidelink beam signals and/or reference signals satisfying the threshold. As shown, for each transmit beam and/or sidelink beam signal and/or reference signal satisfying the threshold, the example 2010 includes a first field (e.g., fields 2015a, 2015b, . . . , 2015n) identifying the transmit beam and/or sidelink beam signal and/or reference signal (e.g., Beam or S-RS i) and second field (e.g., fields 2020a, 2020b, . . . 2020n) including an indication of a measurement (e.g., Measure i) or other indication (e.g., transmit beam and/or receive beam, TCI state, spatial filter, candidate beams, etc.) associated with the transmit beam and/or S-RSB.

Example 2030 of FIG. 20c shows another instances of a beam response structure that may have a variable size. Example 2030 differs from example 2010 in that instead of including a separate fields to identify each transmit beam or sidelink beam signal and/or reference signal (e.g., fields 2015a, 2015b, . . . , 2015n)(e.g., satisfying the threshold) the example 2030 includes a bit map (e.g., bit map 2035a) utilized to identify the transmit beams and/or sidelink beam signals and/or reference signals of one or more sidelink beam signal and/or reference signal bursts that satisfy the threshold. In this regard, the bit map may have a number of bits, N, equal to the number, N, of transmit beams and/or sidelink beam signals and/or reference signals of one or more sidelink beam signal and/or reference signal bursts. The value of the bit corresponding to the transmit beam or sidelink beam signal and/or reference signal may indicate whether the example 2030 includes an associated indication or not. For example, a value of “1” may indicate that an associated indication (e.g., measurement, transmit beam, receive beam) is included, while a value of “0” may indicate that an associated indication is not included. The associated indications as indicated in the bitmap may be included in a separate field for each transmit beam or S-RSB satisfying the threshold (e.g., fields 2040a, 2040b, . . . 2040n following the order of the 1's in the bitmap). In this regard, in contrast to example 2000, the example 2030 may not include a field for each transmit beam and/or sidelink beam signal and/or reference signal of one or more sidelink beam signal and/or reference signal bursts. Instead, the size of the example 2030 may vary based on the number, n (less than or equal to N), of transmit beams and/or sidelink beam signals and/or reference signals satisfying the threshold. The separate fields (e.g., fields 2040a, 2040b, . . . 2040n) may include an indication of a measurement (e.g., Measure i) or other indication (e.g., transmit beam and/or receive beam, TCI state, spatial filter, candidate beams, etc.) associated with the transmit beam and/or S-RSB.

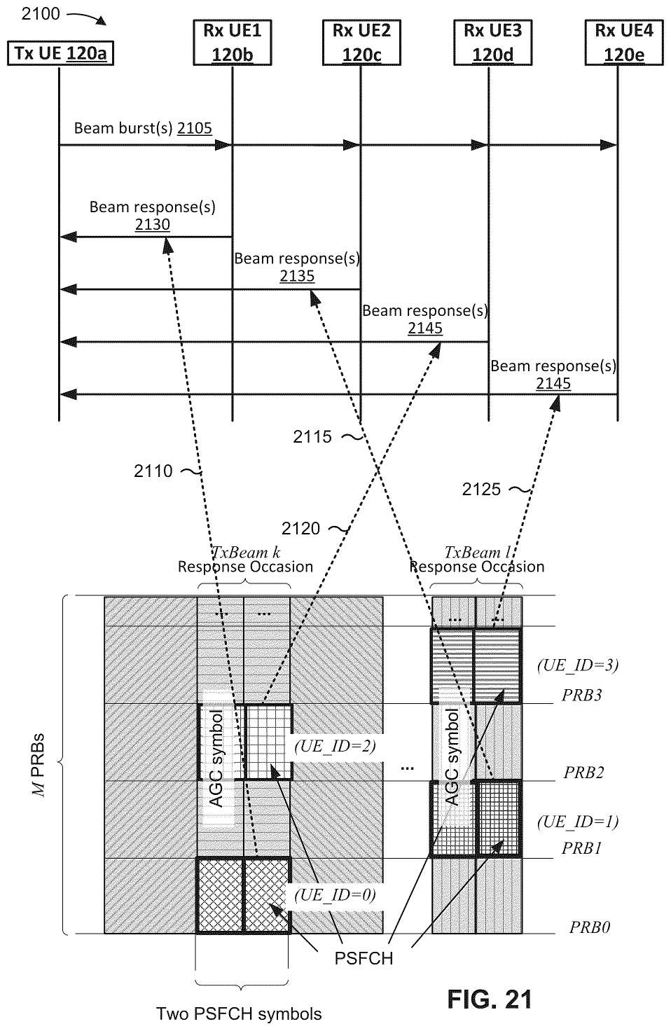

FIG. 21 is a diagram illustrating an example 2100 of sidelink signal burst(s) and associated beam responses, in accordance with the present disclosure. FIG. 21 is provided as an example. Other examples may differ from what is described with regard to FIG. 21. The example 2100 may employ similar mechanisms as described in FIGS. 3-20. In particular, the example 2100 may be similar in many respects to example 1900 discussed above, except that in the example 2100 of FIG. 21 the beam responses are allocated on a per PRB basis instead of on the basis of a group of y PRBs. As illustrated, the example 2100 includes a number of enumerated aspects associated with actions of a Tx UE 120a, an Rx UE1 120b, an Rx UE2 120c, an Rx UE3 120d, and an Rx UE4 120c, but aspects of the example 2100 may include additional aspects before, after, and in between the enumerated aspects. In some instances, one or more of the enumerated aspects may be omitted or performed in a different order. Additionally, or alternatively, two or more of the aspects of example 2100 may be performed in parallel and/or combined.

At action 2105, the Tx UE 120a transmits one or more beam sweeping bursts. For example, the Tx UE 120a may transmit, in a plurality of mini-slots of one or more slots, a plurality of sidelink signals (e.g., sidelink beam signals, sidelink reference signals, and/or S-RSBs). In some aspects, the Tx UE 120a may transmit the plurality of sidelink signals in one or more sidelink signal bursts based on a sidelink beam management configuration. Each of the Rx UEs 120b, 120c, 120d, and 120e may receive one or more sidelink signals transmitted by the Tx UE 120a. In some aspects, the Tx UE 120a and/or the Rx UEs 120b, 120c, 120d, and 120c may transmit and/or receive (including monitoring for) the plurality of sidelink signals based on a sidelink beam management configuration (e.g., beam pairing, fine tuning, monitoring measurement, or candidate beam selection, etc.). In this regard the Tx UE 120a and/or the Rx UEs 120b, 120c, 120d, and 120e may receive the sidelink beam management configuration (e.g., from a base station, network unit, RU, DU, CU, UE, etc.) and/or be preconfigured with the sidelink beam management configuration (e.g., by the manufacturer, network owner, etc.).

Each receiving UE (e.g., Rx UEs 120b, 120c, 120d, and 120c) may transmit one or more beam responses to the Tx UE 120a. The receiving UE may transmit the response(s) using resources for at least one beam response occasion associated with one or more sidelink signals (e.g., sidelink beam signals, sidelink reference signals, and/or S-RSBs) of the plurality of sidelink signals received. In the example 2100 of FIG. 21, each beam response occasion may include M physical resource blocks (PRBs). In some instances, each receiving UE (e.g., Rx UEs 120b, 120c, 120d, and 120c) may be allocated a single PRB for transmitting its response(s). For example, in the example of FIG. 21, Rx UE1 120b (e.g., with UE_ID as “0”) is allocated PRB0 (as indicated by arrow 2110), Rx UE2 120c (e.g., with UE_ID as “1”) is allocated PRB1 (as indicated by arrow 2115), Rx UE3 120d (e.g., with UE_ID as “2”) is allocated PRB2 (as indicated by arrow 2120), and Rx UE4 120c (e.g., with UE_ID as “3”) is allocated PRB3 (as indicated by arrow 2125). Accordingly, the receiving UE transmits its beam response(s) using the allocated PRB. For example, as shown in the example of FIG. 21, the Rx UE1 120b transmits, at action 2130, a beam response associated with the sidelink signal for TxBeam k to the Tx UE 120a using one AGC symbol and one response symbol over PRB0, the Rx UE2 120c transmits, at action 2135, a beam response associated with the sidelink signal for TxBeam l to the Tx UE 120a using one AGC symbol and one response symbol over PRB1, the Rx UE3 120d transmits, at action 2140, a beam response associated with the sidelink signal for TxBeam k to the Tx UE 120a using one AGC symbol and one response symbol over PRB2, and the Rx UE4 120e transmits, at action 2145, a beam response (i.e., Response3) associated with the S-RSB for TxBeam l to the Tx UE 120a using one AGC symbol and one response symbol over PRB3. In other instances, the receiving UEs (e.g., Rx UEs 120b, 120c, 120d, and 120c) may transmit the beam responses in example 2100 without the AGC symbol.

In some instances, each receiving UE (e.g., Rx UEs 120b, 120c, 120d, and 120c) determines the PRB allocated to it based on an identifier associated with the UE. In some aspects, the receiving UE may determine a PRB starting index used for transmitting the response(s). In this regard, the first UE may transmit its response(s) over the PRB indicated by the determined PRB starting index. In some aspects, the first UE determines the PRB starting index based at least in part on a UE identifier (e.g., a UE_ID or other local and/or network identifier associated with the first UE). For example, in the example 2100 of FIG. 21 the PRB starting index may be determined based on the following: PRB-Index= (UJE ID) mod M), where M is the total number of PRBs available for beam responses. As discussed above, the response(s) transmitted by a receiving UE may include an indication of one or more transmit beams, one or more receive beams, and/or one or more beam measurements.

In some aspects, the beam response may be transmitted with a one-bit PSFCH (e.g., a sequence mapped to one-bit indication with a cyclic shift of a base sequence such as a ZC sequence), for example, indicating an “ACK” (e.g., value of “1” or “0” for the one-bit ACK indication mapped to a cyclic shift) for a selected Tx beam or a sidelink signal of the selected Tx beam at the beam response occasion associated to the selected Tx beam or the sidelink signal of the selected Tx beam). In some aspects, the beam response may be transmitted with a one-bit PSFCH, for example, indicating a “NACK” (e.g., value of “0” or “1” for the one-bit NACK indication mapped to a cyclic shift) for a Tx beam or a sidelink signal of the Tx beam with the measurement below a threshold (pre-) configured or activated in MAC CE or indicated in the SCI (e.g., SCI-2 for beam monitoring)(e.g., for beam switching during the beam maintenance) or a Tx beam or a sidelink signal of the Tx beam which fails a beam pair link as an active Tx beam (e.g., beam failure indication) at the beam response occasion associated to the selected Tx beam or the sidelink signal of the selected Tx beam).

In some aspects, the beam response may be transmitted with a two-bit PSFCH (e.g., a sequence mapped to two-bit indication with a cyclic shift of a base sequence such as a ZC sequence), for example, indicating an “ACK, ACK,” “ACK, NACK,” “NACK, ACK,” or “NACK, NACK” mapped respectively to 4 different cyclic shifts for two selected Tx beams or two S-RSBs of the two selected TX beams at one or two (e.g., repeated) of the beam response occasions associated to the two selected Tx beams or the two sidelink beam signals and/or reference signals of the two selected Tx beams).

In some aspects, the beam response may be transmitted with a one-bit PSFCH indicating only an ACK (e.g., a transmission of a PSFCH may indicate an ACK implicitly to a Tx beam or a sidelink beam signal and/or reference signal of the TX beam at a beam response occasion associated to the Tx beam or the sidelink beam signal and/or reference signal of the TX beam). For example, a PSFCH may indicate a “ACK” (e.g., value of “0” or “1” for the one-bit ACK indication mapped to a cyclic shift) for a Tx beam or a sidelink beam signal and/or reference signal of the Tx beam with the measurement above a threshold (pre-) configured or activated in MAC CE or indicated in the SCI (e.g., SCI-2 for beam monitoring)(e.g., for candidate beam selection during the beam maintenance or beam recovery) or a Tx beam or a sidelink beam signal and/or reference signal of the Tx beam that is selected for beam switching as an active Tx beam (e.g., beam switching indication) at the beam response occasion associated to the selected Tx beam or the sidelink beam signal and/or reference signal of the selected Tx beam). In this case, the different cyclic shifts may be used for indicating different UEs transmitting the beam responses. For example, a UE transmitting a beam response may determine a cyclic shift based on the equation: Cyclic_shift=UE_ID mod S, where S is the total number of cyclic shifts available for beam responses (e.g., S=6 for 60 degree angle shift), and a UE monitoring for a beam response may differentiate different UEs transmitting the received beam responses based on the cyclic shift.

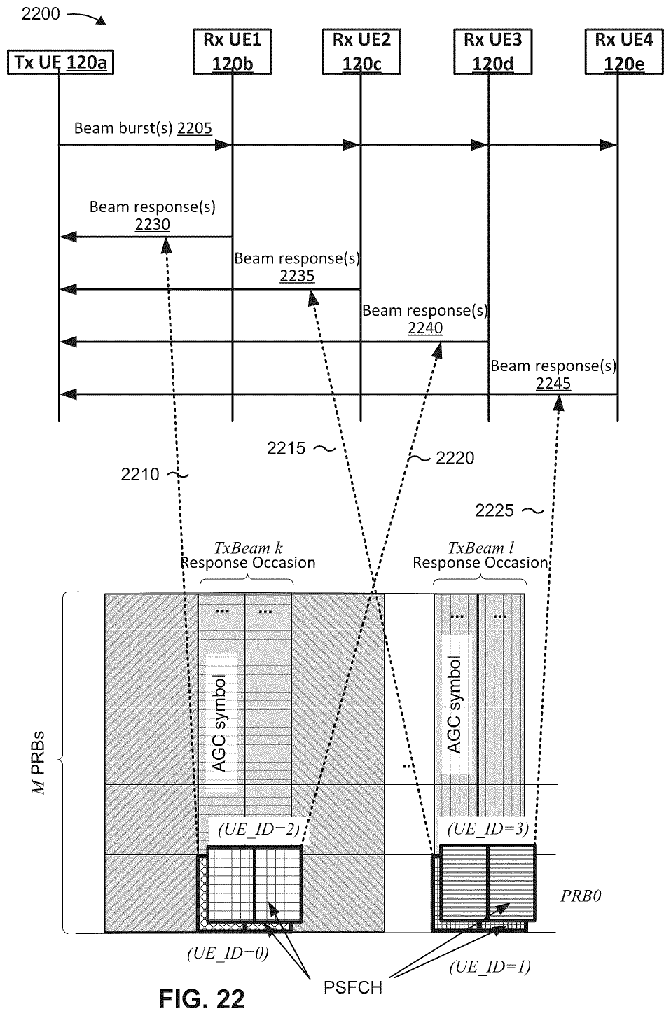

FIG. 22 is a diagram illustrating an example 2200 of sidelink signal burst(s) and associated beam responses, in accordance with the present disclosure. FIG. 22 is provided as an example. Other examples may differ from what is described with regard to FIG. 22. The example 2200 may employ similar mechanisms as described in FIGS. 3-21. In particular, the example 2200 may be similar in many respects to examples 1900 and 2100 discussed above, except that in the example 2200 of FIG. 22 the beam responses may be allocated to a common PRB or common group of PRBs (e.g., (pre-) configured via RRC or activated via MAC CE or dynamically indicated in the SCI (e.g., a flag to enable or disable or an index or code point of beam response resource configuration, for example, based on the channel congestion, available sidelink resources, number of responding UEs, etc.) for multiple UEs. As illustrated, the example 2200 includes a number of enumerated aspects associated with actions of a Tx UE 120a, an Rx UE1 120b, an Rx UE2 120c, an Rx UE3 120d, and an Rx UE4 120c, but aspects of the example 2200 may include additional aspects before, after, and in between the enumerated aspects. In some instances, one or more of the enumerated aspects may be omitted or performed in a different order. Additionally, or alternatively, two or more of the aspects of example 2200 may be performed in parallel and/or combined.

At action 2205, the Tx UE 120a transmits one or more beam sweeping bursts. For example, the Tx UE 120a may transmit, in a plurality of mini-slots of one or more slots, a plurality of sidelink signals (e.g., sidelink beam signal, sidelink reference signal, and/or S-RSBs). In some aspects, the Tx UE 120a may transmit the plurality of sidelink signals in one or more sidelink signal bursts based on a sidelink beam management configuration (e.g., beam pairing, fine tuning, monitoring with measurement, candidate beam selection, etc.). Each of the Rx UEs 120b, 120c, 120d, and 120c may receive one or more S-RSBs transmitted by the Tx UE 120a. In some aspects, the Tx UE 120a and/or the Rx UEs 120b, 120c, 120d, and 120c may transmit and/or receive (including monitoring for) the plurality of sidelink beam signal and/or reference signals based on a sidelink beam management configuration. In this regard the Tx UE 120a and/or the Rx UEs 120b, 120c, 120d, and 120c may receive the sidelink beam management configuration (e.g., from a base station, network unit, RU, DU, CU, UE, etc.) and/or be preconfigured with the sidelink beam management configuration (e.g., by the manufacturer, network owner, etc.).

Each receiving UE (e.g., Rx UEs 120b, 120c, 120d, and 120c) may transmit one or more beam responses to the Tx UE 120a. The receiving UE may transmit the response(s) using resources for at least one beam response occasion associated with one or more sidelink signals of the plurality of sidelink signals received. In the example 2200 of FIG. 22, each beam response occasion may include M physical resource blocks (PRBs). In some instances, multiple and/or all of the receiving UEs (e.g., Rx UEs 120b, 120c, 120d, and 120c) may be allocated a common PRB (e.g., a lowest PRB, a highest PRB, a median PRB, or otherwise) or common PRB group (e.g., a group of y PRBs) for transmitting response(s). For example, in the example of FIG. 22, all of the Rx UEs 120b, 120c, 120d, and 120e are allocated PRB0 (as indicated by arrows 2210, 2215, 2220, and 2225). Accordingly, all of the receiving UEs transmit beam response(s) using the common PRB. For example, as shown in the example of FIG. 22, the Rx UE1 120b (e.g., with UE_ID as ‘0″) transmits, at action 2230, a beam response associated with the sidelink signal for TxBeam k to the Tx UE 120a using one AGC symbol and one response symbol over PRB0, the Rx UE2 120c (e.g., with UE_ID as ‘1″) transmits, at action 2135, a beam response associated with the S-RSB for TxBeam l to the Tx UE 120a using one AGC symbol and one response symbol over PRB0, the Rx UE3 120d (e.g., with UE_ID as ‘2″) transmits, at action 2140, a beam response associated with the sidelink signal for TxBeam k to the Tx UE 120a using one AGC symbol and one response symbol over PRB0, and the Rx UE4 120c (e.g., with UE_ID as ‘3″) transmits, at action 2145, a beam response associated with the sidelink signal for TxBeam l to the Tx UE 120a using one AGC symbol and one response symbol over PRB0. In other instances, the receiving UEs (e.g., Rx UEs 120b, 120c, 120d, and 120e) may transmit the beam responses in example 2100 without the AGC symbol. In some instances, each receiving UE (e.g., Rx UEs 120b, 120c, 120d, and 120c) may determine the common PRB or common PRB group based on a sidelink beam management configuration and/or an indication from the Tx UE 120a. As discussed above, the response(s) transmitted by a receiving UE may include an indication of one or more transmit beams, one or more receive beams, and/or one or more beam measurements.

In some aspects, the beam response may be transmitted with a one-bit PSFCH (e.g., a sequence mapped to one-bit indication with a cyclic shift of a base sequence such as a ZC sequence), for example, indicating an “ACK” (e.g., value of “1” or “0” for the one-bit ACK indication mapped to a cyclic shift) for a selected Tx beam or an S-RSB of the selected TX beam at the beam response occasion associated to the selected Tx beam or the S-RSB of the selected Tx beam). In some aspects, the beam response may be transmitted with a one-bit PSFCH, for example, indicating a “NACK” (e.g., value of “0” or “1” for the one-bit NACK indication mapped to another cyclic shift) for a Tx beam or an S-RSB of the TX beam with the measurement below a threshold (pre-) configured or activated or indicated in the SCI (e.g., SCI-2 for beam monitoring)(e.g., for beam switching during the beam maintenance) or a Tx beam or an S-RSB of the TX beam which fails a beam pair link as an active Tx beam (e.g., beam failure indication) at the beam response occasion associated to the selected Tx beam or the sidelink signal of the selected Tx beam). In this case, a first common PRB may be allocated for “ACK” beam responses from one or more UEs at a beam response occasion associated with a Tx beam or a sidelink signal of a Tx beam and a second common PRB may be allocated for “NACK” beam responses from one or more UEs at a beam response occasion associated with a Tx beam or a sidelink signal of a Tx beam. The UE monitoring for beam responses may determine if a Tx beam is ACKed or NACKed by detecting the beam response at the first common PRB (i.e., an ACK) and/or detecting the beam response at the second common PRB (i.e., a NACK).

In some aspects, the beam response may be transmitted with a one-bit PSFCH indicating only an ACK (e.g., a transmission of a PSFCH may indicate an ACK implicitly to a Tx beam or a sidelink beam signal and/or reference signal of the TX beam at a beam response occasion associated to the Tx beam or the sidelink beam signal and/or reference signal of the TX beam). In this case, different cyclic shifts may be used for indicating different UEs transmitting the beam responses (e.g., ACKing a Tx beam). For example, a UE transmitting a beam response may determine a cyclic shift based on the equation:

Cyclic_shift=UE_ID mod S, where S is the total number of cyclic shifts available for beam responses (e.g., S=6 for 60 degree angle shift), and a UE monitoring for a beam response may differentiate different UEs transmitting the received beam responses based on the cyclic shift.

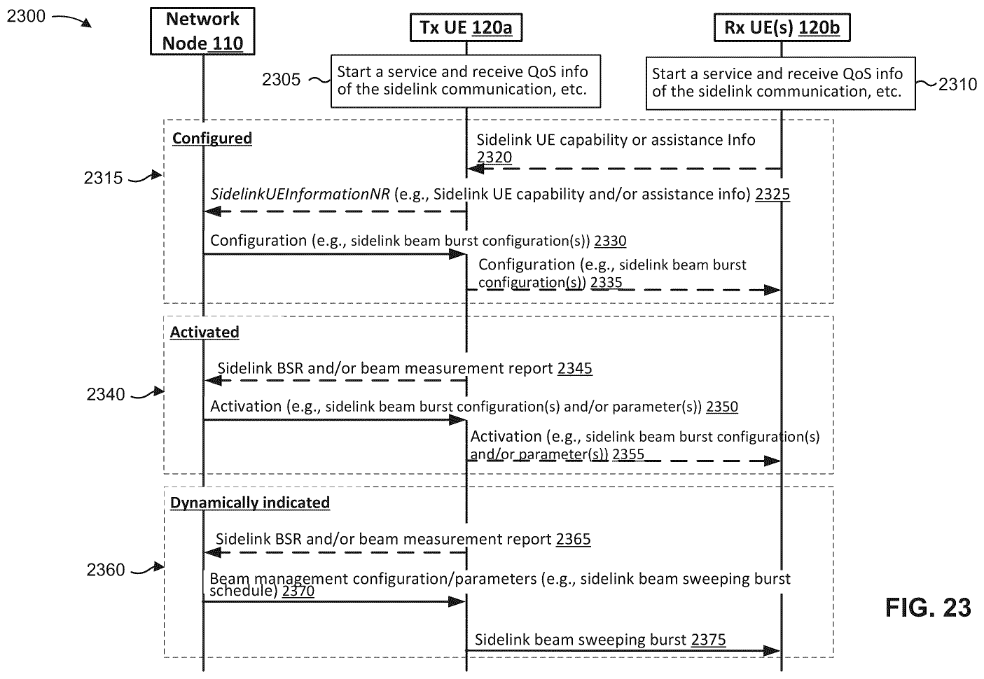

FIG. 23 is a diagram illustrating an example 2300 of techniques associated with sensing and transmitting sidelink beam signals and/or reference signals and associated beam responses, in accordance with the present disclosure. FIG. 23 is provided as an example. Other examples may differ from what is described with regard to FIG. 23. The example 2300 may employ similar mechanisms as described in FIGS. 3-22. As illustrated, the example 2300 includes a number of enumerated aspects associated with actions of a network node 110, a Tx UE 120a, and Rx UE(s) 120b, but aspects of the example 2300 may include additional aspects before, after, and in between the enumerated aspects. In some instances, one or more of the enumerated aspects may be omitted or performed in a different order. Additionally, or alternatively, two or more of the aspects of example 2300 may be performed in parallel and/or combined.

At action 2305, the Tx UE 120a may start a service and/or receive quality of service (QOS) information regarding sidelink communications (e.g., communication range, traffic characteristics with associated latency and reliability, etc. for a sidelink communications associated to an application ID or service type, which may be mapped to a destination ID, for discovery or DCR message or for determining beam pairing or not with the Rx UE(s) 120b).

At action 2310, the Rx UE(s) 120b may start a service and/or receive quality of service (QOS) information regarding sidelink communications (e.g., communication range, traffic characteristics with associated latency and reliability, etc. for a sidelink communications associated to an application ID or service type, which may be mapped to a destination ID, for discovery or DCR message or for determining beam pairing or not with the Tx UE 120a).

At action 2315, in accordance with the present disclosure, UEs (e.g., Tx UE 120a and/or Rx UE(s) 120b) may be preconfigured or configured with parameters related to FR2 operations. For example, the UEs may be provided with a SL-FR2Config or other configuration with a frequency list (e.g., FR2 frequencies or other frequencies) and associated one or more numerologies for one or more SL BWPs respectively, a dedicated beam pairing pool and shared Tx and/or Rx pools for each SL BWP, one or more beam management configurations (e.g., such as burst configurations including beam sweeping configurations and beam response configurations respectively for initial beam pairing, Tx and/or RX beam fine tuning, beam measuring or reporting for beam maintenance or for candidate beam selection for beam recovery, or any parameters (pre-) configured as described previously.) per the numerology of the dedicated-RSB pool.

In some instances, a beam response configuration may include beam response parameters associated with a beam sweeping burst for initial beam pairing, Tx and/or Rx beam fine tuning, beam measuring and/or reporting, candidate beam selection, etc. For example, the beam response parameters may include the number of beam response occasions, the structure or configuration of a beam response (e.g., number of symbols, number of PRBs, format(s), etc.), the total number of PRBs for each beam response occasion, the content of beam response (e.g., one or more Tx and or Rx beams selected, the measurement(s) associated with the Tx beam(s) selected), the container of a beam response (e.g., 1-bit PSFCH for initial beam pairing response, or MAC CE, SCI, or multi-bit PSFCH (e.g., for beam indication and/or beam measurement)), the sidelink beam signal and/or reference signal and/or associated type of a measurement(s)(e.g., RSSI, RSRP, RSRQ, SINR, CBR, etc.).

In some aspects, the network node may determine and/or provide parameters for a sidelink beam management configuration to the Tx UE 120a and/or Rx UE(s) 120b. For example, as shown in the example 2300, the Rx UE(s) 120b may provide sidelink UE capability and/or assistance information to the Tx UE 120a at action 2320. The Rx UE(s) 120b may provide the sidelink UE capability and/or assistance information after discovery and/or establishing PC5 communication with the Tx UE 120a. At action 2325, the Tx UE 120a may provide the sidelink UE capability and/or assistance information from the Rx UE(s) 120b and/or its own the sidelink UE capability and/or assistance information to the network node 110. At action 2330, the network node 110 may transmit a sidelink beam management configuration (e.g., an RRC configuration or reconfiguration message) to the Tx UE 120a. The sidelink beam management configuration may include information regarding sidelink beam burst configurations, beam response configurations, and/or other parameters (as described previously in FIGS. 7-16 and 18-22, etc.). In some instances, the network node 110 may determine one or more aspects of the sidelink beam management configuration based on the sidelink UE capability and/or assistance information received from the Tx UE 120a (e.g., the number of panels, the number of beams for each panel, the types of beams such as wide or medium or narrow, QoS profiles containing communication range, latency, reliability, etc.). Additionally, at action 2335, the Tx UE 120a may transmit or forward the sidelink beam management configuration and/or one or more parameters of the sidelink beam management configuration to the Rx UE(s) 120b (e.g., via PC5 RRC configuration message after PC5 connection establishment).

At action 2340, in accordance with some aspects, one or more configurations or one or more parameter values of a configuration may be activated or deactivated (e.g., by network node 110 if under the network coverage and/or by the Tx UE 120a) based on channel conditions and/or system loading (e.g., reducing the frequency of beam sweeping burst (e.g., increasing the period of periodic beam sweeping or reducing the number of beam sweeping bursts during a sidelink beam sweeping window (e.g., a sweeping window configured or activated for semi-persistent beam sweeping bursts or a one-time beam sweeping burst), or reducing the number of beam of each beam sweeping burst if the channel is congested or over loaded) or status of beam management (e.g., increasing Tx and/or Rx beam fine tuning with higher dual mobility between UEs) or the QoS requirement of a sidelink communication (e.g., using one or more narrow beams for longer communication range, short latency, or high reliability, etc.). At action 2345, the Tx UE 120a may transmit a sidelink BSR, beam management report (e.g., Tx and/or Rx beams, beam measurements, candidate beams, etc.), and/or other information to the network node 110. At action 2350, the network node 110 may transmit an indication of an activation (or deactivation) of one or more configurations and/or one or more parameters (e.g., via MAC CE or DCI activation or deactivation). In some instances, the network node 110 may determine to activate and/or deactivate the one or more configurations and/or one or more parameters based at least in part on the sidelink BSR, the beam management report, and/or the other information received from the Tx UE 120a. At action 2355, the Tx UE 120a may transmit or forward an indication of the activation (or deactivation) to the Rx UE(s) 120b (e.g., via PC5 MAC CE after PC5 connection establishment.

At action 2360, in accordance with some aspects, one or more configurations or one or more parameter values of a configuration may be dynamically indicated (e.g., in DCI scheduling sidelink beam sweeping burst by the network node 110 if under the network coverage or in SCI transmitted with sidelink beam sweeping burst by the Tx UE) based on the channel condition or system loading or status of beam management or the QoS requirement of a sidelink communication. At action 2365, the Tx UE 120a may transmit a sidelink BSR, beam management report, and/or other information to the network node 110. At action 2370, the network node 110 may transmit an indication of one or more configurations or one or more parameter values of a sidelink beam management configuration (e.g., a sidelink beam sweeping burst schedule)(e.g., indicating an index or code point of a configuration for beam sweeping). In some instances, the network node 110 may determine the one or more configurations or one or more parameter values of a sidelink beam management configuration based at least in part on the sidelink BSR, the beam management report, and/or the other information received from the Tx UE 120a. At action 2375, the Tx UE 120a may transmit a sidelink beam sweeping burst based on the one or more configurations or one or more parameter values of a sidelink beam management configuration dynamically indicated in SCI transmitted with S-RSB as described previously at action 2370.

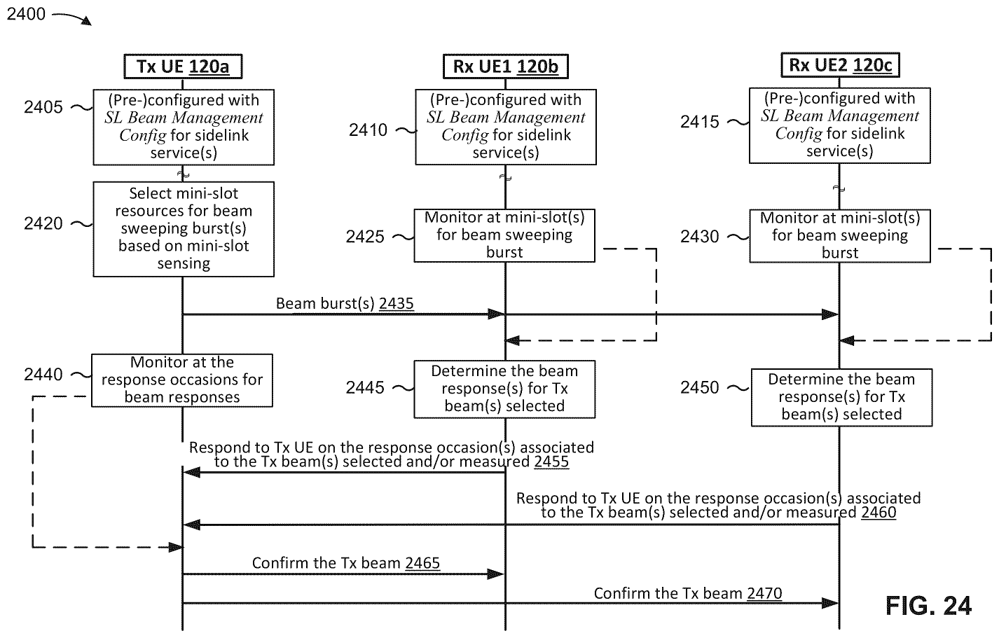

FIG. 24 is a diagram illustrating an example 2400 associated with sensing and transmitting sidelink signal transmissions (e.g., sidelink beam signals, sidelink reference signals, S-RSBs) and associated beam responses, in accordance with the present disclosure. FIG. 24 is provided as an example. Other examples may differ from what is described with regard to FIG. 24. The example 2400 may employ similar mechanisms as described in FIGS. 3-23. As illustrated, the example 2400 includes a number of enumerated aspects associated with actions of a Tx UE 120a, an Rx UE1 120b, and an Rx UE2 120c, but aspects of the example 2300 may include additional aspects before, after, and in between the enumerated aspects. In some instances, one or more of the enumerated aspects may be omitted or performed in a different order. Additionally, or alternatively, two or more of the aspects of example 2300 may be performed in parallel and/or combined.

At block 2405, the Tx UE 120a may be pre-configured and/or configured with one or more sidelink beam management configurations (e.g., one or more configurations for mini-slot sensing or measurements, beam pairing parameters, beam fine tuning parameters, beam measurement parameters for beam maintenance or monitoring, candidate beam selection parameters for beam recovery, as described previously in FIGS. 7-16 and 18-22, etc.) for one or more sidelink services (e.g., associated respectively with one or more service type IDs or PC5 link IDs or pairs of layer 2 source and/or destination IDs of sidelink communication).

At block 2410, the Rx UE1 120b may be pre-configured and/or configured with one or more sidelink beam management configurations for one or more services (e.g., in a similar manner to TX UE 120a at block 2405). The sidelink beam management configuration(s) of the Rx UE1 120b may be the same or different than the sidelink beam management configuration(s) of the Tx UE 120a, for example, based on UE's capability (e.g., number of panels, number of beam per panel, beam types, etc.).

At block 2415, the Rx UE2 120c may be pre-configured and/or configured with one or more sidelink beam management configurations for one or more services (e.g., in a similar manner to Tx UE 120a at block 2405 and/or Rx UE1 120b at block 2410). The sidelink beam management configuration(s) of the Rx UE2 120c may be the same or different than the sidelink beam pairing configuration(s) of the Tx UE 120a and/or the Rx UE1 120b, for example, based on UE's capability (e.g., number of panels, number of beam per panel, beam types, etc.).

At block 2420, the Tx UE 120a selects mini-slot resources for one or more beam sweeping bursts. For example, the Tx UE 120a may select mini-slot resources for its beam sweeping bursts based on the resources configured in the received beam management configuration (e.g., configured for a sidelink service (e.g., associated to a service type ID or PC5 link ID or pair layer source and destination IDs)) or based on the sensing of mini-slot to reduce and/or avoid interfering with resources utilized by other UEs for sidelink beam sweeping (or result in interference satisfying a threshold (e.g., below and/or equal to the threshold)).

At block 2425, the Rx UE1 120b monitors for beam sweeping bursts based on its beam management configuration(s). At block 2430, the Rx UE2 120c monitors for beam sweeping bursts based on its beam management configuration(s). The Rx UE1 120n and the Rx UE2 120c may monitor for S-RSBs from the Tx UE 120a and/or other UEs. In this regard, the Rx UE1 120b and the Rx UE 120c may monitor a plurality of mini-slots of a slot for a plurality of sidelink reference signal block (S-RSBs)(see, e.g., FIGS. 9-16, 18, 19, 21, and 22).

At block 2435, the Tx UE 120a transmits one or more beam sweeping bursts using the resources selected at block 2420. The Rx UE1 120b and/or the Rx UE 120c may receive one or more of the sidelink signals associated with the beam sweeping bursts of the Tx UE1 120a based on the monitoring at blocks 2425 and 2530, respectively.

At block 2440, the Tx UE 120a monitors for beam responses during beam response occasions associated with the beam burst(s) transmitted at block 2435. In this regard, each sidelink signal of a sidelink signal burst transmitted by Tx UE 120a may have an associated beam response occasion that may be (pre-) configured or activated or indicated in the SCI as described previously. Accordingly, the Tx UE 120a may monitor the resources associated with each beam response occasion to detect one or more beam responses from other UEs (e.g., Rx UE1 120b and/or Rx UE2 120c).

At blocks 2445 and 2450, the Rx UE1 120b and the Rx UE2 120c respectively determine the beam response occasion(s), for example, based on the beam response configuration (e.g., via RRC configuration) or activation (e.g., via MAC CE activation) or indication (e.g., SCI indication or reservation) to transmit a beam response to the Tx UE1 120a. The Rx UE1 120b and/or the Rx UE2 120c may determine, based on the monitoring at blocks 2425 and 2430, respectively, at least one beam response occasion associated with at least one of the plurality of sidelink beam signals and/or reference signals transmitted by Tx UE1 120a. In some instances, the Rx UE1 120b and/or the Rx UE2 120c may determine the beam response occasion(s) by identifying one or more Tx beams used to transmit the plurality of sidelink beam signals and/or reference signals satisfying a threshold. For example, one or more Tx beams having at least one of a sidelink reference signal receive power (SL-RSRP), a sidelink reference signal received quality (SL-RSRQ), or sidelink signal to interference and noise ratio (SL-SINR) satisfying a threshold may be identified. In some aspects, the Rx UE1 120b identifies a best beam (e.g., Tx beam k) of the beams used to transmit the plurality of sidelink beam signals and/or reference signals and determines to transmit the beam response during the beam response occasion associated with the best Tx beam or associated sidelink signal. Similarly, the Rx UE2 120c identifies a best Tx beam (e.g., Tx beam l) of the beams used to transmit the plurality of sidelink beam signals and/or reference signals and determines to transmit the beam response during the beam response occasion associated with the best Tx beam or associated sidelink signal.

At block 2455, the Rx UE1 120b transmits the beam response(s) to the Tx UE 120a based on the determination at block 2445. The Tx UE1 120a may receive one or more of the beam responses transmitted by Rx UE1 120b based on the monitoring at block 2440. In this regard, in some aspects the Rx UE1 120b may identify multiple selected beams (e.g., transmit beams and/or receive beams) in a single beam response (e.g., a beam response including multiple fields and/or bits to indicate the selected transmit and/or receive beams and/or associated measurements)(see, e.g., FIGS. 20a-20c) or multiple beam responses (e.g., one beam response per selected transmit beam and/or receive beam). In some aspects, at block 2455, the Rx UE1 120b may transmit one or more beam responses at one or more beam response occasions respectively using the corresponding one or more transmitting beams. The Rx UE1 120b may transmit the beam response(s) at a PRB allocation (see, e.g., FIGS. 19, 21, and/or 22) based on an ID of Rx UE1 120b using PFSCH, SCI, MAC CE, or other communication. In some aspects, the Rx UE1 120b transmits the beam response(s) at a common PRB allocation using one-bit PFSCH. The beam response transmitted by the Rx UE1 120b may be for initial beam pairing, beam fine tuning, beam selection for beam switching and/or beam recovery, or otherwise.

At block 2460, the Rx UE2 120c transmits the beam response(s) to the Tx UE 120a based on the determination at block 2450. The Rx UE2 120c may transmit the beam response(s) in a similar manner to Rx UE1 120b described above.

The Tx UE1 120a may receive one or more of the beam responses from the Rx UE1 120b and/or the Rx UE2 120c at the one or more beam response occasions. In some aspects, the Rx UE1 120b may identify the Rx UE1 120b and/or Rx UE 120c via an ID (e.g., an L1 source ID or a link ID or a device ID) indicated in the one or more beam response(s).

At block 2465, the Tx UE 120a may confirm one or more beam parameters (e.g., beam pairing with Tx beam, Rx beam, TCI state(s), spatial filter, beam switching, beam selected from the candidate beams for beam recovery, etc.) for sidelink communications with Rx UE1 120b. In this regard, the Tx UE 120a may confirm the one or more beam parameters for initial beam pairing, Tx beam fine tuning, Tx beam switching, Rx beam fine tuning, candidate beam selection for beam recovery, or otherwise, based on the received beam responses.

At block 2470, the Tx UE 120a may confirm one or more beam parameters (e.g., Tx beam, Rx beam, TCI state(s), etc.) for sidelink communications with Rx UE2 120c. The Tx UE 120a may confirm the beam parameter(s) for Rx UE2 120c in a similar manner to Rx UE1 120b described above.

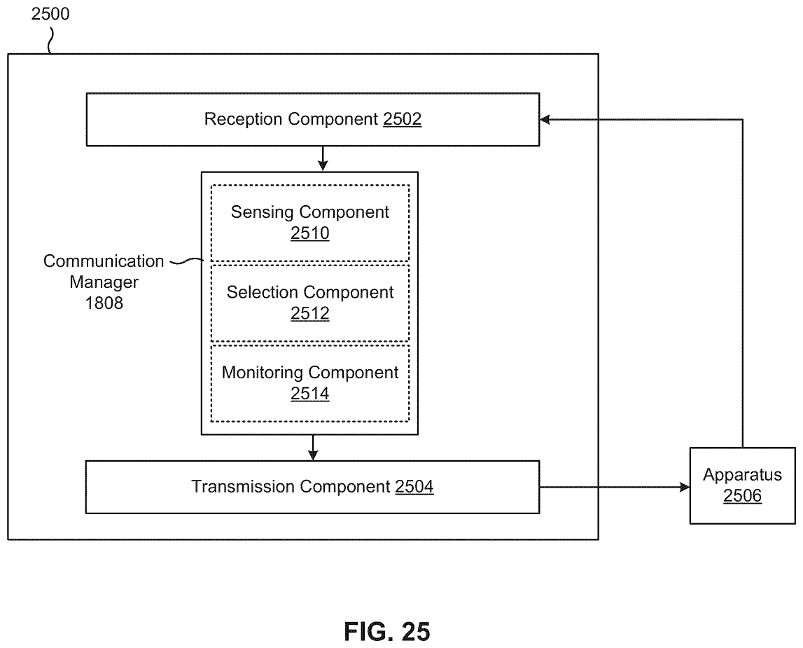

FIG. 25 is a diagram of an example apparatus 2500 for wireless communication, in accordance with the present disclosure. The apparatus 2500 may be a UE, or a UE may include the apparatus 2500. In some aspects, the apparatus 2500 includes a reception component 2502 and a transmission component 2504, which may be in communication with one another (for example, via one or more buses and/or one or more other components). As shown, the apparatus 2500 may communicate with another apparatus 2506 (such as a UE, a base station (e.g., network unit, RU, CU, and/or DU), or another wireless communication device) using the reception component 2502 and/or the transmission component 2504. As further shown, the apparatus 2500 may include a communication manager 2508. The communication manager 2508 may control and/or otherwise manage one or more operations of the reception component 2502 and/or the transmission component 2504. In some aspects, the communication manager 2508 may include one or more antennas, a modem, a controller/processor, a memory, or a combination thereof, of the UE described in connection with FIG. 2. The communication manager 2508 may be, or be similar to, the communication managers 140a, 140e, and/or 140f depicted in FIGS. 1 and 2. For example, in some aspects, the communication manager 2508 may be configured to perform one or more of the functions described as being performed by one or more of the communication managers 140a, 140c, and/or 140f. In some aspects, the communication manager 2508 may include the reception component 2502 and/or the transmission component 2504. The communication manager 2508 may include a sensing component 2510, a selection component 2512, and/or a monitoring component 2514, among other examples.

In some aspects, the apparatus 2500 and/or one or more components shown in FIG. 25 may include one or more components of the UE described in connection with FIG. 2. Additionally, or alternatively, one or more components shown in FIG. 25 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

In some aspects, the apparatus 2500 may be configured to perform one or more operations described herein in connection with FIGS. 1-24. Additionally, or alternatively, the apparatus 2500 may be configured to perform one or more processes described herein, such as process 2600 of FIG. 26, process 2700 of FIG. 27, or a combination thereof. Additionally, or alternatively, the apparatus 2500 may be configured to perform one or more aspects of clauses 1-57 described below or a combination thereof. In this regard, the apparatus 2500 may include one or more memories (or at least one memory) and one or more processors (or at least one processor) coupled with the one or more memories individually or collectively configured to perform one or more operations, functions, and/or aspects of the present disclosure. Likewise, the apparatus 2500 may include a set of one or more memories and a set of one or more processors coupled to the set of one or more memories individually or collectively configured to perform one or more operations, functions, and/or aspects of the present disclosure.

The reception component 2502 may receive communications, such as reference signals, control information, data communications, or a combination thereof, from the apparatus 2506. The reception component 2502 may provide received communications to one or more other components of the apparatus 2500. In some aspects, the reception component 2502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2500. In some aspects, the reception component 2502 may include one or more antennas, a modem, a demodulator, a MIMO detector, a receive processor, a controller/processor, a memory, or a combination thereof, of the UE described in connection with FIG. 2.

The transmission component 2504 may transmit communications, such as reference signals, control information, data communications, or a combination thereof, to the apparatus 2506. In some aspects, one or more other components of the apparatus 2500 may generate communications and may provide the generated communications to the transmission component 2504 for transmission to the apparatus 2506. In some aspects, the transmission component 2504 may perform signal processing on the generated communications (such as filtering, amplification, modulation, digital-to-analog conversion, multiplexing, interleaving, mapping, or encoding, among other examples), and may transmit the processed signals to the apparatus 2506. In some aspects, the transmission component 2504 may include one or more antennas, a modem, a modulator, a transmit MIMO processor, a transmit processor, a controller/processor, a memory, or a combination thereof, of the UE described in connection with FIG. 2. In some aspects, the transmission component 2504 may be co-located with the reception component 2502 in a transceiver.

In some aspects, the sensing component 2510 may perform sensing in a sidelink resource pool. In some instances, the sensing component 2510 performs mini-slot based sensing. In some aspects, the sensing component 2510 performs the mini-slot based sensing based on a sidelink beam management configuration. For example, in some instances the sensing component 2510 monitors for one or more S-RSBs of a S-RSB burst based the sidelink beam management configuration. In this regard, the sensing component 2510 may monitor a resource pool dedicated to S-RSB bursts for one or more services as indicated in the sidelink beam management configuration.

The selection component 2512 may select, based at least in part on the sensing performed by the sensing component 2510, one or more sidelink resources for transmitting one or more S-RSBs, where each S-RSB includes at least one RS and SCI. The transmission component 2504 may transmit the one or more S-RSBs in an S-RSB burst using the selected one or more sidelink resources. The transmission component 2504 may transmit the one or more S-RSBs in a beam sweeping pattern. The selection component 2512 may determine, based at least in part on the sensing performed by the sensing component 2510, one or more sidelink resources for transmitting one or more beam responses, where each beam response may be associated with one or more S-RSBs of an S-RSB burst. The transmission component 2504 may transmit the one or more beam responses.

The monitoring component 2514 may monitor for a sidelink communication based at least in part on each S-RSB of the one or more S-RSBs in the S-RSB burst. The reception component 2502 may receive the sidelink communication. The reception component 2502 may receive an indication of a selected beam associated with the second beam sweeping pattern. In some aspects, the monitoring component 2514 may monitor for one or more S-RSBs in an S-RSB burst in a sidelink resource pool. The reception component 2502 may receive the one or more S-RSBs in the S-RSB burst, where each S-RSB in the S-RSB burst includes at least one RS and SCI. The selection component 2512 may select a beam based at least in part on the one or more S-RSBs in the S-RSB burst. The selection component 2512 may select resources for one or more beam responses based at least in part on measurements associated with one or more S-RSBs in the S-RSB burst.

The sensing component 2510 may perform sensing for a sidelink communication. The selection component 2512 may select a resource for the sidelink communication based at least in part on a selected beam. The transmission component 2504 may transmit the sidelink communication.

The selection component 2512 may map a resource set to an S-RSB of the one or more S-RSBs of the S-RSB burst based at least in part on a received beam identifier, a beam index, or an S-RSB index indicated by SCI in an S-RSB associated with the selected beam. The selection component 2512 may determine a transmitting beam based at least in part on a beam identifier, a beam index, an S-RSB index, a TCI state indicated by SCI in an S-RSB associated with the selected beam, or a spatial filter indicated by the SCI.

The number and arrangement of components shown in FIG. 25 are provided as an example. In practice, there may be additional components, fewer components, different components, or differently arranged components than those shown in FIG. 25. Furthermore, two or more components shown in FIG. 25 may be implemented within a single component, or a single component shown in FIG. 25 may be implemented as multiple, distributed components. Additionally, or alternatively, a set of (one or more) components shown in FIG. 25 may perform one or more functions described as being performed by another set of components shown in FIG. 25.

FIG. 26 is a diagram illustrating an example process 2600 performed, for example, by a UE or an apparatus of the UE, in accordance with the present disclosure. Example process 2600 is an example where the UE (e.g., UE 120, UE 120a, UE 120b, UE 120c, apparatus 2500, apparatus 2506) performs operations associated with sensing-based sidelink beam pairing in accordance with the present disclosure. The UE may utilize one or more components, such as the reception component 2502, the transmission component 2504, the communication manager 2508, a processor, a memory, etc., to execute the blocks of process 2600. The process 2600 may employ similar mechanisms as described in FIGS. 3-24. As illustrated, the process 2600 includes a number of enumerated blocks, but aspects of the process 2600 may include additional blocks before, after, and in between the enumerated blocks. In some aspects, one or more of the enumerated blocks may be omitted or performed in a different order. Additionally, or alternatively, two or more of the blocks of process 2600 may be performed in parallel and/or combined.

At block 2610, a first user equipment (UE) receives, in one or more mini-slots of one or more slots, one or more sidelink reference signal blocks (S-RSBs) of a plurality of S-RSBs associated with a second UE. In some aspects, the first UE receives the one or more S-RSBs based on monitoring for the plurality of S-RSBs associated with the second UE in a plurality of mini-slots of one or more slots (see, e.g., FIGS. 9-19 and 21-24). In some aspects, the first UE monitors for the plurality of S-RSBs using resources associated with a dedicated beam pairing pool (see, e.g., FIG. 14). The first UE may monitor for the plurality of S-RSBs using a single receive beam direction (see, e.g., FIGS. 10-11) or using multiple receive beam directions (see, e.g., FIGS. 12-13).

In some instances, each of the mini-slots in which the first UE monitors for the plurality of S-RSBs and/or receives the one or more S-RSBs occupies either two symbols or four symbols. In some aspects, each of the plurality of S-RSBs occupies either two symbols, three symbols, or four symbols. In some aspects, the first UE monitors for the plurality of S-RSBs based on a sidelink beam management configuration. In this regard, the first UE may receive the sidelink beam management configuration (e.g., from a base station, network unit, RU, DU, CU, UE, etc.). In some instances, the UE is preconfigured with the sidelink beam management configuration (e.g., by the manufacturer, network owner, etc.). The sidelink beam management configuration may indicate one or more numerologies associated with one or more sidelink bandwidth parts, one or more resources associated with a dedicated beam pairing pool for each of one or more sidelink bandwidth parts, one or more beam pairing burst parameters, one or more resources for a beam response, and/or other parameters associated with sensing-based sidelink beam management.

At block 2620, the first UE transmits, to the second UE, at least one response associated with at least one S-RSB of the one or more S-RSBs received. The first UE may transmit the response(s) using resources for at least one beam response occasion associated with the at least one S-RSB of the plurality of S-RSBs (see, e.g., FIGS. 12, 15-19, 21-24). The first UE may determine, based on receiving the one or more S-RSBs and/or monitoring for the plurality of S-RSBs, at least one beam response occasion and transmit the response(s) associated with at least one of the plurality of S-RSBs using the at least one beam response occasion.

In some instances, the first UE determines the beam response occasion(s) for transmitting the response(s) by identifying one or more beams used to transmit the one or more S-RSBs received that satisfy a threshold. For example, the first UE may identify transmit beams having at least one of a sidelink reference signal receive power (SL-RSRP), a sidelink reference signal received quality (SL-RSRQ), or sidelink signal to interference and noise ratio (SL-SINR) satisfying the threshold. In some instances, the threshold is based on at least one of a sidelink priority level (e.g., associated with a sidelink communication and/or a sidelink UE) or a channel busy ratio (CBR) level. In this regard, different sidelink priority levels and/or different CBR levels may have different associated thresholds. For example, in some instances a lower priority level may have a higher threshold, while a higher priority level may have a lower threshold. If the measurement for a particular S-RSB satisfies the threshold (e.g., is above or equal to a signal quality threshold), then the first UE may transmit a response in the associated beam response occasion. In some aspects, the first UE may transmit a response for the best x beams, where x is an integer equal to or greater than 1. In some aspects, the first UE may transmit a single response associated including indications for multiple S-RSBs using the beam response occasion associated with the best beam (see, e.g., FIGS. 20a-20c).

The first UE may transmit the at least one response using at least one beam response occasion with a single symbol and/or at least one beam response occasion with a plurality of symbols. In some aspects, a first symbol of a beam response occasion is associated with automatic gain control (AGC). In this regard, the AGC symbol may include the same information as a second symbol (e.g., a beam response) transmitted during the beam response occasion.

The first UE may transmit the at least one response over a quantity of symbols greater than or equal to 1 (e.g., 1, 2, 3, 4, etc.). In some aspects, the quantity of symbols, x, may be determined by the first UE based on a sidelink beam management configuration. The first UE may transmit the at least one response over a quantity of physical resource blocks (PRBs) greater than or equal to 1 (e.g., 1, 2, 3, 4, etc.)(see, e.g., FIGS. 19, 21, and 22). In some aspects, the first UE transmits the at least one response over one symbol and one PRB. In this regard, the first UE may transmit the at least one response over a common PRB (e.g., a lowest PRB index, PRB0, or other PRB index), where the common PRB associated with a plurality of UEs (see, e.g., FIG. 22). In some instances, the first UE may transmit an AGC symbol along with the at least one response that is transmitted over one symbol and one PRB (see, e.g., FIGS. 21-22). In some instances, the first UE may transmit the at least one response over one symbol and one PRB without an accompanying AGC symbol.

In some aspects, the first UE may determine a PRB starting index used for transmitting the at least one response. In this regard, the first UE may transmit the at least one response over the quantity of PRBs beginning with the PRB starting index. In some aspects, the first UE determines the PRB starting index based at least in part on a UE identifier associated with the first UE (e.g., a UE_ID or other local and/or network identifier associated with the first UE).

For example, in some instances the PRB starting index may be determined based on the following: PRB-Starting-Index=(UE_ID mod |M/y|)×y, where M is the total number of PRBs available for beam responses and y is the number of PRBs in a group of PRBs allocated to each set of response resources. Accordingly, a first Rx UE (e.g., the first UE, UE_ID=0) may transmit a first beam response (e.g., Response0 over PRB_0˜ PRB_y-1) at the beam response occasion associated to a first best Tx beam (e.g., TxBeam k) selected by the first Rx UE, while a second Rx UE (e.g., a second UE, UE_ID=1) may transmit a second beam response (e.g., Response l over PRB_y˜PRB_2y-1) at the beam response occasion associated to a second best Tx beam (e.g., TxBeam l) selected by the second Rx UE (see, e.g., FIG. 19).

As another example, in some instances responses for different UEs may be mapped to different PRBs and the PRB starting index may be determined based on the following: PRB-Index=(UE ID) mod M), where M is the total number of PRBs available for beam responses. Accordingly, a first Rx UE (e.g., the first UE, UE_ID=0) may transmit a first beam response (e.g., a one-bit PSFCH) in a first PRB (e.g., at PRB0) at the beam response occasion associated to a first best Tx beam (e.g., TxBeam k) selected by the first Rx UE, while a second Rx UE (e.g., a second UE, UE_ID=1) may transmit a second beam response (e.g., a one-bit PSFCH) in a second PRB (e.g., at PRB1) at the beam response occasion associated to a second best Tx beam (e.g., TxBeam l) selected by the second Rx UE (see, e.g., FIG. 21).

The at least one response transmitted by the first UE may include an indication of one or more transmit beams, one or more receive beams, and/or one or more beam measurements. The indication may be an implicit indication (e.g., based on the resource(s) used to transmit the response (e.g., corresponding to a response occasion associated with a particular S-RSB) or other correlation) or an explicit indication (e.g., an affirmative indication in a field, information element, or other aspect of the response). In some aspects, the at least one response transmitted by the first UE may include an indication of one or more transmit beams (e.g., a transmit beam ID, a transmit beam index, an S-RSB ID, an S-RSB index, a TCI state, etc.) associated with transmitting the one or more S-RSBs (e.g., for the best x transmit beam(s)), an indication of one or more receive beams (e.g., a receive beam ID, a receive beam index, an S-RSB ID, an S-RSB index, a TCI state, etc.) associated with receiving the one or more S-RSBs (e.g., the best z receive beam(s)), an indication of one or more measurements (e.g., RSSI, RSRP, RSRQ, SINR, CBR, etc.) of one or more transmit beams associated with transmitting the one or more S-RSBs, and/or a combination thereof.

In some aspects, the at least one response may be transmitted by the first UE over x symbols and y PRBs using a format with one or more fields. For example, the response may be a multi-bit PSFCH, SCI, and/or MAC-CE having one or more fields (see, e.g., FIGS. 20a-20c). In some aspects, the indication of the one or more transmit beams and/or the one or more receive beams included in the response may be in a list and/or bitmap format. In some instances, the indication of the one or more measurements of the one or more transmit beams included in the response comprises a separate measurement field associated with each of the plurality of S-RSBs (see, e.g., example 2000 of FIG. 20a). In some aspects, the indication of the one or more measurements of the one or more transmit beams comprises a measurement field for each transmit beam of the one or more transmit beams satisfying a threshold (see, e.g., example 2010 of FIG. 20b and/or example 2030 of FIG. 20c). In some instances, the indication of the one or more measurements of the one or more transmit beams further comprises an indication for each transmit beam and/or an indication of an S-RSB associated to each transmit beam of the one or more transmit beams satisfying the threshold (see, e.g., example 2010 of FIG. 20b and/or example 2030 of FIG. 20c).

In some instances, the first UE transmits the at least one response over a physical sidelink feedback channel (PSFCH). The first UE may transmit the at least one response over the PSFCH using one or more bits. In some instances, the first UE transmits the at least one response using a single bit PSFCH.

In some instances, the first UE transmits the at least one response in sidelink control information (SCI). The first UE may transmit the at least one response in SCI-1 and/or SCI-2. In this regard, the first UE may transmit the at least one response in SCI-1 and/or SCI-2 with or without a physical sidelink shared channel (PSSCH) communication.

In some instances, the first UE transmits the at least one response over a physical sidelink shared channel (PSSCH). The first UE may transmit the at least one response over the PSSCH in a media access control control element (MAC-CE) message.

In some instances, the first UE transmits the at least one response with a single bit indication. The first UE may transmit the single bit indication over a single bit PSFCH. In some aspects, the first UE determines a cyclic shift and transmits the at least one response using the cyclic shift. In some aspects, the first UE determines the cyclic shift based at least in part on a UE identifier associated with the first UE (e.g., a UE_ID or other local and/or network identifier associated with the first UE). In some instances, the first UE may determine the cyclic shift based on the following: Cyclic_shift=UE_ID mod S, where S is the total number of cyclic shifts available for beam responses (e.g., S=6 for 60 degree angle shift). Use of the cyclic shift may allow a UE that transmitted a beam burst and is receiving responses from multiple UEs (including the first UE) over the same resources (see, e.g., FIG. 22) to receive and/or distinguish between the multiple responses.

In some aspects, the first UE transmits the at least one response by transmitting a first response during a first response occasion associated with a first S-RSB of the plurality of S-RSBs and transmitting a second response during a second response occasion associated with a second S-RSB of the plurality of S-RSBs. That is, the first UE may transmit separate responses for separate S-RSBs of the plurality of S-RSBs. In some aspects, the first UE transmits the at least one response by transmitting a first response associated with a first S-RSB and a second response associated with a second S-RSB together during a single response occasion, where the single response occasion is associated with either the first S-RSB or the second S-RSB of the one or more S-RSBs of the plurality of S-RSBs. That is, the first UE may transmit a single response that includes indications for multiple S-RSBs of the plurality of S-RSBs.

FIG. 27 is a diagram illustrating an example process 2700 performed, for example, by a UE or an apparatus of the UE, in accordance with the present disclosure. Example process 2700 is an example where the UE (e.g., UE 120, UE 120a, UE 120b, UE 120c, apparatus 2500, apparatus 2506) performs operations associated with sensing-based sidelink beam pairing in accordance with the present disclosure. The UE may utilize one or more components, such as the reception component 2502, the transmission component 2504, the communication manager 2508, a processor, a memory, etc., to execute the blocks of process 2700. The process 2700 may employ similar mechanisms as described in FIGS. 3-24. As illustrated, the process 2700 includes a number of enumerated blocks, but aspects of the process 2700 may include additional blocks before, after, and in between the enumerated blocks. In some aspects, one or more of the enumerated blocks may be omitted or performed in a different order. Additionally, or alternatively, two or more of the blocks of process 2700 may be performed in parallel and/or combined.

At block 2710, a first user equipment (UE) transmits, in a plurality of mini-slots of one or more slots, a plurality of sidelink signals (e.g., sidelink beams, sidelink reference signals, sidelink reference signal block (S-RSBs), etc.). In some aspects, the first UE transmits the plurality of sidelink signals in a burst based on a sidelink beam management configuration. In this regard, the first UE may receive the sidelink beam management configuration (e.g., from a base station, network unit, RU, DU, CU, UE, etc.). In some instances, the UE is preconfigured with the sidelink beam management configuration (e.g., by the manufacturer, network owner, etc.). The sidelink beam management configuration may indicate one or more numerologies associated with one or more sidelink bandwidth parts, one or more resources associated with a dedicated beam pairing pool for each of one or more sidelink bandwidth parts, one or more beam pairing burst parameters, one or more resources for a beam response, and/or other parameters associated with sensing-based sidelink beam management.

In some aspects, the first UE transmits a first S-RSB in a first mini-slot of a slot and a second S-RSB in a second mini-slot of the slot (see, e.g., FIGS. 9-16). The first UE may transmit the first S-RSB using a first beam direction. The first UE may transmit the first S-RSB in a licensed spectrum. In some aspects, the licensed spectrum includes FR2. The first S-RSB may include first sidelink control information (SCI). The first SCI of the first S-RSB may comprise SCI-1 (see, e.g., S-RSB 702, S-RSB 704, S-RSB 706) and/or SCI-2 (see, e.g., S-RSB 704). The first SCI may indicate a sidelink beam burst structure and/or one or more resources associated with the first S-RSB. The sidelink beam burst structure may include one or multiple beam sweeping transmissions for beam management and/or one or multiple associated beam response occasions (see, e.g., FIGS. 15-16). In this regard, the first SCI may indicate the resources, beam direction(s), and/or other parameters for each transmission (e.g., each S-RSB) of the sidelink beam burst structure. The first SCI may indicate S-RSB information (e.g., S-RSB index of an S-RSB within an S-RSB burst for beam association or resource mapping, S-RSB structure or configuration for a UE to identify the proper S-RSB burst). In some instances, the S-RSB burst structure or configuration information may include an S-RSB configuration index (e.g., a codepoint of S-RSB burst duration and/or S-RSB burst period, based at least in part on a numerology configured for a sidelink BWP).

The first SCI may also indicate the resources for each response occasion of the sidelink beam burst structure associated with the corresponding beam pairing transmission of the sidelink beam burst structure. The one or more resources associated with the first S-RSB indicated in the first SCI may include resources for one or more beam response occasions associated with the first S-RSB and/or resources associated with one or more future transmissions of the first S-RSB (e.g., in a next beam burst, a beam burst periodicity) using the same beam direction. In some aspects, the first SCI may further indicate beam information associated with the first S-RSB (e.g., beam direction, transmission power, a transmission configuration indicator (TCI) state with quasi-co-location (QCL) types such as type A or type D, a spatial filter, a beam identifier, a beam index, etc.).

The first UE may transmit the second S-RSB using a second beam direction. In some aspects, the second beam direction may be different than the first beam direction (see, e.g., FIGS. 10-11). In some aspects, the second beam direction may be the same as the first beam direction (see, e.g., Burst j+/of FIG. 12). The first UE may transmit the second S-RSB in a licensed spectrum. In some aspects, the licensed spectrum includes FR2. The second S-RSB may include the same or a different structure than the first S-RSB.

The second S-RSB may include second SCI. The second SCI of the second S-RSB may comprise SCI-1 (see, e.g., S-RSB 702, S-RSB 704, S-RSB 706) and/or SCI-2 (see, e.g., S-RSB 704). The second SCI may indicate the sidelink beam burst structure and one or more resources associated with the second S-RSB. In some aspects, the second SCI (or any other SCI of the beam burst) may indicate the same sidelink beam burst structure associated with the beam burst as indicated in the first SCI of the first S-RSB. In this regard, if a receiving sidelink UE does not receive and/or is unable to decode the first SCI, the receiving sidelink UE may use another SCI of the beam burst that is successfully received and decoded (e.g., the second SCI) to determine the sidelink beam burst structure and associated resources for performing aspects of the sensing-based sidelink beam management in accordance with the present disclosure. In this regard, the sidelink beam burst structure may include one or multiple beam sweeping transmissions for beam pairing and/or one or multiple associated beam response occasions (see, e.g., FIGS. 15-16). The second SCI may indicate the resources, beam direction(s), and/or other parameters for each transmission (e.g., each S-RSB) of the sidelink beam burst structure. In this regard, the sidelink beam burst structure may comprise first resources for transmitting one or more S-RSBs, the one or more S-RSBs including the first S-RSB and the second S-RSB. The second SCI may also indicate the resources for each response occasion of the sidelink beam burst structure associated with the corresponding beam management transmission of the sidelink beam burst structure. In this regard, the sidelink beam burst structure may comprise second resources for communicating a response associated with each of the one or more S-RSBs.

At block 2720, the first UE receives, from one or more other UEs during one or more response occasions associated with the plurality of sidelink signals, one or more responses associated with at least one of the plurality of sidelink signals. In some instances, the first UE receives, from a second UE, a first response associated with at least one sidelink signal of the plurality of sidelink signals. In some aspects, the first response is associated with multiple sidelink signals of the plurality of sidelink signals. In some aspects, the first response is associated with a single sidelink signal of the plurality of sidelink signals. The first UE may receive the response(s) in a single symbol or over a plurality of symbols. In some aspects, a first symbol of the plurality of symbols is associated with automatic gain control (AGC). In this regard, the AGC symbol may include the same information as a second symbol (e.g., a beam response) transmitted during the beam response occasion.

In some instances, the first UE also receives, from a third UE, a second response associated with at least one of the plurality of sidelink signals. In this regard, the first UE may receive the first and second responses over a first quantity (e.g., 1, 2, 3, 4, etc.) of symbols and a second quantity (e.g., 1, 2, 3, 4, etc.) of physical resource blocks (PRBs). That is, the first UE may receive the first and second responses over the same quantity of symbols and the same quantity of PRBs. In some instances, the first quantity of symbols is equal to 1 and the second quantity of PRBs is equal to 1. In some aspects, the first UE receives the first response over a common PRB associated with a plurality of UEs. In some instances, the first UE may receive the first response over a different quantity of symbols and/or a different quantity of PRBs than the second response.

In some aspects, the first UE receives the first and second responses during a first response occasion associated with a first sidelink signal of the plurality of sidelink signals. That is, the first UE may receive the first and second responses during the same response occasion. In this regard, the first UE may receive the first response in a first frequency range and receive the second response in a second frequency range different than the first frequency range. The first frequency range may include a first group of one or more PRBs and the second frequency range may include a second group of one or more PRBs. In some aspects, the first frequency range is based at least in part on a UE identifier associated with the second UE and the second frequency range is based at least in part on a UE identifier associated with the third UE. For example, in some instances the PRB starting index for a response may be determined based on:

$$PRB - Starting - Index = ( UE\_ID mod ⌊ \frac{M}{y} ⌋ ) \times y ,$$

where M is the total number of PRBs available for beam responses and y is the number of PRBs in a group of PRBs allocated to each set of response resources. In some instances, the PRB starting index for a response may be determined based on: PRB-Index= (UE ID) mod M), where M is the total number of PRBs available for beam responses.

In some aspects, the first UE receives the first response with a first cyclic shift and receives the second response with a second cyclic shift different than the first cyclic shift. In this regard, the first cyclic shift may be based at least in part on a UE identifier associated with the second UE and the second cyclic shift may be based at least in part on a UE identifier associated with the third UE. In some instances, the cyclic shift may be based on the following: Cyclic_shift=UE_ID mod S, where S is the total number of cyclic shifts available for beam responses (e.g., S=6 for 60 degree angle shift). Use of a cyclic shift may allow the first UE to receive responses from multiple UEs (e.g., the first and second responses) over the same resources (see, e.g., FIG. 22).

In some aspects, the first UE receives the first response during a first response occasion associated with a first sidelink signal of the plurality of sidelink signals (see, e.g., beam response 1808a of TxBeam k Response Occasion of FIG. 18 or Response0 of FIG. 19) and receives the second response during a second response occasion associated with a second sidelink signal of the plurality of sidelink signals (see, e.g., beam response 1808c of TxBeam/Response Occasion of FIG. 18 or Response1 of FIG. 19), the second response occasion being different than the first response occasion.

The response(s) received by the first UE may include an indication of one or more transmit beams, one or more receive beams, and/or one or more beam measurements. The indication may be an implicit indication (e.g., that the first UE may determine based on the resource(s) used to transmit the response (e.g., corresponding to a response occasion associated with a particular S-RSB) or other correlation) or an explicit indication (e.g., an affirmative indication in a field, information element, or other aspect of the response). In some aspects, the response(s) received by the first UE may include an indication of one or more transmit beams (e.g., a transmit beam ID, a transmit beam index, a sidelink beam pairing or tuning or monitoring ID such an S-RSB ID, a sidelink beam pairing or tuning or monitoring signal index or resource index such as an S-RSB index, a beam spatial filter or spatial indication such as a TCI state, etc.) associated with transmitting the one or more sidelink signals (e.g., for the best x transmit beam(s)), an indication of one or more receive beams (e.g., a receive beam ID, a receive beam index, a sidelink beam ID, an S-RSB ID, an S-RSB index, a TCI state, etc.) associated with receiving the one or more sidelink signals (e.g., the best z receive beam(s)), an indication of one or more measurements (e.g., RSSI, RSRP, RSRQ, SINR, CBR, etc.) of one or more transmit beams associated with transmitting the one or more sidelink signals, and/or a combination thereof.

In some aspects, the response(s) may be received by the first UE over x symbols and y PRBs using a format with one or more fields. For example, the response(s) may be a multi-bit PSFCH, SCI, and/or MAC-CE having one or more fields (see, e.g., FIGS. 20a-20c). In some aspects, the indication of the one or more transmit beams and/or the one or more receive beams included in the response may be in a list and/or bitmap format. In some instances, the indication of the one or more measurements of the one or more transmit beams included in the response(s) comprises a separate measurement field associated with each of the plurality of S-RSBs (see, e.g., example 2000 of FIG. 20a). In some aspects, the indication of the one or more measurements of the one or more transmit beams comprises a measurement field for each transmit beam of the one or more transmit beams satisfying a threshold (see, e.g., example 2010 of FIG. 20b and/or example 2030 of FIG. 20c). In some instances, the indication of the one or more measurements of the one or more transmit beams further comprises an indication for each transmit beam and/or an indication of an S-RSB associated to each transmit beam of the one or more transmit beams satisfying the threshold (see, e.g., example 2010 of FIG. 20b and/or example 2030 of FIG. 20c).

In some instances, the first UE receives the response(s) over a physical sidelink feedback channel (PSFCH). The first UE may receive the response(s) over the PSFCH via one or more bits. In some instances, the first UE receives the response(s) via a single bit PSFCH.

In some instances, the first UE receives the response(s) in sidelink control information (SCI). The first UE may receive the response(s) in SCI-1 and/or SCI-2. In this regard, the first UE may receive the response(s) in SCI-1 and/or SCI-2 with or without a physical sidelink shared channel (PSSCH) communication.

In some instances, the first UE receive the response(s) over a physical sidelink shared channel (PSSCH). The first UE may receive the response(s) over the PSSCH in a media access control control element (MAC-CE) message.

In some instances, the first UE receives the response(s) with a single bit indication. The first UE may receive the single bit indication over a single bit PSFCH.

In some aspects, the first UE receives, from a second UE, a first response during a first response occasion associated with a first S-RSB of the plurality of S-RSBs and receives, from the second UE, a second response during a second response occasion associated with a second S-RSB of the plurality of S-RSBs.

In some aspects, the first UE receives a first response associated with a first S-RSB and a second response associated with a second S-RSB together during a single response occasion. In some instances, the single response occasion may be associated with either the first S-RSB or the second S-RSB of the plurality of S-RSBs.

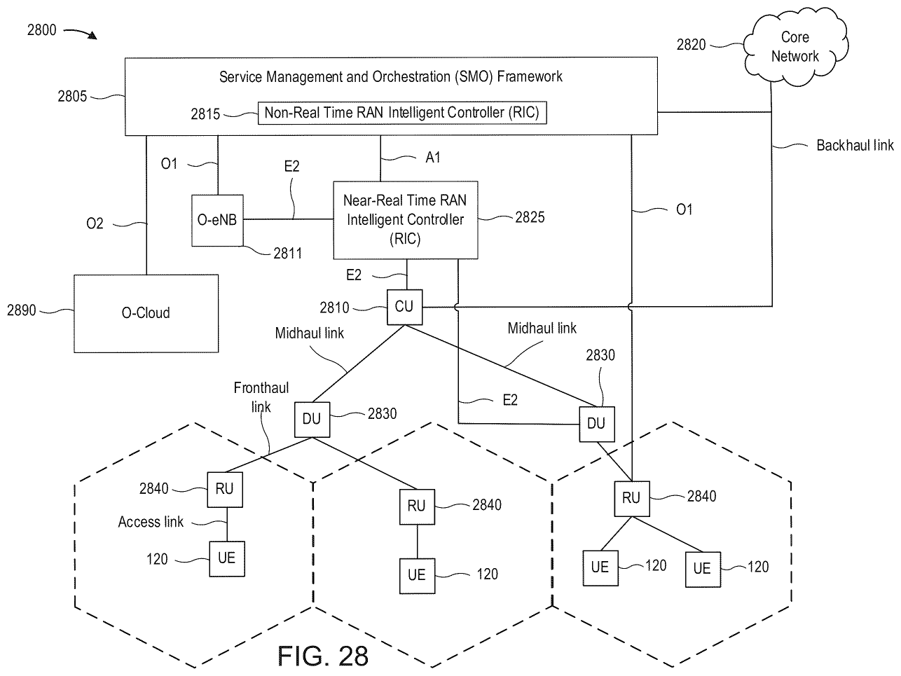

FIG. 28 is a diagram illustrating an example disaggregated base station architecture 2800 according to some aspects of the present disclosure. The disaggregated base station architecture 2800 may include one or more central units (CUs) 2810 that can communicate directly with a core network 2820 via a backhaul link, or indirectly with the core network 2820 through one or more disaggregated base station units (such as a Near-Real Time (Near-RT) RAN Intelligent Controller (RIC) 2825 via an E2 link, or a Non-Real Time (Non-RT) RIC 2815 associated with a Service Management and Orchestration (SMO) Framework 2805, or both). A CU 2810 may communicate with one or more distributed units (DUs) 2830 via respective midhaul links, such as an F1 interface. The DUs 2830 may communicate with one or more radio units (RUs) 2840 via respective fronthaul links. The RUs 2840 may communicate with respective UEs 120 via one or more radio frequency (RF) access links. In some implementations, the UE 120 may be simultaneously served by multiple RUs 2840.

Each of the units, i.e., the CUS 2810, the DUs 2830, the RUs 2840, as well as the Near-RT RICs 2825, the Non-RT RICs 2815 and the SMO Framework 2805, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 2810 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 2810. The CU 2810 may be configured to handle user plane functionality (i.e., Central Unit-User Plane (CU-UP)), control plane functionality (i.e., Central Unit-Control Plane (CU-CP)), or a combination thereof. In some implementations, the CU 2810 can be logically split into one or more CU-UP units and one or more CU-CP units. The CU-UP unit can communicate bidirectionally with the CU-CP unit via an interface, such as the E1 interface when implemented in an O-RAN configuration. The CU 2810 can be implemented to communicate with the DU 2830, as necessary, for network control and signaling.

The DU 2830 may correspond to a logical unit that includes one or more base station functions to control the operation of one or more RUs 2840. In some aspects, the DU 2830 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 2830 may further host one or more low PHY layers. Each layer (or module) can be implemented with an interface configured to communicate signals with other layers (and modules) hosted by the DU 2830, or with the control functions hosted by the CU 2810.

Lower-layer functionality can be implemented by one or more RUs 2840. In some deployments, an RU 2840, controlled by a DU 2830, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 2840 can be implemented to handle over the air (OTA) communication with one or more UEs 120. In some implementations, real-time and non-real-time aspects of control and user plane communication with the RU(s) 2840 can be controlled by the corresponding DU 2830. In some scenarios, this configuration can enable the DU(s) 2830 and the CU 2810 to be implemented in a cloud-based RAN architecture, such as a vRAN architecture.

The SMO Framework 2805 may be configured to support RAN deployment and provisioning of non-virtualized and virtualized network elements. For non-virtualized network elements, the SMO Framework 2805 may be configured to support the deployment of dedicated physical resources for RAN coverage requirements which may be managed via an operations and maintenance interface (such as an O1 interface). For virtualized network elements, the SMO Framework 2805 may be configured to interact with a cloud computing platform (such as an open cloud (O-Cloud) 2890) to perform network element life cycle management (such as to instantiate virtualized network elements) via a cloud computing platform interface (such as an O2 interface). Such virtualized network elements can include, but are not limited to, CUs 2810, DUs 2830, Rus 2840 and Near-RT RICs 2825. In some implementations, the SMO Framework 2805 can communicate with a hardware aspect of a 4G RAN, such as an open eNB (O-eNB) 2811, via an O1 interface. Additionally, in some implementations, the SMO Framework 2805 can communicate directly with one or more Rus 2840 via an O1 interface. The SMO Framework 2805 also may include a Non-RT RIC 2815 configured to support functionality of the SMO Framework 2805.

The Non-RT RIC 2815 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 2825. The Non-RT RIC 2815 may be coupled to or communicate with (such as via an A1 interface) the Near-RT RIC 2825. The Near-RT RIC 2825 may be configured to include a logical function that enables near-real-time control and optimization of RAN elements and resources via data collection and actions over an interface (such as via an E2 interface) connecting one or more CUs 2810, one or more DUs 2830, or both, as well as an O-eNB, with the Near-RT RIC 2825.

In some implementations, to generate AI/ML models to be deployed in the Near-RT RIC 2825, the Non-RT RIC 2815 may receive parameters or external enrichment information from external servers. Such information may be utilized by the Near-RT RIC 2825 and may be received at the SMO Framework 2805 or the Non-RT RIC 2815 from non-network data sources or from network functions. In some examples, the Non-RT RIC 2815 or the Near-RT RIC 2825 may be configured to tune RAN behavior or performance. For example, the Non-RT RIC 2815 may monitor long-term trends and patterns for performance and employ AI/ML models to perform corrective actions through the SMO Framework 2805 (such as reconfiguration via 01) or via creation of RAN management policies (such as A1 policies).

The following provides an overview of some aspects of the present disclosure:
Clause 1. A method of wireless communication performed at a first user equipment (UE), the method comprising: receiving, in one or more mini-slots of one or more slots, one or more sidelink signals (e.g., sidelink reference signal blocks (S-RSBs), sidelink beam signals, sidelink reference signals, etc.) of a plurality of sidelink signals associated with a second UE; and transmitting, to the second UE, at least one response associated with at least one sidelink signal of the one or more sidelink signals received.
Clause 2. The method of clause 1, wherein the transmitting the at least one response comprises transmitting the at least one response using at least one beam response occasion with a single symbol.
Clause 3. The method of clause 1, wherein the transmitting the at least one response comprises transmitting the at least one response using at least one beam response occasion with a plurality of symbols.
Clause 4. The method of clause 3, wherein a first symbol of the plurality of symbols is associated with automatic gain control (AGC).
Clause 5. The method of any of clauses 1-4, wherein the transmitting the at least one response comprises transmitting the at least one response over a quantity of symbols greater than or equal to 1.
Clause 6. The method of any of clauses 1-5, wherein the transmitting the at least one response comprises transmitting the at least one response over a quantity of physical resource blocks (PRBs) greater than or equal to 1.
Clause 7. The method of clause 6, further comprising: determining a PRB starting index; and wherein the transmitting the at least one response comprises transmitting the at least one response over the quantity of PRBs beginning with the PRB starting index.
Clause 8. The method of clause 7, wherein the determining the PRB starting index is based at least in part on a UE identifier associated with the first UE.
Clause 9. The method of clause 1, wherein the transmitting the at least one response comprises transmitting the at least one response over one symbol and one physical resource block (PRB).
Clause 10. The method of clause 9, wherein the transmitting the at least one response comprises transmitting the at least one response over a common PRB, the common PRB associated with a plurality of UEs.
Clause 11. The method of any of clauses 1-10, wherein the at least one response includes an indication of one or more transmit beams associated with transmitting the one or more sidelink signals.
Clause 12. The method of any of clauses 1-11, wherein the at least one response includes an indication of one or more receive beams associated with receiving the one or more sidelink signals.
Clause 13. The method of any of clauses 1-12, wherein the at least one response includes an indication of one or more measurements of one or more transmit beams associated with transmitting the one or more sidelink signals.
Clause 14. The method of clause 13, wherein the indication of the one or more measurements of the one or more transmit beams comprises a separate measurement field associated with each of the plurality of sidelink signals.
Clause 15. The method of clause 13, wherein the indication of the one or more measurements of the one or more transmit beams comprises a measurement field for each transmit beam of the one or more transmit beams satisfying a threshold.
Clause 16a. The method of clause 15, wherein the indication of the one or more measurements of the one or more transmit beams further comprises an indication for each transmit beam of the one or more transmit beams satisfying the threshold.
Clause 16b. The method of clause 15, wherein the indication of the one or more measurements of the one or more transmit beams further comprises an indication of a sidelink signal associated to each transmit beam of the one or more transmit beams satisfying the threshold.
Clause 17. The method of any of clauses 1-16, wherein the transmitting the at least one response comprises transmitting the at least one response over a physical sidelink feedback channel (PSFCH).
Clause 18. The method of clause 17, wherein the transmitting the at least one response over the PSFCH comprises transmitting the PSFCH using one or more bits.
Clause 19. The method of any of clauses 1-16, wherein the transmitting the at least one response comprises transmitting the at least one response in sidelink control information (SCI).
Clause 20. The method of any of clauses 1-16, wherein the transmitting the at least one response comprises transmitting the at least one response over a physical sidelink shared channel (PSSCH).
Clause 21. The method of clause 20, wherein the transmitting the at least one response over the PSSCH comprises transmitting the at least one response in a media access control control element (MAC-CE) message.
Clause 22. The method of clause 1, wherein the transmitting the at least one response comprises transmitting the at least one response with a single bit indication.
Clause 23. The method of clause 22, wherein the transmitting the at least one response with the single bit indication comprises transmitting the single bit indication over a single bit physical sidelink feedback channel (PSFCH).
Clause 24. The method of clause 23, further comprising: determining a cyclic shift; and wherein the transmitting the at least one response comprises transmitting the at least one response using the cyclic shift.
Clause 25. The method of clause 24, wherein the determining the cyclic shift comprises determining the cyclic shift based at least in part on a UE identifier associated with the first UE.
Clause 26. The method of clause 1, wherein the transmitting the at least one response comprises: transmitting a first response during a first response occasion associated with a first sidelink signal of the plurality of sidelink signals; and transmitting a second response during a second response occasion associated with a second sidelink signal of the plurality of sidelink signals.
Clause 27. The method of clause 1, wherein the transmitting the at least one response comprises: transmitting a first response associated with a first sidelink signal and a second response associated with a second sidelink signal together during a single response occasion, wherein the single response occasion is associated with either the first sidelink signal or the second sidelink signal of the one or more sidelink signals of the plurality of sidelink signals.
Clause 28. A method of wireless communication performed at a first user equipment (UE), the method comprising: transmitting, in a plurality of mini-slots of one or more slots, a plurality of sidelink signals (e.g., sidelink reference signal block (S-RSBs), sidelink beams, sidelink reference signals, etc.); and receiving, from one or more other UEs during one or more response occasions associated with the plurality of sidelink signals, one or more responses associated with at least one of the plurality of sidelink signals.
Clause 29. The method of clause 28, wherein the receiving the one or more responses comprises: receiving, from a second UE, a first response associated with at least one sidelink signal of the plurality of sidelink signals.
Clause 30. The method of clause 29, wherein the receiving the first response comprises receiving the first response in a single symbol.
Clause 31. The method of clause 29, wherein the receiving the first response comprises receiving the first response over a plurality of symbols.
Clause 32. The method of clause 31, wherein a first symbol of the plurality of symbols is associated with automatic gain control (AGC).
Clause 33. The method of clause 29, wherein the receiving the one or more responses comprises further comprises: receiving, from a third UE, a second response associated with at least one of the plurality of sidelink signals.
Clause 34. The method of clause 33, wherein: the receiving the first response comprises receiving the first response over a first quantity of symbols and a second quantity of physical resource blocks (PRBs); and the receiving the second response comprises receiving the second response over the first quantity of symbols and the second quantity of PRBs.
Clause 35. The method of clause 34, wherein: the receiving the first response comprises receiving the first response during a first response occasion associated with a first sidelink signal of the plurality of sidelink signals; and the receiving the second response comprises receiving the second response during the first response occasion associated with the first sidelink signal of the plurality of sidelink signals.
Clause 36. The method of clause 35, wherein: the receiving the first response comprises receiving the first response in a first frequency range; and the receiving the second response comprises receiving the second response in a second frequency range different than the first frequency range.
Clause 37. The method of clause 36, wherein: the first frequency range is based at least in part on a UE identifier associated with the second UE; and the second frequency range is based at least in part on a UE identifier associated with the third UE.
Clause 38. The method of clause 35, wherein: the receiving the first response comprises receiving the first response with a first cyclic shift; and the receiving the second response comprises receiving the second response with a second cyclic shift different than the first cyclic shift.
Clause 39. The method of clause 38, wherein: the first cyclic shift is based at least in part on a UE identifier associated with the second UE; and the second cyclic shift is based at least in part on a UE identifier associated with the third UE.
Clause 40. The method of clause 34, wherein: the receiving the first response comprises receiving the first response during a first response occasion associated with a first sidelink signal of the plurality of sidelink signals; and the receiving the second response comprises receiving the second response during a second response occasion associated with a second sidelink signal of the plurality of sidelink signals, the second response occasion being different than the first response occasion.
Clause 41. The method of clause 34, wherein the first quantity of symbols is equal to 1 and the second quantity of PRBs is equal to 1.
Clause 42. The method of clause 41, wherein the receiving the response comprises receiving the first response over a common PRB, the common PRB associated with a plurality of UEs.
Clause 43. The method of any of clauses 29-43, wherein the first response includes an indication of at least one transmit beam associated with transmitting at least one sidelink signal of the plurality of sidelink signals.
Clause 44. The method of any of clauses 29-43, wherein the first response includes an indication of at least one receive beam associated with receiving at least one sidelink signal of the plurality of sidelink signals.
Clause 45. The method of any of clauses 29-43, wherein the first response includes an indication of one or more measurements of one or more transmit beams associated with transmitting one or more of the plurality of sidelink signals.
Clause 46. The method of clause 45, wherein the indication of the one or more measurements of the one or more transmit beams comprises a separate measurement field associated with each of the plurality of sidelink signals.
Clause 47. The method of clause 45, wherein the indication of the one or more measurements of the one or more transmit beams comprises a measurement field for each transmit beam of the one or more transmit beams satisfying a threshold.
Clause 48. The method of clause 47, wherein the indication of the one or more measurements of the one or more transmit beams further comprises an indication for each transmit beam or an indication for a sidelink signal associated with each transmit beam of the one or more transmit beams satisfying the threshold.
Clause 49. The method of any of clauses 29-48, wherein the receiving the first response comprises receiving the first response over a physical sidelink feedback channel (PSFCH).
Clause 50. The method of any of clauses 29-48, wherein the receiving the first response comprises receiving the first response in sidelink control information (SCI).
Clause 51. The method of any of clauses 29-48, wherein the receiving the first response comprises receiving the first response over a physical sidelink shared channel (PSSCH).
Clause 52. The method of clause 51, wherein the receiving the first response over the PSSCH comprises receiving the first response in a media access control control element (MAC-CE) message.
Clause 53. The method of clause 29, wherein the receiving the first response comprises receiving the first response with a single bit indication.
Clause 54. The method of clause 53, wherein the receiving the first response with the single bit indication comprises receiving the single bit indication over a single bit physical sidelink feedback channel (PSFCH).
Clause 55. The method of clause 29, further comprising: receiving, from the second UE, a second response associated with at least one of the plurality of sidelink signals; and wherein: the receiving the first response comprises receiving the first response during a first response occasion associated with a first sidelink signal of the plurality of sidelink signals; and the receiving the second response comprises receiving the second response during a second response occasion associated with a second sidelink signal of the plurality of sidelink signals.
Clause 56. The method of clause 29, wherein the first response is associated with multiple sidelink signals of the plurality of sidelink signals.
Clause 57. The method of clause 28, wherein the receiving the one or more responses comprises: receiving a first response associated with a first sidelink signal and a second response associated with a second sidelink signal together during a single response occasion, wherein the single response occasion is associated with either the first sidelink signal or the second sidelink signal of the plurality of sidelink signals.
Clause 58. An apparatus for wireless communications at a user equipment (UE) comprising: at least one memory; and at least one processor coupled to the at least one memory, wherein the at least memory stores instructions executable by the at least one processor, individually or in any combination, to cause the apparatus to perform any one or more aspects of clauses 1-57.
Clause 59. A user equipment (UE) comprising one or more means to perform any one or more aspects of clauses 1-57.
Clause 60. A non-transitory computer-readable medium storing one or more instructions for wireless communication, the one or more instructions comprising one or more instructions that, when executed by one or more processors of a user equipment (UE), cause the UE to perform any one or more aspects of clauses 1-57.

Claus 61. A method, device, apparatus, computer program product, non-transitory computer-readable medium, user equipment, base station, network entity, network node, wireless communication device, and/or processing system in accordance with one or more aspects of clauses 1-57 and/or as described herein with reference to the accompanying detailed description, drawings, and/or appendix.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” should be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, α+b, α+c, b+c, and a+b+c, as well as any combination with multiples of the same element (e.g., α+a, α+a+a, α+a+b, α+a+c, α+b+b, α+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communications at a user equipment (UE), comprising:
one or more memories; and
one or more processors coupled to the one or more memories, the one or more memories storing instructions executable by the one or more processors to cause the UE to:
receive, in one or more mini-slots of one or more slots, one or more sidelink signals of a plurality of sidelink signals for sidelink beam management associated with a second UE; and
transmit, to the second UE, at least one response associated with at least one sidelink signal of the one or more received sidelink signals for sidelink beam management.

2. The apparatus of claim 1, wherein the one or more memories store instructions executable by the one or more processors to further cause the UE to transmit the at least one response over a quantity of symbols greater than 1.

3. The apparatus of claim 1, wherein the one or more memories store instructions executable by the one or more processors to further cause the UE to transmit the at least one response over a single symbol and one physical resource block (PRB).

4. The apparatus of claim 1, wherein the at least one response includes an indication of one or more transmit beams associated with transmitting the one or more sidelink signals.

5. The apparatus of claim 1, wherein the at least one response includes an indication of one or more receive beams associated with receipt of the one or more sidelink signals.

6. The apparatus of claim 1, wherein the at least one response includes:
an indication of one or more measurements of one or more transmit beams associated with transmission of the one or more sidelink signals.

7. The apparatus of claim 1, wherein the one or more memories store instructions executable by the one or more processors to further cause the UE to transmit the at least one response over a physical sidelink feedback channel (PSFCH).

8. The apparatus of claim 1, wherein the one or more memories store instructions executable by the one or more processors to further cause the UE to transmit the at least one response in sidelink control information (SCI).

9. The apparatus of claim 1, wherein the one or more memories store instructions executable by the one or more processors to further cause the UE to:
transmit the at least one response in a media access control control element (MAC-CE) message.

10. The apparatus of claim 1, wherein the one or more memories store instructions executable by the one or more processors to further cause the UE to:
transmit a first response during a first response occasion associated with a first sidelink signal of the plurality of sidelink signals; and
transmit a second response during a second response occasion associated with a second sidelink signal of the plurality of sidelink signals.

11. An apparatus for wireless communications at a user equipment (UE), comprising:
one or more memories; and
one or more processors coupled to the one or more memories, the one or more memories storing instructions executable by the one or more processors to cause the UE to:
transmit, in a plurality of mini-slots of one or more slots, a plurality of sidelink signals for sidelink beam management; and
receive, from one or more other UEs during one or more response occasions associated with the plurality of sidelink signals for sidelink beam management, a first response associated with at least one sidelink signal of the plurality of sidelink signals.

12. The apparatus of claim 11, wherein the one or more memories store instructions executable by the one or more processors to further cause the UE to:
receive, from a second UE, a first response associated with at least one sidelink signal of the plurality of sidelink signals.

13. The apparatus of claim 11, wherein the apparatus is further configured to receive a first response of the one or more responses in a single symbol.

14. The apparatus of claim 11, wherein the apparatus is further configured to receive a first response of the one or more responses over a plurality of symbols, wherein a first symbol of the plurality of symbols is associated with automatic gain control (AGC).

15. The apparatus of claim 11, wherein the one or more memories store instructions executable by the one or more processors to further cause the UE to:
receive, from a third UE, a second response associated with at least one sidelink signal of the plurality of sidelink signals; and
wherein:
the first response is received during a first response occasion associated with a first sidelink signal of the plurality of sidelink signals; and
the second response is received during the first response occasion associated with the first sidelink signal of the plurality of sidelink signals.

16. The apparatus of claim 11, wherein the first response includes at least one of:
an indication of at least one transmit beam associated with transmission of at least one sidelink signal of the plurality of sidelink signals;
an indication of at least one receive beam associated with receipt of at least one sidelink signal of the plurality of sidelink signals; or
an indication of one or more measurements of one or more transmit beams associated with transmission of one or more of the plurality of sidelink signals.

17. The apparatus of claim 11, wherein the one or more memories store instructions executable by the one or more processors to further cause the UE to receive the first response over a physical sidelink feedback channel (PSFCH).

18. The apparatus of claim 11, wherein the one or more memories store instructions executable by the one or more processors to further cause the UE to receive the first response in sidelink control information (SCI).

19. The apparatus of claim 11, wherein the one or more memories store instructions executable by the one or more processors to further cause the UE to:
receive the first response in a media access control control element (MAC-CE) message.

20. The apparatus of claim 11, wherein the one or more memories store instructions executable by the one or more processors to further cause the UE to:
receive a first response associated with a first sidelink signal and a second response associated with a second sidelink signal together during a single response occasion, wherein the single response occasion is associated with either the first sidelink signal or the second sidelink signal of the plurality of sidelink signals.
